(19) United States
(12) Patent Application Publication
(10) Pub. No.: US 2008/0167981 A1
(43) Pub. Date: Jul. 10, 2008

(54) METHODS AND SYSTEMS FOR COMMODITIZING INTEREST RATE SWAP RISK TRANSFERS

(76) Inventors: Philip H. WHITEHURST, London (GB); Hassan ARMAND, London (GB)

Correspondence Address: WILMERHALE/NEW YORK, 399 PARK AVENUE, NEW YORK, NY, 10022, US

(21) Appl. No.: 11/871,625

(22) Filed: Oct. 12, 2007

Related U.S. Application Data
(63) Continuation-in-part of application No. 11/387,974, filed on Mar. 24, 2006.
Application No. 11/387,974 is a continuation-in-part of application No. PCT/IB2006/004137, filed on Sep. 6, 2006.
Application No. PCT/IB2006/004137 is a continuation of application No. 11/387,974, filed on Mar. 24, 2006.
(60) Provisional application No. 60/714,424, filed on Sep. 6, 2005.
(60) Provisional application No. 60/714,424, filed on Sep. 6, 2005.

(51) Int. Cl. G06Q 40/00; G06F 17/11

(52) U.S. Cl. 705/37

(57) ABSTRACT

A data structure, method, class, system and computer program product for trading a commoditised financial claim. The claim obligates one party to pay on demand to a second party on any date an amount, for value spot, transparently determined with reference to a market quote for pre-specified spot-starting benchmark interest rate swap contracts prevailing on that date. The claim may be a debt obligation of a third party and may be open-ended. Embodiments of the claim closely replicate IRS risk profiles and permanently track benchmark quotes, and do so within a simplified operational framework. There is a linear intra-day and index-linked overnight relationship between (i) the market rate for the pre-specified reference constant maturity swap and (ii) the payment obligation. Securitised, bilateral, OTC and futures contract embodiments are disclosed.

### CROSS-REFERENCE TO RELATED APPLICATIONS

This application is a continuation in part of application U.S. patent application Ser. No. 11/387,974 filed Mar. 24, 2006 entitled “METHODS AND SYSTEMS FOR COMMODITIZING INTEREST RATE SWAP RISK TRANSFERS,” which claims priority to U.S. provisional application 60/714,424 filed Sep. 6, 2005. This application is also a continuation in part of PCT application PCT/IB2006/004137 filed Sep. 6, 2006 and entitled “METHODS AND SYSTEMS FOR COMMODITIZING INTEREST RATE SWAP RISK TRANSFERS.”

### BACKGROUND OF THE INVENTION

### Field of the Invention

The present invention relates to the field of interest rate risk management. A number of financial products are available to market participants for managing this risk. The Interest Rate Swap (“IRS”) contract is one such product. The present invention enlarges the set of IRS-risk-based products available to risk managers.

### Background of the Invention

IRS contracts are long-term bi-lateral agreements between two parties. Individual transactions are executed by private negotiation within an active market. They are generally governed by master documentation, also bi-lateral, necessary to cover the complexities of the relationship between the parties.

Suppliers communicate prevailing IRS market prices to customers via live quoted spot rates Li_{q} (“Live Grid-Point IRS Quotes”) for Reference IRS through assorted media, including printed, verbal and electronic. As illustrated in FIG. 1, quotes Li_{q} are typically displayed electronically as a pre-configured array 10,12 of Reference Tenors K 2002 with continuously varying quoted figures, in columns headed “Bid” and “Ask”, alongside.

As represented in FIG. 17A, a Reference IRS is concisely identified by its denomination currency RCDC 1001 and constant maturity K 2002. By selecting RCDC, a new Interest Rate Derivative structure (cIRD class 2000) is constructed and instantiated which draws upon pre defined Yield Curve conventions (YCurve class 1000) specific to RCDC. Each Reference IRS object inherits a set of market conventions, including K-specific attributes and methods, summarised by participants as quotation basis QB 27. Market conventions include fixed payment frequency 1009, fixed daycount fraction 1041, fixed date adjustment centres for payment 1007, floating rate designated maturity 1010, floating daycount fraction 1025, floating fixing offset 1028, floating date adjustment centres for fixing 1004 and for payment 1007 and payment date adjustment business day convention 1008. Users may set and save these conventions where necessary. By loading the set of conventions, a full contract template applicable for use on each trade date can be produced.

In FIG. 1, bid 28B and ask 28A quotes Li_{q} are made in terms of the percentage rate for the fixed leg. At execution, additional terms Fixed Rate 28E, Notional Amount (currency and amount) 13, Pay/Receive 17 and Counterparty 15 combine with the contract template to define the full commercial terms of an IRS transaction. Conditions specific to the Supplier's Master Agreement with Counterparty 15 may be added for the purpose of confirmation, for example introducing credit-driven early termination features. Such contract attributes may not be transferable.

Trade date fₛᵢ 14 unambiguously defines all date schedules for fixed 22 and floating 26 cashflows for that day's Reference IRS contract template, including Effective Date sᵢ 2045, and Termination Date s(K)ᵢ 2038, through application of the market conventions 27. However, customers trading on day fₛᵢ may also select a non-generic Effective Date s(ng)ⱼ 2045 for quotation. s(ng)ⱼ will drive a distinct date schedule, and will create a Tailored IRS contract template. Where s(ng)ⱼ is in the future, a pricing engine is required to derive the fair value forward swap rate F_{q}(IRSⱼ) running from that date. The pricing engine converts the cashflows, generated by applying a library of methods to the contract specification, into a rate F_{q}(IRSⱼ) by applying a library of methods to an input term structure of quotes Li_{q} and deposit market data. Revaluation of existing positions is achieved by applying the same processes, in this case with s(ng)ⱼ in the past, and solving for present value PV_{q} as opposed to rate. In both cases, the link between Li_{q} and F_{q}(IRSⱼ)/PV_{q} is opaque.

Techniques which additionally require volatility inputs also exist for converting forward swap rate F_{q}(IRSⱼ) into forward CMS rate F_{q}(CMSⱼ). A constant maturity swap (“CMS”) rate is related to its IRS rate cousin in referring to an identical underlying swap contract, but the cashflow schedule is truncated to a single payment, in this case on date sⱼ. CMS is a widely used technique, popular for capturing swap rate observations as single cashflows. However, as with F_{q}(IRSⱼ), the linkage between ultimate contractual pay-out, interim contract value and Live Quotes Li_{q} is not transparent.

By executing contracts with an Effective Date s(ng)ⱼ set in the future, customers may be attempting to reduce the problems associated with execution-date-driven date/cashflow schedules. The forward date will roll down ultimately to coincide with the spot date, at which point the contract value will be linked more transparently to Live Quotes Li_{q} as opposed to interpolated rates. In example FIG. 1, contract 2 executed as a forward IRS on trading day fₛᵢ 14 coincides with a spot contract executed off a Live Quote Li_{q} when trading on day fₛⱼ 31. However, the value relationship remains non-linear even here.

Although implemented by numerous commercially available analytics software packages and systems, the methodologies for deriving forward swap rates are sufficiently complex as to obscure the link between input curves and output rates F_{q}(IRSⱼ) & F_{q}(CMSⱼ). This would not be a problem in itself, but combined with the large set of swap contracts which emerge from trading the limited family of quotes Li_{q}, there is no method which can standardise the relationships into factors which are relevant for a sufficiently wide set of users. This means exit price transparency is constrained.

Customers can recreate price transparency for themselves by seeking competing assignment quotes when they exit a position. However, a customer is required to communicate numerous transaction terms in order to identify the contract to a third party. These include Counterparty, RCDC, Notional Amount, Pay/Receive, Fixed Rate, Fixed Leg Conventions, First Floating Fixing, Floating Leg Conventions, Effective Date and Reference Tenor. These details must then be input into a pricing engine as described above. Once known, PV_{q} may be subject to further checking processes before an executable price is quoted to a customer. This process is highly inefficient for customer and supplier alike, even when trade terms are held within a common database.

The issues described above amount to frictional costs associated with IRS execution. Aside from these execution-related issues, there are equally important pre- and post-execution inefficiencies in the existing IRS dealing framework, including but not limited to the following areas:
(1) transferability—IRS contracts are bi-lateral, each party requiring the consent of the other to modify the terms of the contract. Assignment by one party requires the permission of the other, and this severely constrains liquidity;
(2) revaluation—complex financial methodologies as described for exit execution must be applied to revalue outstanding IRS positions. This information is necessary for day-to-day position management;
(3) creditworthiness—counterparties are exposed to each other to honour their obligations to pay cashflow streams into the future. Without sufficient creditworthiness, or mechanisms to provide collateral, counterparties cannot enter the market;
(4) operational support—users need to acquire pricing and booking systems and to maintain back-office processing areas to monitor and exchange ongoing payments streams. This represents a long-term cost burden.
(5) legal/documentation—IRS participants must generally set up an ISDA® Master Agreement with every potential supplier to govern transactions, and each can involve a lengthy and costly negotiation. Additionally, each individual swap transaction requires its commercial terms to be documented, which represents a frictional cost at execution;
(6) accounting treatment—changes in international accounting legislation (IAS39, FAS133) have created a complicated environment in which to report a fair and accurate picture in a company's accounts of the results of IRS activity;
(7) regulation—entering into an IRS contract can create a notionally unlimited liability, and the IRS product is defined as a “Derivative”. Many operators are barred by their regulators from dealing “Derivatives” because of the scale of liability they can come to represent;
(8) regulatory capital—suppliers, and some customers, are required to put aside solvency capital to cover exposures associated with their IRS transactions which are costly and not always closely related to the economic risks

### BRIEF SUMMARY OF THE INVENTION

The present invention includes the identification, evaluation and determination of a live spot quote L_{q} for a notional Reference IRS, denoted an Underlying Curve Point or UCP, related to the live spot quote Li_{q} for a real Reference IRS for which it is exchangeable daily, in which the intra-day value associated with any first fixing on the floating leg of the equivalent real Reference IRS is applied as an offsetting adjustment over the fixed leg of the notional Reference IRS.

The present invention includes the development of a treatment of quotes L_{q} as prices at which the UCP commodity can be bought and sold without a requirement to enter into a real Reference IRS.
The present invention includes the contractual specification of 6 new financial product types into which execution against quotes L_{q} leads.
The present invention includes the specification of the value evolution of these 6 new products, both on an intra-day and an inter-day basis, all of which track quotes L_{q} on a continuous, permanent and transparent way.

The present invention includes the identification, evaluation and determination of 3 index factors (each a “UCPI”) per UCP, whose value changes in response to underlying market data, whose value is set and published once daily, and whose value governs the inter-day dynamics of financial contracts in order to maintain the inter-day linkage with quotes L_{q}.

The present invention includes the trading of interest rate risks implemented by computer.

The present invention includes the specification of products capable of transferring interest rate risks between parties in which a first party exchanges the UCP commodity with a second party for a cash amount. The cash amount may be handled on a margined basis, and the delivery of the UCP commodity may be physical or notional.

Other features of the present invention include settling the interest rate risk transfer through spot delivery of the inventive instrument, whereafter the holding period of the position may be open-ended or may be fixed. Further, this holding period may be prematurely ended, either by the choice of the parties, or automatically. Another feature of the invention is that the trading of interest rate risks can be done expressed as a risk amount, and this risk amount may be static or may be a function of time. Another feature of the embodiments D, E &F of the invention is that trading can be done on a securities exchange with or without the use of an electronic trading platform.

In all embodiments of the invention, the value of the cash amount is calculated by setting an initial value upon the execution of the trade, then adjusting the initial value, directly or indirectly, once daily with reference to a published UCPI. This UCPI can account for trading between different currencies.

In all embodiments of the invention trading of interest rate risk can be done using a graphical user interface displaying an interest rate curve along with at least one interest rate risk instrument. This interface can also be used to present additional information.

By providing a novel data structure, method, class, system, financial products and a computer program product, these and other objects are fulfilled, as summarised below.

Through increased standardisation of the input contract terms, and most critically by taking advantage of the evergreen quotes Li_{q} as a permanent reference point, the present invention makes IRS risk transfer more efficient. We eliminate the need for individual users to derive F_{q}(IRSⱼ)/F_{q}(CMSⱼ) for their individual contracts, and move to a regime relying solely on prevailing quotes Li_{q} to produce present values PV_{q}.

In the remainder of the document, we may use the following references: (1) open-ended FX-style Embodiment A may be referred to as Cash Curve Point (CCP); (2) margin-traded CFD of Embodiment B traded OTC, may be referred to as Margined Curve Point (MCP); (3) a closed-ended swap-style Embodiment C may be referred to as an iMID OIS (OIS); (4) Embodiment D traded on an Exchange may be referred to as iMID Futures (FUT); (5) securities Embodiment E may be referred to as a SwapShare (SWS, SPS); (6) a deleveraged Embodiment F, which may amongst others take the form of a deposit, a fund, a loan, or a note, may be referred to as a Total Return iMID instrument (TRI)

Transferability—Users may be able to buy and sell instruments of Embodiments A, D, E & F freely amongst a trading community. This third party liquidity exceeds that for standard bi-lateral IRS contracts.

Revaluation—All embodiments have a contractual pay-out for value spot connected by simple arithmetic to L_{q}. Certain instruments will have dedicated market prices. By this method and system, a more direct and straightforward valuation of holdings is possible for users.

Creditworthiness—Spot settlement of inventive instruments is a clear advantage over IRS. Embodiments A, D, E & F may be centrally cleared: settlement risk may be transferred from the trading counterparty (if known) to a settlement counterparty; open position risk beyond settlement may be with a distinct instrument account provider. Embodiments B&C may remain bi-lateral, and may be easily margined.

Trade Capture—Transactions in Embodiments A, B, D, E & F can be significantly quicker and cheaper to capture than those in conventional IRS, since security, futures and FX ticket processing is much cheaper than for privately-negotiated derivatives. They may also be sub-allocated more easily than IRS.

Cashflow processing—In embodiments E & F, cashflows need occur only upon acquisition and disposal of positions. There are no ongoing intermediate flows. This has clear advantages over conventional IRS contracts. Optional alternative embodiments E & F, in which intermediate cashflows occur, can be created and may have advantages in context of certain customers.

Legal—Under Embodiments A, B, D, E & F, the need for an ISDA® Master between trading counterparties is eliminated. Each embodiment may require alternative legal frameworks according to the legal format of the contract. The instruments may take advantage of wider legal frameworks, such as those between a clearing system & its agents and between these agents & their customers, to lessen the burden on, as well as loosen the ties between, trading counterparties.

Documentation—All Embodiments benefit implicitly from the standardisation associated with each UCP, and therefore tickets in all Embodiments may be being significantly shorter and more standardised than a typical conventional IRS confirmation.

Accounting treatment—The inventive instruments do not, arguably, meet the definitions of a “Derivative” under IAS39. They settle spot as opposed to settling at a future date. The instruments of Embodiment A, E & F may also involve an initial investment greater than for a conventional Reference IRS, the “underlying” whose value they track. Both characteristics are tests for a derivative under IAS39. The present invention is then a means for replicating IRS risk in at least one embodiment without the need to enter into contracts classified as derivative contracts. Following on from this observation, there is greater flexibility in the accounting treatments available for the instruments.

Regulation—Following on from a non-derivative accounting treatment, and from the observation that embodiment A, E & F are strict assets of the holder, the instruments may attract a less punitive classification by regulators, and may be deemed eligible investments for users currently prohibited from trading “Derivatives”. Such treatments will be specific to jurisdiction, user and regulator configurations.

Transparency of IRS-based risk transfer—By improving the transferability and portability of IRS risk, particularly via Embodiments A, D, E & F, the present invention introduces greater execution transparency and a simplified audit trail. This is useful in the context of MiFID legislation to be introduced across Europe.

Transparency of the Indices—The inventive indices SNIP, SNIPR & SNIPn are new to market users. In one preferred optional embodiment, the rules associated with producing them will be made publicly available. In a further optional embodiment, an existing trade body, for example ISDA®, can be considered as the publication sponsor for the indices. Irrespective, adoption of the indices by major suppliers in contracts will bring credibility to end-users. By these optional methods and systems, the usefulness of the inventive contracts is enhanced, specifically in the light of legislation such as UCITS III requiring index independence.

Regulatory Capital—Embodiments of the present invention may provide both outright and net regulatory capital savings. Regulatory capital is defined as capital which a regulated firm must set aside to cover losses associated with position exposures. Exposures are categorised as deriving from operational, credit and market risk. The regulatory capital requirement is not always closely related to economic risk. An ongoing regime change, from BASEL I to BASEL II, complicates the reference frame, but certain generalisations can be made.

First, so-called BIS add-ons are maturity-based. The shorter contract maturity facilitated by the present inventive products will lead to a smaller capital charge. Second, these BIS add-ons are volume-based. The automatic netting of trades in inventive instruments eliminates the mushrooming of notional amount (and therefore of capital consumption) associated with typical IRS portfolios.

Third, trades done under ISDA® documentation do not net for regulatory capital purposes against securities financing transactions (SFTs), generally governed under a GMRA. With securitised instruments of the present invention, offered alongside a repo transaction, IRS risk is contracted as an SFT. It will now have the advantage of netting against other SFTs.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1 is a schematic diagram of IRS trade execution as effected on automated electronic platforms, and the financial contracts which result.

FIG. 2 is a business process flow diagram illustrating the main processes applicable over the lifecycle of instruments of the present invention.

FIG. 3 is a schematic representation of the New Instrument Launch Assessment Process.

FIG. 4 is a schematic representation of the New Instrument Launch Preparation Process

FIG. 5 is a schematic representation of the New Instrument Trade Capture Process.

FIG. 6 is a schematic representation of the processes associated with launch, trading and expiry of futures contract embodiment D of the present invention.

FIG. 7 illustrates the process of consolidating market input data.

FIG. 8A is a schematic diagram of data, calculation and storage requirements of the index calculation process of SNIP-based embodiments C, E & F of the present invention.

FIG. 8B is a schematic diagram of data, calculation and storage requirements of the index calculation process of SNIP-based embodiments A, B & D of the present invention.

FIG. 8C is a schematic diagram of data, calculation and storage requirements of the index calculation process of SNIPR-based embodiments A, C, E & F of the present invention.

FIG. 8D is a schematic diagram of data, calculation and storage requirements of the index calculation process of SNIPn-based embodiments A, C & E of the present invention.

FIG. 8E tabulates preferred margin configurations, in SNIP-, SNIPR- & SNIPn-regimes, across market rate scenarios and instruments. Margins are expressed from an end-user's perspective.

FIG. 8F tabulates attributes Notional Asset Value and Notional Invoice Amount by instrument type.

FIG. 8G tabulates default ticket data by instrument type.

FIG. 8H tabulates pay-off and product accounting parameters by instrument type.

FIG. 9A is a flow diagram showing the attributes, methods and formulas for calculating the SNIF component of UCPI.

FIG. 9B is a flow diagram showing the attributes, methods and formulas for calculating the CC component of UCPI.

FIG. 9C is a flow diagram showing the attributes, methods and formulas for calculating the QC component of UCPI.

FIG. 9D is a flow diagram showing the attributes, methods and formulas for calculating UCPI when using an optional curve-building embodiment to account for movements in money-market rates between fixing time and close.

FIG. 9E is a schematic instrument taxonomy, expressed in terms of the value components which account for the inter-day spot rate tracking.

FIGS. 10A and 10B show examples of UCPI and derived index (e.g. ELA) display screens.

FIG. 10C illustrates the deployment of the SNIPn index in trading Cash Curve Point instruments.

FIG. 11A illustrates example windows leading to execution of bi-lateral instruments (e.g. OIS) of the present invention over an electronic platform integrated with IRS execution.

FIG. 11B illustrates example windows relating to execution of SNIPr-driven MCP over an electronic platform integrated with spot foreign exchange execution.

FIG. 11C illustrates example windows relating to execution of SNIPn-driven CCP over an electronic platform integrated with spot foreign exchange execution.

FIG. 12 follows from FIG. 11A and illustrates example windows leading to execution of security instruments (e.g. SWS) of the present invention over an electronic platform.

FIG. 13 illustrates example transaction tickets for CCP and SWS embodiments of the present invention, including the Rate/Price and PV01/Notional toggles.

FIG. 14A illustrates a novel instrument display structure for security instruments of the present invention, allowing co-ordinate sensitive display to aid performance evaluation and execution.

FIG. 14B illustrates a novel instrument display structure for Cash Curve Points, allowing co-ordinate sensitive display to aid performance evaluation and subsequent execution.

FIGS. 15A and 15B illustrate example instrument attribute displays via which users can view execution and pre-execution security instrument data respectively.

FIG. 15C illustrate example instrument attribute displays via which users can view pre-execution CCP instrument data.

FIG. 16 is a flow diagram showing the attributes, methods and formulas for calculating the Trigger Chance.

FIGS. 17A 17B & 17C are schematics illustrating the classes, interfaces and calculations according to the present invention.

FIGS. 18A and 18B are a schematic illustration of the cross-functional processing systems of the present invention.

FIGS. 19A, 19B, 19C and 19D are event trace diagrams for ownership transfer instruments of securitised embodiments of the present invention (for OTC embodiments, Issuer may be functionally but not be legally distinct from Dealer), respectively secondary market buying and selling, safeguard termination processing, holder put processing and issuer call processing.

FIG. 20A shows an example display configuration for inventive instrument windows and first order risk report, alongside example index series data, following the position described in FIG. 11B, wherein the risks are reported from an IntraDay perspective.

FIG. 20B shows an example display configuration for inventive instrument windows and first order risk report, alongside example index series data, following the position described in FIG. 11B, wherein the risks are reported from an Overnight perspective.

FIG. 20C shows the first order risk report displayed in FIG. 20B along with additional second order risk data.

### DETAILED DESCRIPTION OF THE EMBODIMENTS OF THE INVENTION

The dependence of contractual result on execution date for otherwise identical transactions is a major obstacle in efforts to commoditise IRS risk transfer. It is also an important contributor to high production costs. A limited family of benchmark quotes Li_{q} lead to a much larger portfolio of executed contracts. Commoditisation efforts to date, such as Exchange-traded futures, have focussed on pre-selecting an arbitrary standard IRS contract with a fixed absolute Effective Date, and trading some function of the present value of its future cashflows. Major drawbacks of this approach are the lack of transparency between prevailing quotes Li_{q} and contract prices, and the methodological complexity in the pricing relationship. Efforts to create open-ended instruments have been restricted to long-only securitised products, with imprecise factors attempting to account for periodic roll. In all cases, poor design has led to limited customer uptake.

The prior art CMS product addresses certain of the problems of IRS. For example, it can be used to create cashflows linked to long-term IRS rates without the need to enter into the underlying IRS contract. However, contractual payments and interim contract values are not transparently related to quotes Li_{q}. Most importantly, they are currently tradable only with CMS fixings on fixed absolute dates. There is no equivalent of the entry/exit timing flexibility delivered within the inventive product framework, which standardises relative date relationships and renders open-ended spot-settled contracts possible.

We outline six product embodiments of the present invention by way of example, while noting that these examples do not to exhaust the set of alternative embodiments of the invented data structure, method and system.

These inventive products rely on the novel UCP commodity as their underlying. They have an economic performance linked directly, permanently and transparently to UCP quotes L_{q}. These instruments are characterised by a linear intra-day relationship between their spot pay-out and L_{q}. For positions held overnight, an adjustment factor IDAᵢ, described in detail below, must be applied to the contracts or to positions in the contracts. The value accounts for market risks held and resets the fair contract value (or position value) such that the linear intra-day relationship is re-established for trading on the next good business day.

By application of a novel data structure, method and system of the present invention over existing practices in the IRS market, these adjustment factors IDAᵢ can be quantified with very high precision. All adjustment factors can be reduced to a small number of components, one of which, the UCPI, is independent of contractual setting. A critical feature of the UCPI is that it can be applied universally for every instrument and/or instrument position associated with a given UCP. The single universal value is recalculated daily. It therefore assumes a role modelled on that taken by the daily LIBOR fixing in the short-term money markets.

The Index value may be presented in one of 3 forms: SNIPᵢ, SNIPRᵢ & SNIPnᵢ Index SNIPᵢ capitalises the UCP roll value into an IDC-denominated dividend; SNIPRᵢ is the rate equivalent of SNIP₁, and amounts to an IDC-denominated dividend yield; SNIPnᵢ is a UCP financing rate, applied over units of UCP.

We choose between Index families, which are economically equivalent ignoring rounding, to maximise operational convenience.

We refer to SNIPᵢ, SNIPRᵢ & SNIPnᵢ indices as core indices within the inventive framework. In combination with cash positions, daily mark-to-market positions and pay-out constraints, we can create adjustment factors which apply to embodiments with great flexibility in construction.

The data structure, method and system presented enables the creation of UCPI families credible to market participants as a valid independent reference source for use in financial contracts.

We describe in detail the methods used to produce the preferred embodiments outlined. We also describe the implementation of these methods to create a robust trading environment for examples of the output products. They have been engineered to fit within existing trading systems where possible, with extensions to these systems described where necessary or informative. Trading of the inventive contracts by suppliers involves risks which are of a quantified scale and a familiar type.

We also describe a method and system for communicating the factors, and for identifying and communicating other real-time instrument data which increases the usefulness of the inventive instruments.

### Design Approach

The design approach for the data sets and associated software of the present invention adopts C++ language and an object-oriented (“OO”) methodology. The approach is also implemented and qualified using spreadsheets.

The inheritability and polymorphism which are central to an OO design approach allow us to take advantage of existing interest rate derivatives (IRD) system solutions, given that many underlying algorithms, methods and data structures are shared. As a result, the differences associated with the present invention can be highlighted and kept concise. Throughout this document, and with regard to computer software delivery systems mentioned here, the terms Class, Object and Parts are used interchangeably. They are based on C++ Classes, comprised of Attributes(Properties), Events/Signals(change in status) and Actions/Methods.

Time-critical calculations involving both static data and market data are implemented using DLLs. All the critical data structures are stored in shared memory using STL collection classes.

The helper classes and functions, such as system functions, C++ libraries functions, I/O streams and SQL server database tools which are used but not altered by this invention, are excluded from the description.

With respect to interfacing to the classes and data structures which define and implement both the prior art and the inventive instruments, we take the following approach:
a) Generalised data type class SIR-D. This provides arrays of characters. It is used as a generic data class for data types required by IRD class member attributes, action and methods. It provides a full range automatic conversion from and to numeric types, including integer, unsigned, short, long, double, float and char. It also handles text date to number conversion. All attributes are of type SIRD class. Where needed, this also provides an interface to underlying mathematical and financial libraries.
b) Access to data, or attributes. A complete attribute interface includes (i) member functions which return the value of the attribute and set the value of the attribute; and (ii) events (signals) to notify other parts when the value of the attribute changes. The setting of an attribute member function is performed by setAttributeName (attributeType aAttribute) e.g. setCalculationDate (“Dec. 9, 2005”). This approach applies to all the class attributes mentioned in this application. The functions are not listed. The get member function value of an attribute is defined in the form of attributeType& attributeName( ) e.g. calculationDate( ). This approach applies to all the class attributes mentioned in this application. The functions are not listed. In the above example, a call to calculationDate( ) returns Dec. 9, 2005.
c) Access to the behaviour of a part, or actions. These represent tasks which any class or part can ask any other part to perform. Examples include “calculate CCi”, “open a window” or “add an iMID instrument object to a collection of iMID instruments” (portfolio).
d) Event notification. By signalling events, a class (part) can notify other parts that its state has changed. For example, the DAᵢ calculator signals an event to notify other listening objects when it has completed the calculation or when it has encountered an error; or the end-of-the-day timer signals an event when it is expired; or a safeguard event handler can signal an event when the market rates reaches the lower or upper barriers. Events can also be signalled when the value of a part attribute changes, such as when interest rate volatility (Vol field) is changed either manually or by market data feed input handlers.

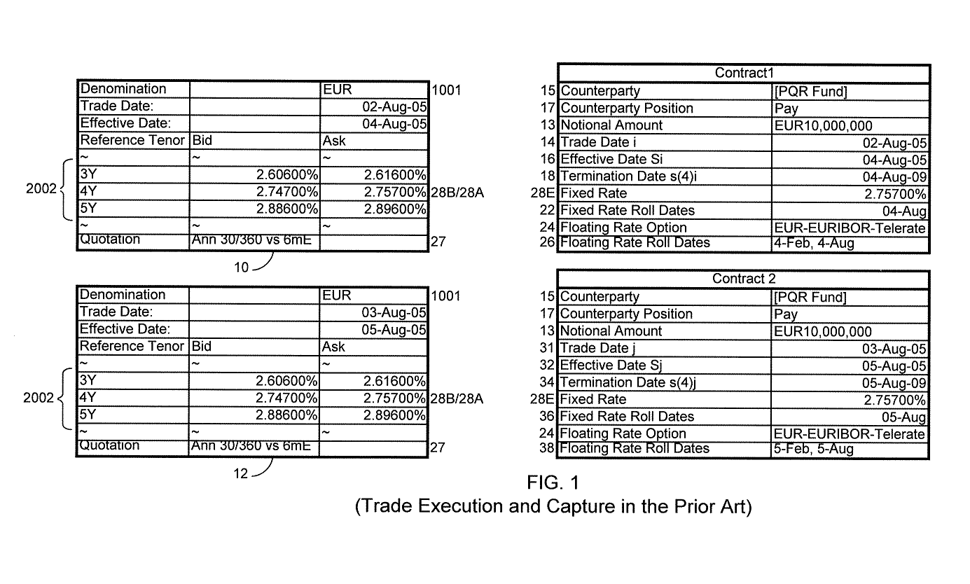

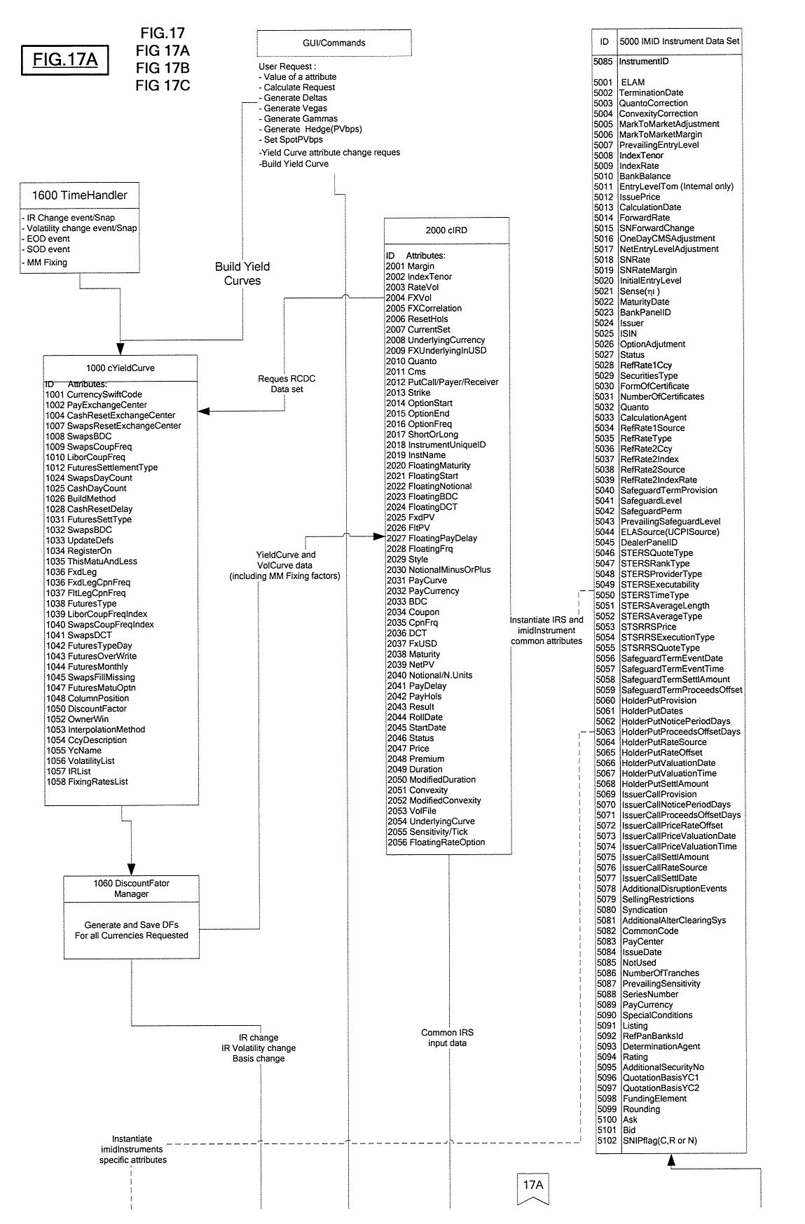

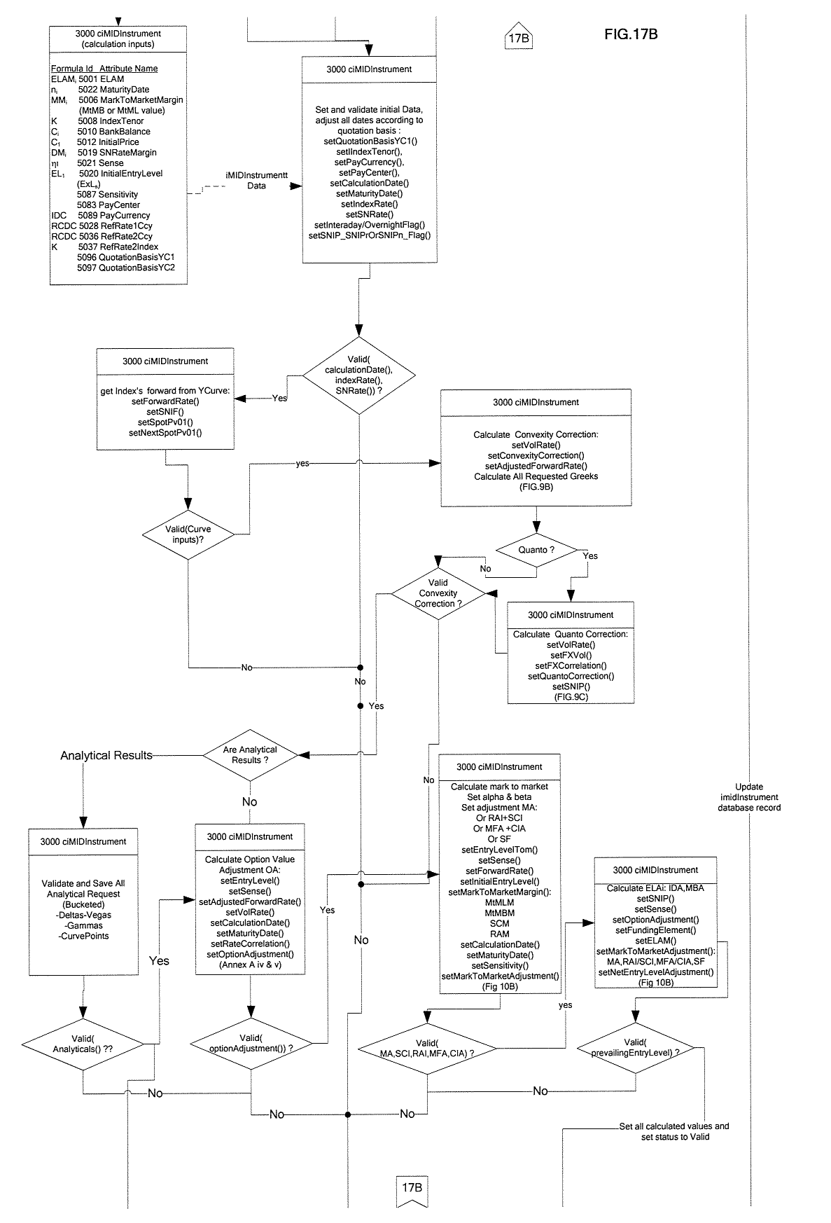

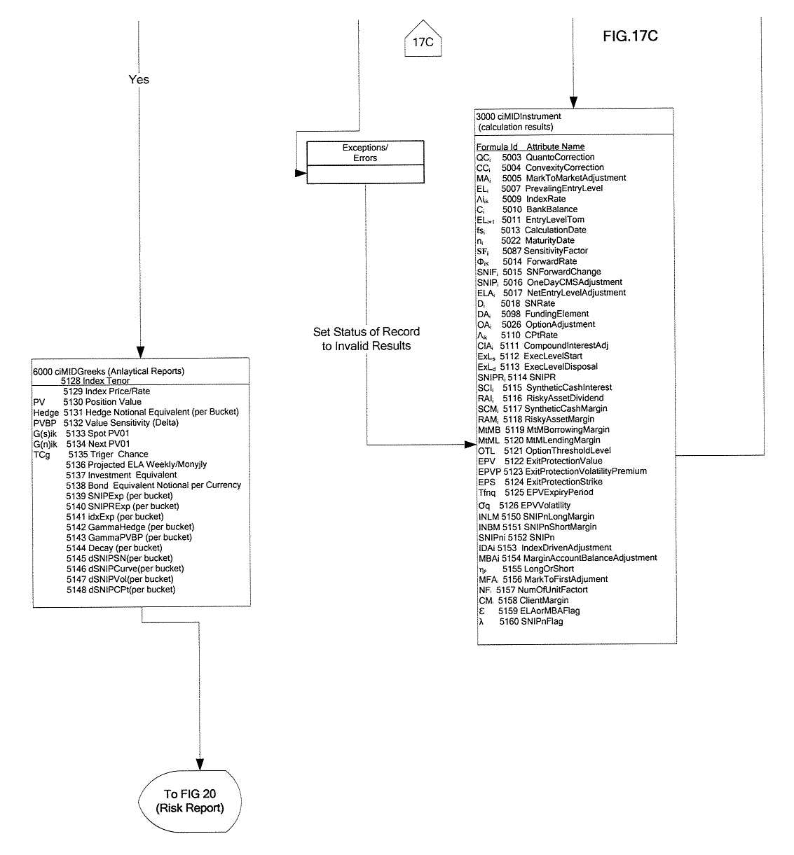

The inventive instruments inherit substantially from prior art handler classes and libraries. We limit our class descriptions to functionality and calculations required to integrate successfully between the inventive instruments and the prior art. We have the following prior art classes:
1—Yield Curve Class (cYCurve) 1000. This prior art superclass is responsible for requesting, receiving and maintaining market data feeds such as rates for Money Market, Futures and Swaps and IR Volatility instruments. It also manages currency conventions, exchange holiday centres, quotations basis and interpolation methods. Each curve can be customised according to the requirements of the specific inventive instrument 5000. The curve 1055 is then named to identify the configuration. During iMID instrument build and calculation, the instrument conventions and quotation basis attributes are instantiated from the particular configuration of named curve 1055.
2—Interest Rate Derivatives class (cIRD) 2000 (illustrated in FIG. 17A). This is a prior art superclass providing calculation attributes, functions and methods for Prior Art illustrated in FIG. 1. It provides handlers for existing vanilla, exotic and structured interest rate derivative instruments including but not limited to Fixed, Floating, Swaps, CMS, Bonds, Options, Cap and Floors.

We have the following inventive instrument data set and classes, extending IRD:
1—iMIDInstrument Record 5000: This is a generalised data structure for maintaining all aspects of an IMID instruments from inception to termination. These records are stored and maintained in database for day-to-day processing and updates.
2—ciMIDInstrument 3000: ciMIDInstrument class is a derived class from cIRD 2000 superclass. It inherits and extends the capabilities of cIRD to handle ELA Index and End-Of-Day (EOD) calculations 1700. Specifically cIRD's CMS, Option, Forward Rate and Convexity Correction calculations are used in accordance with this invention.

### UCP Commodity Definition

In the prior art, quoted IRS rates Li_{q} are a gateway into IRS contracts with fixed absolute dates. The K-year IRS rate quoted on one day does not lead into the same IRS contract as that quoted on another day.

By the present inventive framework, we treat quotes Li_{q} as a gateway into positions in a point, fixed relative to the quotation date, along the yield curve. We do so by a process of transformation. We reinterpret RCDC yield curve tenors K and quotes Li_{q} as a set of discrete commodities and their prices. Each discrete spot-relative point becomes a commodity, which we label as an Underlying Curve Point or UCP, uniquely identified in summary by attributes IDC, RCDC, K and QB.

Let us specify more exactly our definition of a commodity, and describe the beneficial implications. For our purposes, a commodity can be defined as a non-perishable physical good of uniform quality which is available from a number of suppliers, whose price is set in an active market and which is readily converted into cash.

The UCP is non-perishable since the benchmark maturities are a consistent and continuous feature of the yield curve quote structure. This is distinct from an individual IRS contract, which “perishes” when it passes to a non-generic maturity on the day after trading.

The UCP is a physical good since it is continuously convertible into a physically deliverable IRS. The template for the Reference IRS underlying each UCP is constructed, and may be published, each day according to a set of attributes and methods, collectively known as “market conventions” agreed by market participants, inherited from the prior art. This physical deliverable may never be realised, and may form the basis of immediate cash settlement when combined with a benchmark fixing. Since it is not necessary for the Reference IRS to be realised, we create advantages relative to conventional IRS activity such as being able to remove the potential for long-term exposures. In several product embodiments, we may also sever the linkage between trade execution and trade maintenance.

The presence of market conventions accepted by market users is also the basis of the UCP's uniform quality. This uniform quality appears to be present for IRS trading. However, the requirement implicit within conventional IRS trading is that quote Li_{q} leads into a long-term bi-lateral contract. There is no such requirement for the inventive instruments reliant on each UCP. The price of each UCP is determined through its simple and direct relationship with IRS. Interest Rate Swaps trade in an active global IRS market with total average daily volumes of USD621 billion (BIS Triennial, 2004) and Herfindahl indices typically below 700 (BIS, “OTC derivatives market activity in the second half of 2006”, May 2007). Prices have sufficient standing as to feature, for example, in the H.15 Daily Statistical Release of the Federal Reserve. (www.federalreserve.gov/releases/h15/Current). By escaping the perishability trap of IRS, the degree of transparency in UCP-linked contracts is unparalleled. The legal standing of the inventive instruments is supported by this UCP fungibility with IRS, which lies below the legal framework associated with each product.

### PRODUCT EMBODIMENTS

The UCP commodity may form the basis for a number of inventive financial products, a number of which are outlined in this application. The specification of certain features of each product is best achieved individually. However, the central attributes of the UCP commodity on which they all draw are as follows.

The UCP commodity may trade in units of value sensitivity. This can be defined as the sensitivity of transaction value, expressed in units of IDC, to a one basis point change in the UCP quote L_{q,K}. Individual products may constrain the units of trading. The scale of a position may be static or may be dynamic with respect to time, denoted by VaR and VaRᵢ respectively.

UCPs may be bought, resulting in a long UCP position, or may be sold, resulting in a short UCP position. Long positions increase in value when UCP quotes L_{q} rise. We denote long positions by η=1. Short positions increase in value when UCP quotes L_{q} fall. We denote short positions by η=−1. Every transaction in an inventive instrument can be translated into an equivalent position in corresponding UCP(s) according to η=ηₚη_{I} (except the Drop Component in SPS, for which η=−ηₚη_{I}).

UCP quotes L_{q,K} may be expressed or presented in basis points (“450.1”) or as percent (“4.501”) as well as taking their strict value in absolute terms (“4.501%”, “0.04501”). This choice feeds through to the product embodiments. System implementations can be easily adjusted for this through the use of scaling factors H (=10,000) and 100 respectively.

The UCP is a spot-settled commodity. This feeds through to transactions in inventive instruments which will, unless otherwise stated, settle for value sᵢ as defined by for IDC.

UCP positions are fungible, across instruments and through time. Secondary transactions executed on the same day in the same instruments will aggregate with each other in a straightforward additive fashion, and will aggregate with positions from the previous day to which the adjustment factor has been applied. For distinct instruments which share the same UCP, risks are fungible at the UCP level.

UCP positions will be financed according to the IDAᵢ formulation defined for the instrument in question. This may take the form of real financing, for example in the case of the CCP product, or may take the form of implicit financing in the case of margined products. Since positions in inventive instruments may be registered and maintained by third party account providers, settlement may fully discharge the relationship between trading partners.

UCP quotes form a continuous series without limitation in time, such that instruments and instrument positions may be open-ended. Instrument embodiments may however have maturity dates, according to the conventions associated with that format and the participants in it.

### Product Embodiment Outlines

### Embodiment A

### Cash Curve Point, CCP

Embodiment A is a funded financial product. The position in the inventive instrument, registered with a CCP account provider, is financed by an opposite position in IDC cash, whose initial balance is set with reference to traded price ExLₛ. CCP account providers may process positions with reference to SNIPnᵢ, in which case the IDC cash balance adjusts daily, by application of an interest-based cost/credit attributable to the IDC balance, and the CCP balance VaRᵢ adjusts daily, by application of a SNIPnᵢ-based rate attributable to the CCP position. This SNIPnᵢ-based CCP embodiment enables UCP risk to be traded as if it were a self-contained currency. Positions may also be processed with reference to SNIPRᵢ: the IDC cash balance adjusts daily, first by application of an interest-based cost/credit attributable to the prevailing IDC balance and second by application of a SNIPRᵢ-based dividend attributable to the CCP position; the CCP balance is static (=VaRₛ).

Each instrument CCP_{RCDC,IDC,K,QB} may be considered as a new currency. Rate L_{q} is the exchange rate between currency CCP_{RCDC,IDC,K,QB} and currency IDC. Index SNIPn_{i,RCDC,IDC,K,QB} is the daily spot/next benchmark financing rate for CCP_{RCDC,IDC,K,QB} balances, and we generally refer to it in the remainder of the document as SNIPn_{i,K}.

### Embodiment B

### Margined Curve Point, MCP

Embodiment B is a margin-traded financial product intended to integrate with margined FX trading. Methods mirror those for futures positions, save that the instruments may be supplied bi-laterally. The position in the inventive instrument, registered with an MCP account provider, is financed by a notional position in IDC cash, and is margined relative to traded price ExLₛ. MCP account providers will most commonly process positions with reference to SNIPᵢ, in which case the IDC cash balance adjusts daily while the MCP balance is static.

### Embodiment C

### iMID OIS, OIP (When Primary)/OIS (When Secondary)

Embodiment C is an (auto-extendible) bi-lateral contract most closely related to existing OIS transactions. It is designed to slot readily into current OTC IRD infrastructure. Business is expected to be conducted under an ISDA® Master agreement, and can be processed alongside prior art IRD positions. Individual trades may initiate primary processing, as with conventional IRS, although the instruments lend themselves to a simpler ongoing trade amendment process than straight IRS. Index families SNIPRᵢ and SNIPᵢ in are most likely to be employed.

### Embodiment D

### iMID Futures, FUT

Embodiment D is a margined contract for difference (“CFD”), expected to be hosted on major international and domestic futures exchanges (each an Exchange) and to possess an external identification code such as an ISIN. SNIPᵢ indices are the preferred basis of a novel centrally-cleared daily pay/collect mechanism operated by the Exchange's clearing house.

### Embodiment E

### SwapShares, SWS & SPS

Embodiment E is a securitised CFD designed to trade on- or off-exchange in an active secondary market. It is a strict asset of its holder, and a debt obligation of its Issuer. It may be listed, may be rated, may possess an external identification code and may be lodged for settlement in major international clearing systems. These securities carry their own margin, and their leverage may vary. They may employ a prior art knock-out mechanism which gives them advantages relative to warrants. Their value evolves most naturally with reference to the SNIPᵢ index family. They may be sold short, and may be borrowed or lent in an OTC repo market.

### Embodiment F

### TRiMIDs, TRI

Instruments of Embodiment F offer total return performance. They are deleveraged by the additional step of relating the L_{q}-indexed return to the conventional concept of a principal amount and reapplying a gearing, for example driven by the PV01 of the UCP's Reference IRS sampled at some pre-determined time(s). This is equivalent to manipulating the index components so as to generate total return measures (“T-R Indices”) for the IRS markets. These T-R Indices will capture the development of the present value of positions made up of cash (typically 100% at inception) and an L_{q}-based risk position of given scale. Index families SNIPRᵢ and SNIPᵢ in are most likely to be employed, with VaR variability governed through changes to gearing G. Instruments may be listed, may be rated and may be lodged for settlement in major international clearing systems. They may trade in an active secondary market, on- or off-exchange.

### Primary Phase

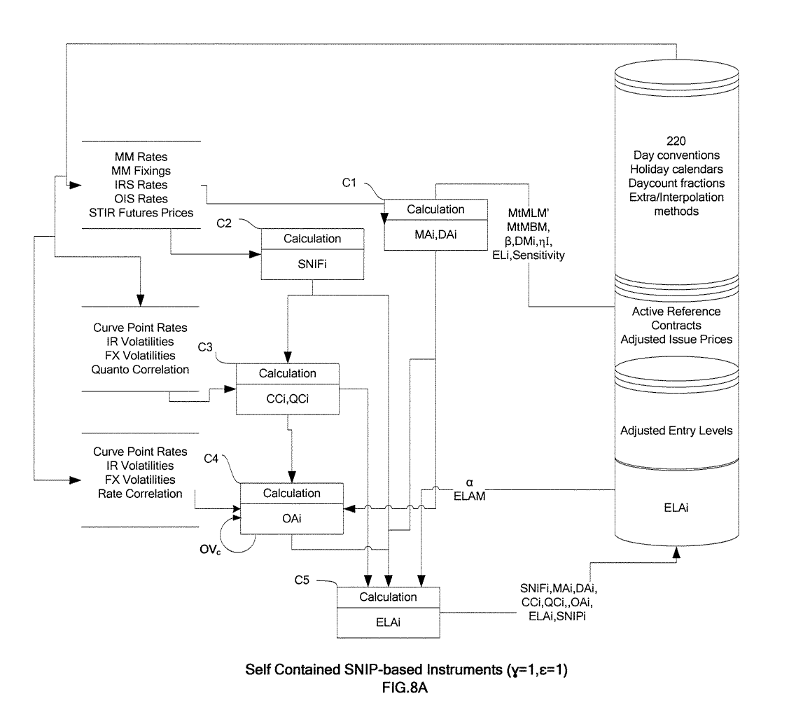

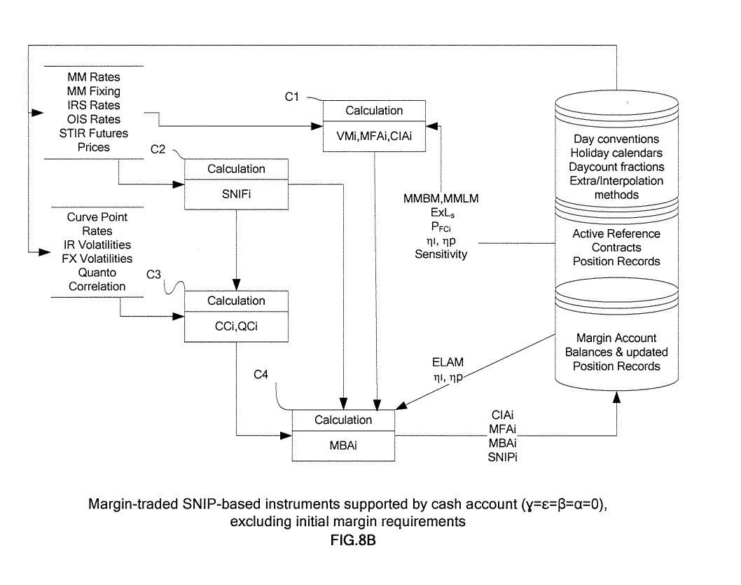

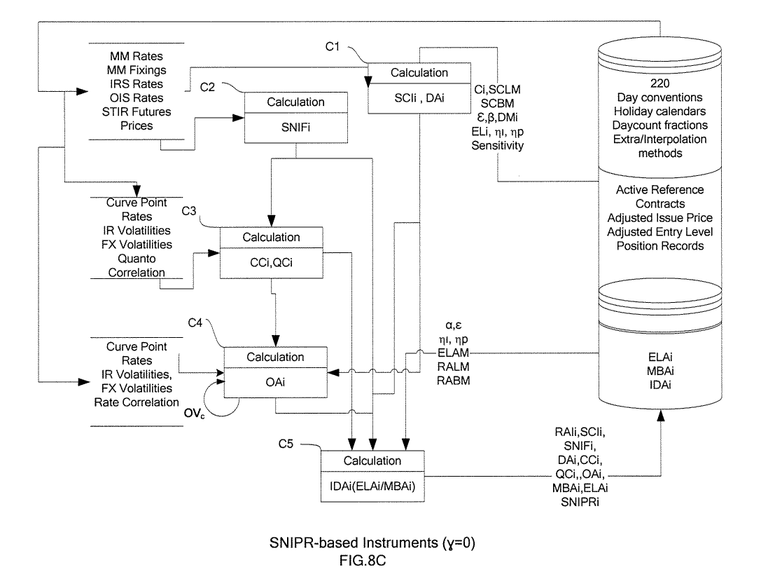

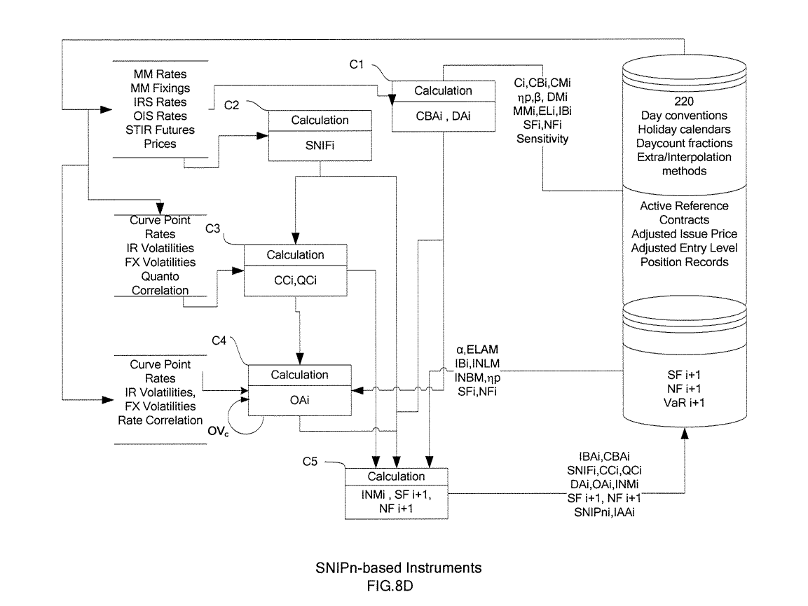

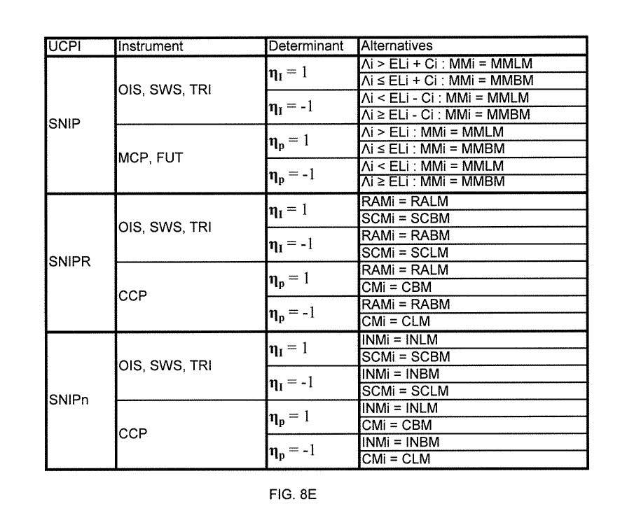

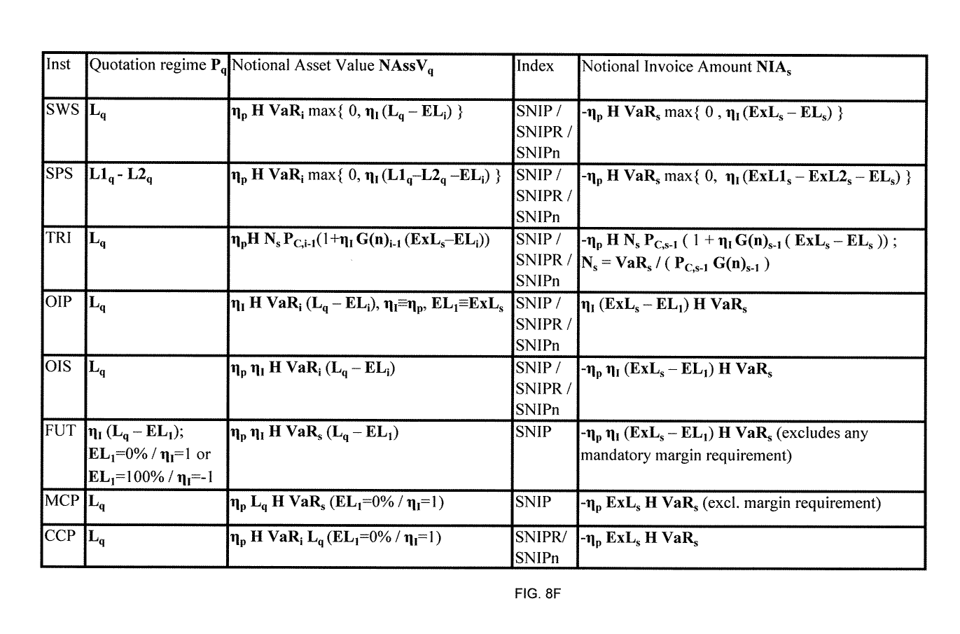

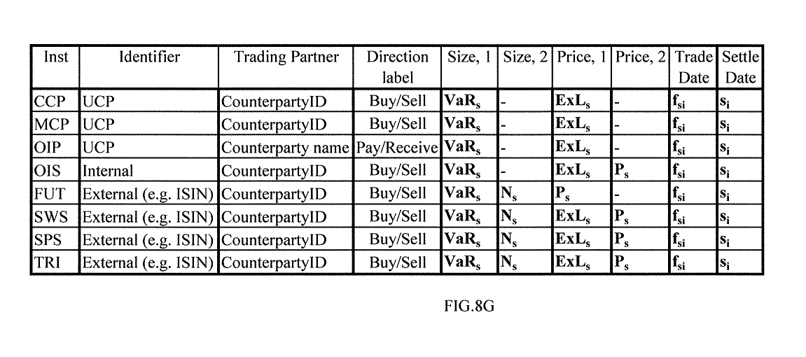

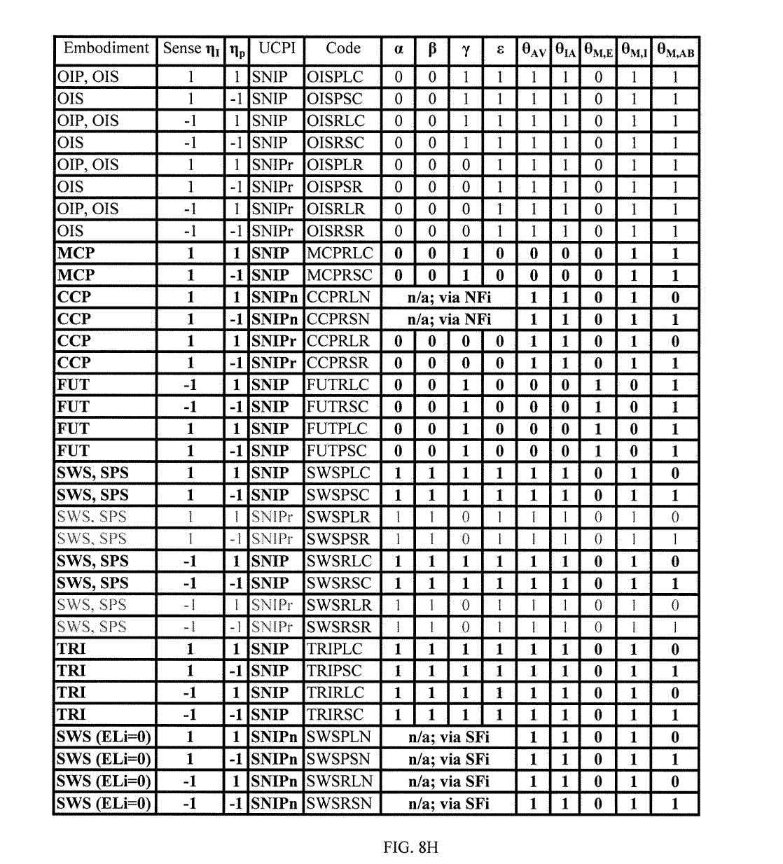

All instruments, except those of Embodiment C, undergo a primary phase in which global attributes & methods of the instruments are set in readiness for launch & secondary trading. These may include attributes such as Entry Level EL₁ and Sense η_{I} and methods such as quotation regime and valuation function. Certain key information is summarised in FIG. 8F & FIG. 8H. By pre-setting instrument features in this way, more efficient trade execution is possible.

Instruments of Embodiment C may undergo their primary phase as part of trade execution. A piece of business defined by {C/Pₛ, UCPₛ, buy/sell ηₚ, risk amount VaRₛ, rate ExLₛ, trade date fₛᵢ, settle date sᵢ} may qualify as primary or as secondary. If primary, we instantiate a new contract in which we set η_{I}=ηₚ, risk amount=VaRₛ and EL₁=ExLₛ. For secondary to be a choice, we must have open OIS transactions with counterparty C/Pₛ in Curve Point UCPₛ; secondary instruments may be cancelled or changed in size more easily and transparently than for conventional IRS (see Secondary Markets).

### Issuance Framework

CCP, MCP & OIS may require no additional business framework beyond that which supports activity between a Dealer and its clients, and business may proceed without recourse to any third party. This enhances launch flexibility, at the expense of wider liquidity.

The type of programme framework required for SWS, SPS & TRI security issuance is well known and readily available within large international banks with significant fixed income markets activities. Such debt issuance programmes, which could be “Debt”, “MTN”, “Warrant” or “Certificates” programmes, are very flexible with respect to the commercial terms of the securities issued, which are detailed in a pricing supplement. At the same time, they provide centralised management of the main agency functions. The supplier may itself act as Issuer, or may draw down from a third party programme to which it has access. In most cases, it will convert the risks acquired from securities issuance into a conventional funding profile through the use of hedging derivative contracts.

By this method, parties trading the risk have no requirement for term credit lines towards each other. Equally, there are no long-lived cashflow obligations in either direction. Thirdly, in this securitised form, users need access only to a securities settlement account and need securities dealing terms of business in place with each other, rather than more onerous than master IRS framework documents, which are shifted to the Issuer/Supplier interaction.

Buyers have no exposure to the seller other than a DvP settlement risk (generally 2 business days), and are exposed to the Issuer up to a maximum equal to the invoice amount for the securities. The seller is exposed to the short-term DvP risk on the buyer, and incurs no exposure to the Issuer. Also, since the securities settle spot, for embodiments in which there are no distributions, there are no ongoing cashflow streams to capture and manage.

In one preferred Embodiment E, instruments will be open-ended, subject to early termination provisions defined in the Pricing Supplement, and will not carry any distributions. In a second, instruments will be open-ended, will be subject to early termination provisions defined in the Pricing Supplement, will have Sense η_{I}=1, will have EL₁=0 and will pay a periodic distribution which resets ELᵢ to 0. Dated instruments can be issued subject to demand.

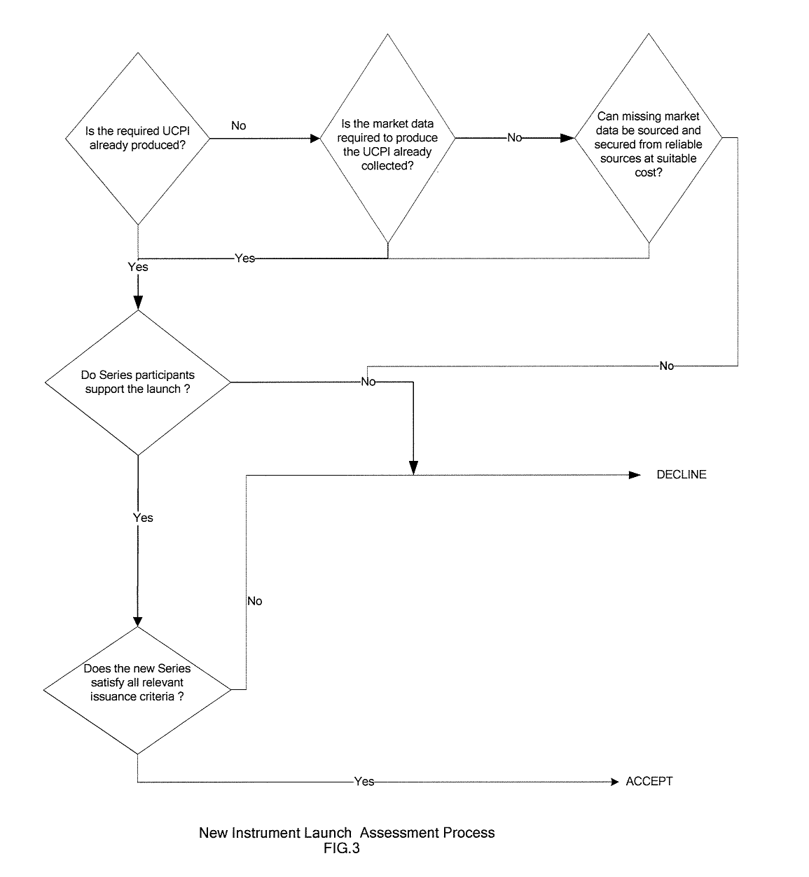

Dealers, individually or as groups, may initiate the launch of new Series with a New Instrument Launch Request 100. On receipt, the Index Provider conducts a New Instrument Launch Assessment Process 200 as per FIG. 3. Amongst other things, the process identifies additional data required for index calculation on the new Series, and assesses whether such data can be sourced. The process may also address new Series compliance issues. As a result of the process, a decision to accept or decline the new Series is made.

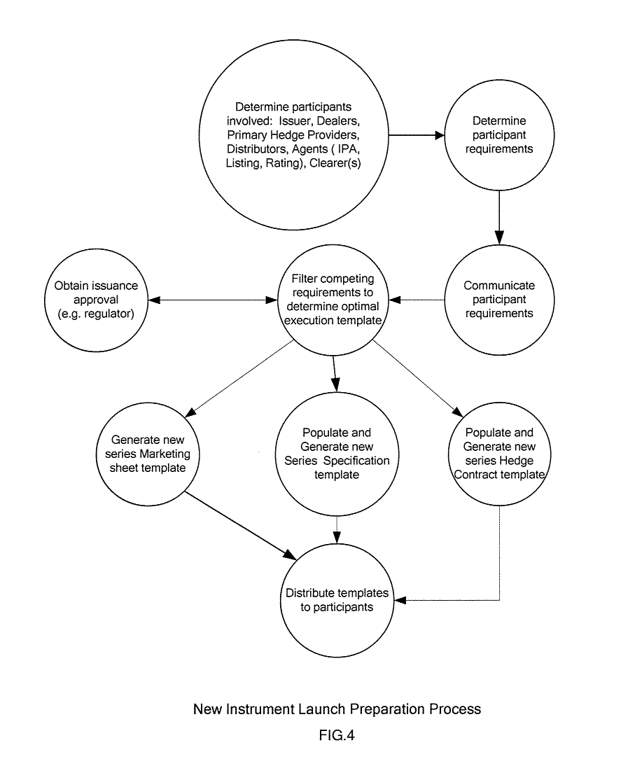

Upon acceptance, the Index Provider conducts a New Instrument Launch Preparation Process 300 as per FIG. 4. A set of potential participants (Dealers, Issuers, Reference Panel Banks, Hedge Providers, Hosts, Distributors and agents) may be identified. Commercial constraints applicable for each participant, such as funding level for the Issuer, are filtered so as to produce an optimal execution template.

Record builder 600 creates templates 5000 for instruments and (any) primary derivative hedge contracts which are saved into database 220. Record builder 600 enables report server 900 to create pro form a documents to serve as a basis for (i) the Series Specification for the new Series, and (ii) the Hedging Derivative Contracts between the Issuer and Hedge Counterparties (potentially multiple), where necessary.

Record builder 600 produces templates 5000 based upon a data structure which encompasses FX, securities and derivatives market terminologies & definitions. The necessary derivatives contracts employ the various ISDA® definition schemes, and an FpML® version has been devised. The underlying data structure for the inventive contracts has been translated into FpML®-, ISDA®- and securities markets schemas and data structures to the extent possible. For a full elucidation of the inventive instruments, both the ISDA®- and FpML®-definition schemes require extension and modification.

The prepared pro form a datafiles and documents are communicated to participants by the report server 900. These parties are now primed and may proceed to execution, furnished with matching base terms and conditions.

In cases where immediate issuance is not possible, further elements enter the process. The desire for each Series to be traded by multiple dealers may elongate the issuance process when developing new issuance currencies, and the Index Provider may intermediate in the provision of standardised data sets to prospective security Dealers in an index validation process. In emerging currencies especially, the risk appetites of Dealers may vary across a panel, and the Index Provider may be responsible for arriving at mutually acceptable instrument parameters such as Safeguard Premium levels. A set of rules will be developed between the involved parties to cover frequently arising issues. Examples of such rules might be that (i) the Issue Price of an instrument must be sufficiently high for OA₁ to equal zero at the degree of rounding employed, or that (ii) new Series on pre-specified terms are issued as soon as the likelihood that an existing Series will experience Safeguard Termination rises above a given threshold.

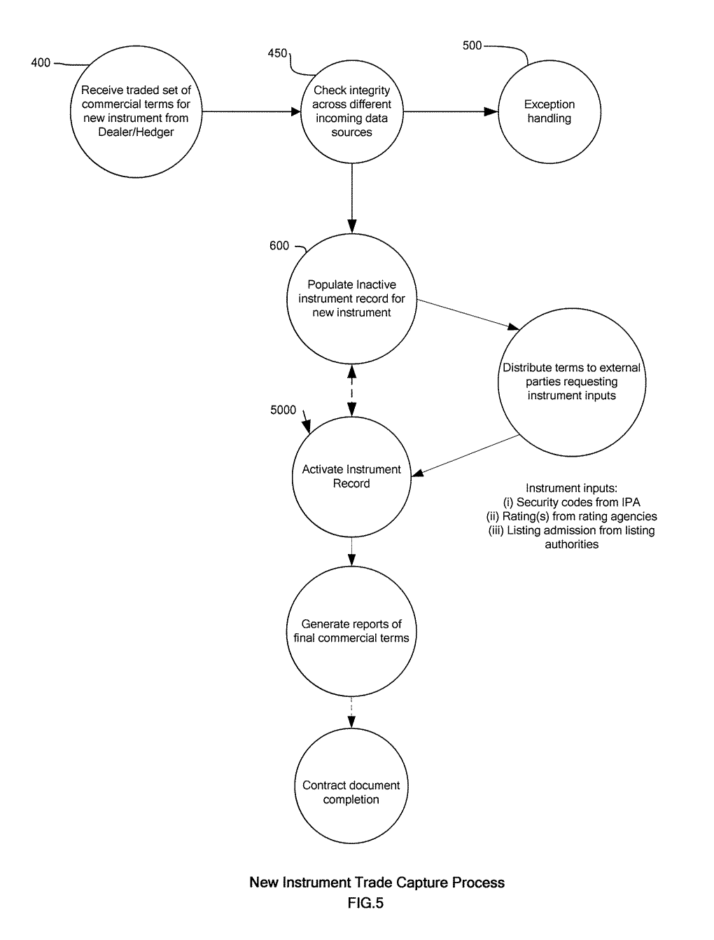

Upon execution, the group 5023 of involved Dealers and Hedge Counterparties provide the administrator with filled-in execution copies 400 of the templates, which are then used by record builder 600 in the New Instrument Trade Capture Process illustrated in FIG. 5.

Amongst other parts of this record building process, the inactive instrument record 5000 is populated with the incoming data. An integrity check 450 between incoming documents is performed to validate commercial terms. Non-matching terms are managed via an exception handler 500. The report server 900 can communicate executed terms once validated to (i) the IPA with a request to be assigned an ISIN 5025 and series number 5088; (ii) a listing agent potentially with a request to be admitted for listing 5091 on an exchange; (iii) a rating agency potentially with a request for the instrument to be assigned a rating 5094; (iv) a market host potentially with a request for the instrument to be hosted along with supporting analytics; (v) account providers with a request that customer balances in the new instrument be recognised and maintained. The instrument record 5000 is activated upon receipt back of necessary data, such as securities codes from the IPA. This information is incorporated into datafiles for communication back to participants.

Additional administrative functions will also need to be performed, according to embodiment. For example, for Embodiment E, the IPA lodges the signed Pricing Supplement together with a Global Security with the Common Depositary for Euroclear Bank S.A./N.V. as operator of the Euroclear system (“Euroclear”), or according the procedures appropriate given the clearing system used. The securities are then established within the chosen clearing system used, and are credited to the IPA's account. The security Dealers are then able to buy the securities, in exchange for cash which will be passed by the IPA to the Issuer's account, to support the component DAᵢ within the Entry Level evolution.

For Embodiment A, there is no Issuer and no physical instrument to lodge. In this regard, they bear strong similarities to Embodiment D. They differ in that, whether SNIPnᵢ- or SNIPRᵢ-driven, instrument balances may be moved freely between agents which recognise the relationship between the balances and benchmark IRS rates. Agents are able to compete to perform clearing and trade maintenance activities without making markets in the instruments and without being tied to a central clearing system. This may be an attractive business for Prime Brokers.

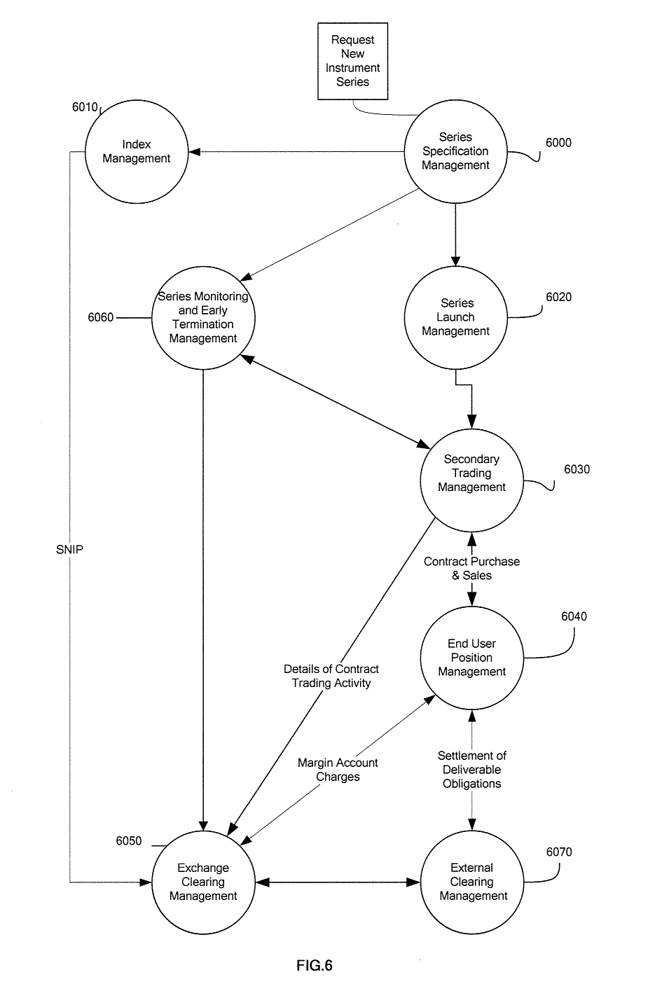

For Embodiment D, we illustrate the full process in FIG. 6. The Exchange sets the contract specifications via process 6000 prior to launch. These include quotation basis, trading unit, price units and instrument codes, as well as contract expiry definitions covered separately below and terms governing ongoing exchangeability for cash or physical IRS.

The Exchange also sets rules and procedures for Secondary Trading Management 6030. These include trading calendar, trading hours, trading system and margin requirements, and are covered in Secondary Markets. It is also likely to provide and maintain systems and services in support of secondary trading.

Regarding contract expiry, futures contracts typically have an expiry date. This expiry date represents a point at which trading in the contract ceases and outstanding positions are settled against an Exchange Delivery Settlement Price FDSP. This often takes the form of physical delivery of the contract underlying in exchange for a cash payment (“Physical Settlement”). It can alternatively take the form of a cash payment in isolation (“Cash Settlement”).

One major prior art obstacle to creating a futures contract based on IRS rates relates to this physical delivery of the underlying, for the reasons given previously in Background of the Related Art. By the present invention, we create two solutions to these problems.

In a first optional embodiment, we make possible a Futures Contract Series for which there is no expiry date, and which therefore runs in perpetuity. As a result, we eliminate the need for this physical delivery step and process. Positions taken can be held for as long as process 6030 is maintained by the Exchange. As such, we have created a clear advantage over existing technologies.

In a second optional embodiment, the Futures Contract Series can be assigned an expiry date, in line with many existing futures contracts. Here, we introduce the need for a process 6060 to govern contract expiry monitoring and management. Recognising the objections to physical delivery of the underlying conventional IRS contract, we propose a novel instrument as eligible for delivery under Physical Settlement, being an instrument of the type described in optional embodiment A or E of the present invention. Eligible deliverable obligations will be defined by a set of rules and criteria within process 6000 including, in the case of SWS, its Reference IRS, its Issuer's credit quality and its outstanding issue amount. This expiry process may be a mandatory final example of a daily liquidity feature.

Within process 6060, FDSP for the Futures Contract Series is set. In one optional embodiment, FDSP is set by the Exchange as the trading price of the Futures Contract Series at the expiry time on the expiry date of the contract. Price FDSP can be translated to and from a reference rate Λ_{FDSP} for the underlying Reference IRS on the expiry date according to the direct arithmetic relationship in (1Fa) or (1Fb) as appropriate. In a second optional embodiment, FDSP is set by reference to one of a number of existing benchmark Reference IRS fixings. In a third optional embodiment, a new market rate fixing could be established for the purpose.

For Cash Settlement, contract positions are valued at FDSP and a final Margin Account settlement made. Users are thereby forced to exit the risk position.

For Physical Settlement, once FDSP is set, securities of a type described in embodiment A are assigned a futures delivery price P_{FDSP} equal to the difference between the prevailing Entry Level for the security on expiry date i for value sᵢ and Λ_{FDSP} (P_{FDSP}=η_{I} (Λ_{FDSP}−ELᵢ)). Each security therefore has its own P_{FDSP}. We translate contract position sizes into securities position sizes in a straightforward process according the ratio of their price sensitivities to a 1 basis point move in the underlying Reference IRS.

The Exchange must set rules regarding the delivery of Payer and/or Receiver securities in settlement of open contract positions at expiry. In one optional arrangement, holders of a long Futures Contract Series position with quotation basis (1Fa) receive Receiver securities against payment of cash equal to P_{FDSP} for that security; holders of a short position deliver eligible Receiver securities against receipt of cash equal to P_{FDSP} for that security. Other optional arrangements are possible. In all cases, the settlement mechanism is a pre-defined part of the contract specification.

### Input Data Manager 1600

Market data is required for the performance of both Real-time and EOD processes.

Real-time processes will be offered in support of trading in individual contracts of the present invention. Safeguard Event management is the most critical of these, as applies in embodiment A. The provision of a live projection of tonight's SNIPᵢ would be a further example.

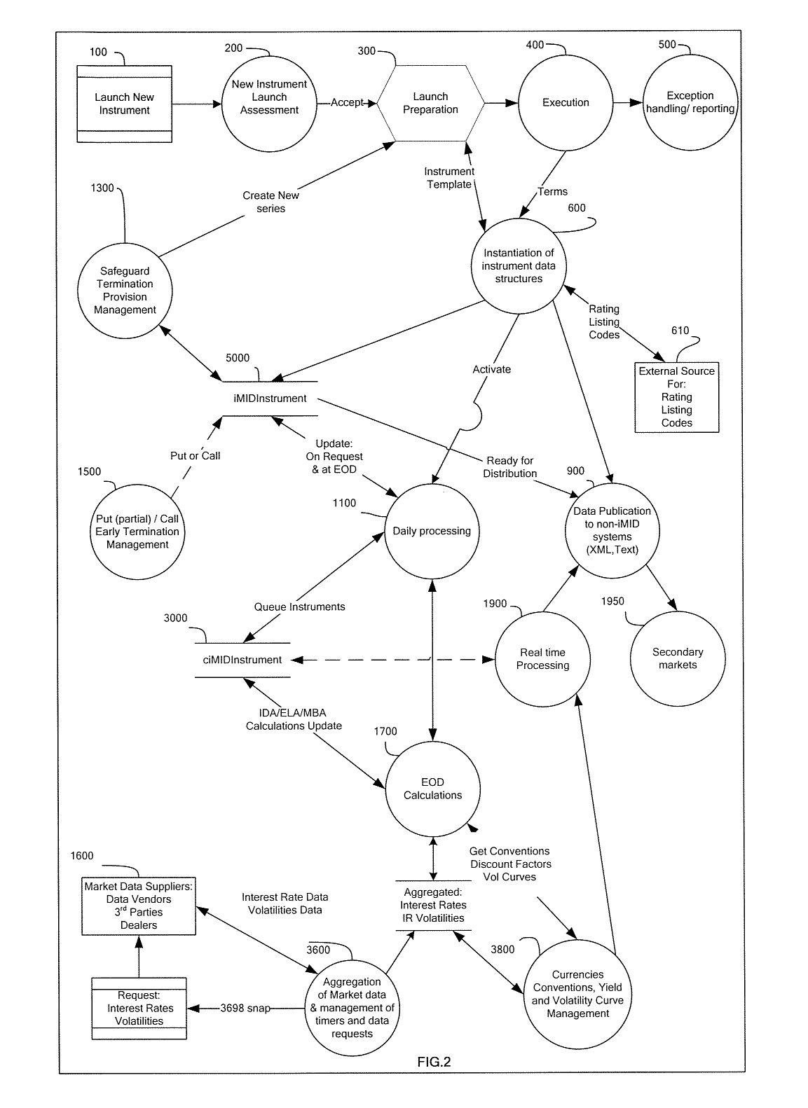

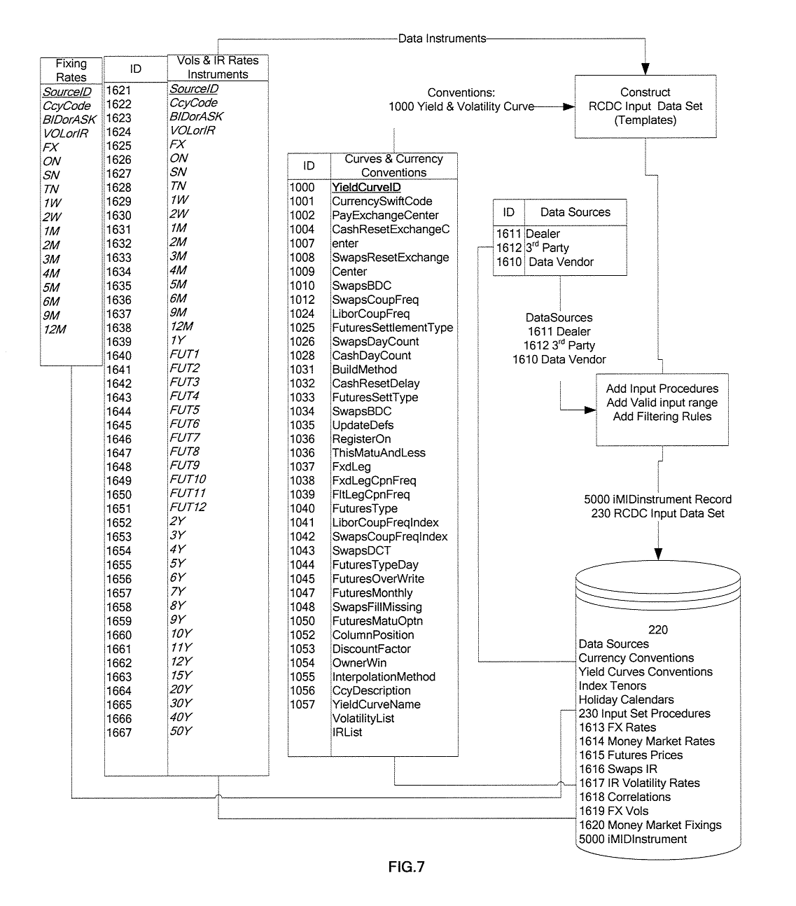

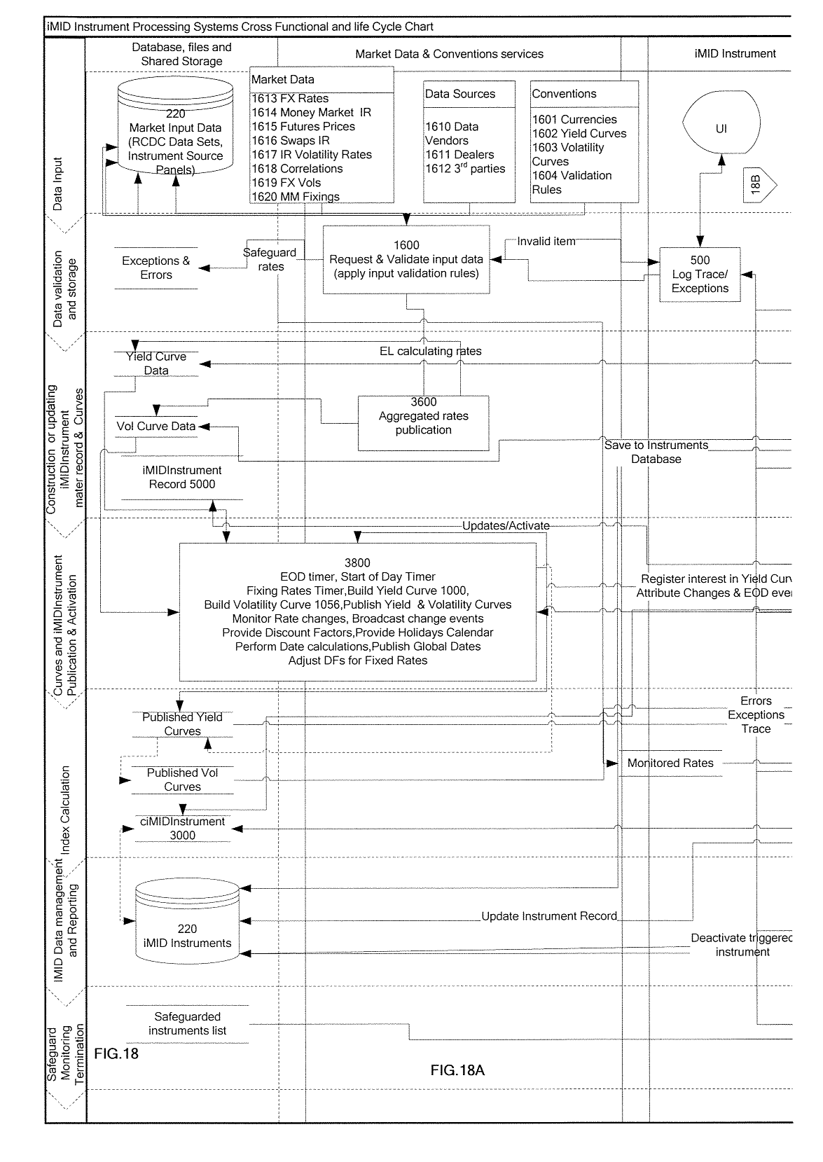

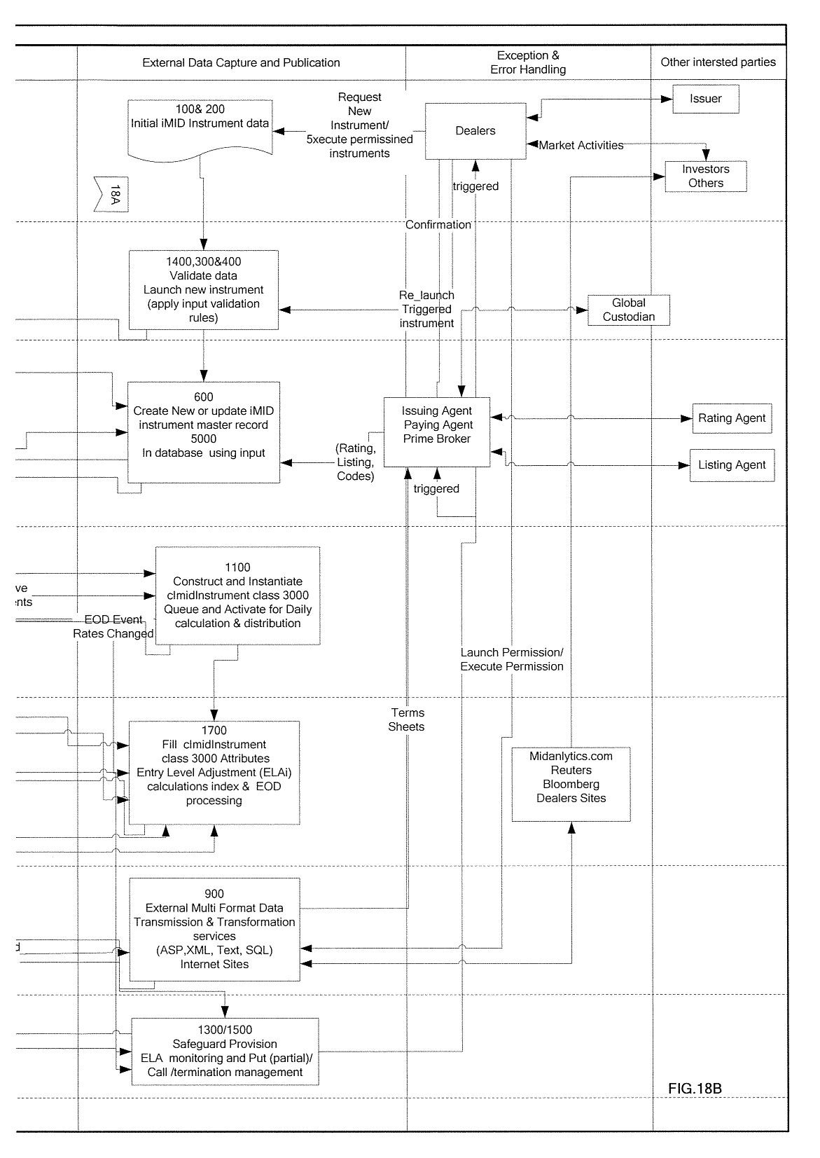

FIG. 2, FIG. 7 and FIGS. 18A & 18B jointly show the process of consolidating market data to be used as inputs to EOD processes 1700. EOD processes 1700 are performed once daily in respect of each instrument.

Market data 1600 will come from three source classifications. Dealers 1611 are defined as individual firms engaged in the trading of Index-linked instruments. Third Parties 1612 are defined as individual non-Dealer firms. Vendors 1610 are defined as commercial market data vendors, for example money brokers or information vendors.

From each source, incoming data may be in the form of a continuous live feed, or be prompted by timed request to the data supplier. Continuously fed data will be subject to periodic snapshot for data management purposes.

For each outstanding instrument 5000 recorded in the database 220, an input data set is compiled. This lists the required data items (each an Instrument Input Data Item), in preparation for receipt of the corresponding values (each an Instrument Input Data Item Value) from identified sources.

Individual instruments may require Input Data Items from across the source classifications as well as from multiple providers within a source classification.

These data requirements are then consolidated into a master Input Data Set, including sources, and translated into currency-specific templates per source.

Where there is a requirement to receive data by timed request to a provider, rules and procedures will be established to govern the nature and timing of the request, the nature and timing of the response, the nature of data integrity checks & filters applied to the response and the nature and timing of fallback provisions.

From the potentially multiple Dealer 1611, Third Party 1612 & Vendor 1610 Input Data Sets (each such set an Instrument Source Panel), a set of committed data 230 is created for use in ELA calculation process 1700 as follows.

First, each Instrument Input Item Value will be subject to a data integrity check 3601. Values will be passed through filters and be excluded from the averaging process according to pre-specified rules. The rules, for example quantified tolerances, are specific to the input variable, will be agreed with Dealers and licensees, and may be made public for users of the instruments as Input Data Integrity Rules.

Collected values, having passed these integrity checks, may be further filtered prior to deriving an average, for example by way of a ranking. A Committed Instrument Input Set is then created as the listed pairs of each Instrument Input Data Item and its committed value Instrument Input Data Item Fixing per currency.

Within the averaging process above, we have considered applying weightings, such as market share, to each incoming set of Dealer rates when deriving the mean. Until such time as accepted figures for swap dealer market share are available, an unweighted average is expected to be used.

In another optional embodiment which spans the input rate averaging process and parts of the index calculation process, committed index component values such as SNIPᵢ could be produced by calculating the implied index values from individual source inputs and then averaging the implied values. In a further optional embodiment of this process, committed index component values could be produced by arranging receipt of individual Dealer-calculated index component values, such as SNIPᵢ, as pre-configured Dealer data and then averaging these values directly.

In a further optional embodiment, existing accepted market fixings, for example the ISDAFIX® swap rate fixings, may be used as Input Date Item Fixings, subject to permission. A timing mismatch may introduce a loss of accuracy by this method to offset the credibility gain of using a standardised fixing.

In one optional embodiment, it will be possible to work with individual banks in producing distinct indices to support the launch of products in which only that one bank makes an active market. The role of the index calculator 5033 as an independent index provider may still prove critical in terms of client credibility. This possibility might result from the desire of one Dealer only to have indices in a particular emerging currency, for example. In such an embodiment, it is likely that 3^{rd} party data would be necessary as an input to the index calculation process, but embodiments are possible in which the only inputs to the calculation process are those sourced from the single instrument Dealer.

### INSTRUMENT EMBODIMENTS

Values of positions in instruments are a function of the interplay between instrument (risk) values and cash balances. Cash balances (e.g. those resulting from exchange of invoice amounts) are treated in a conventional manner; they need only be considered in detail here where they are embedded within an instrument pay-off.

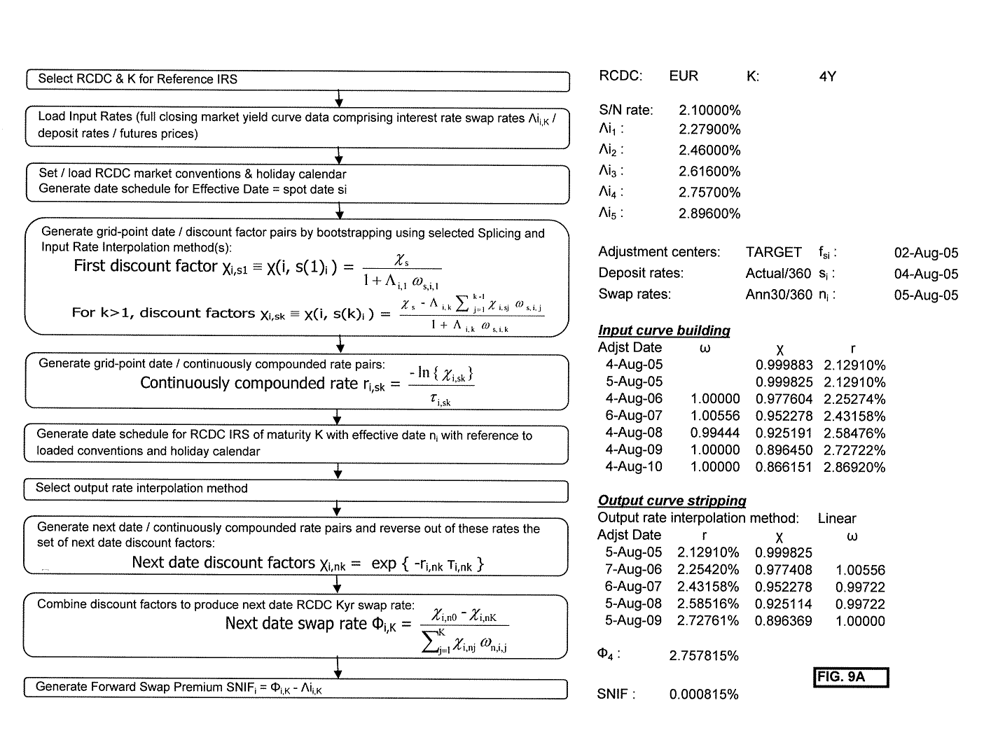

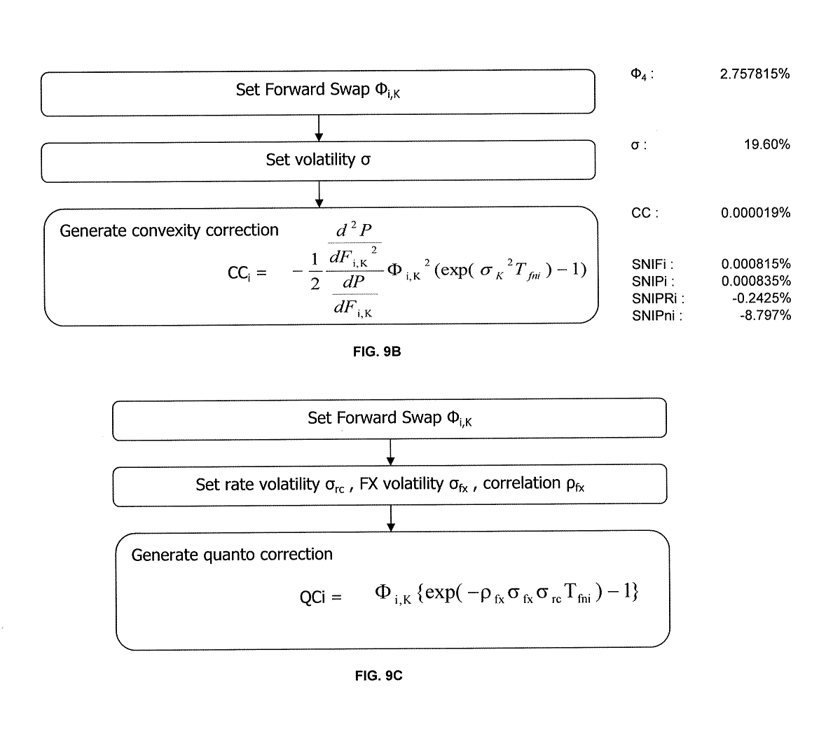

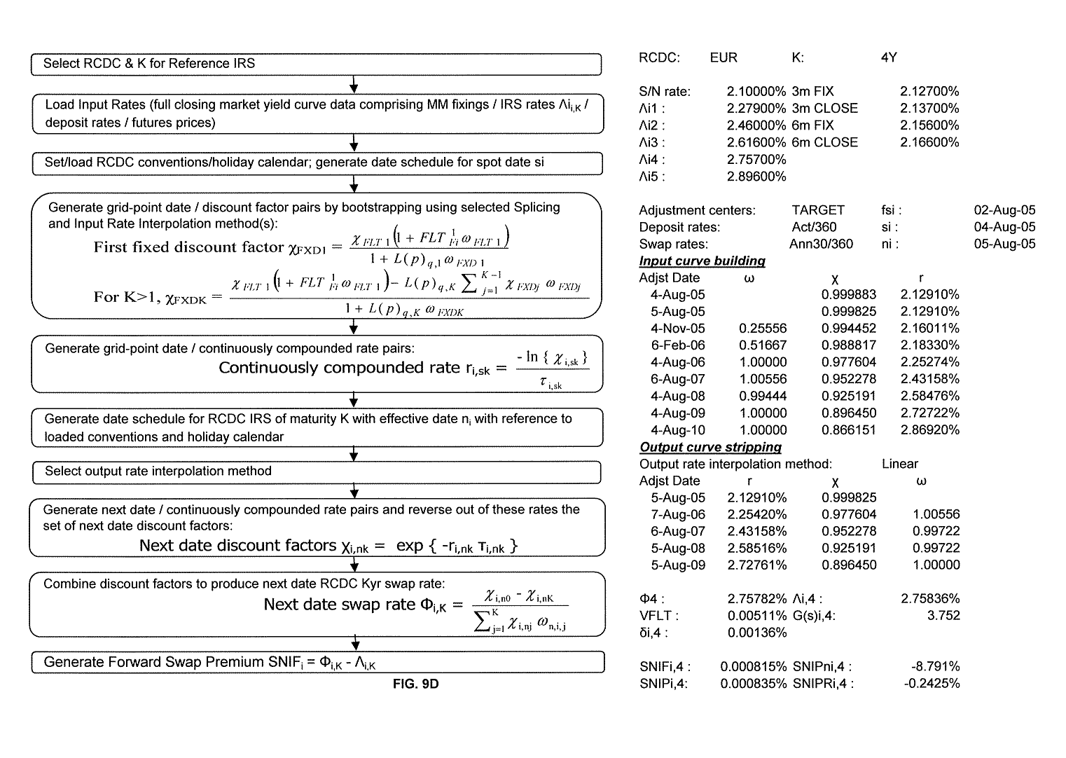

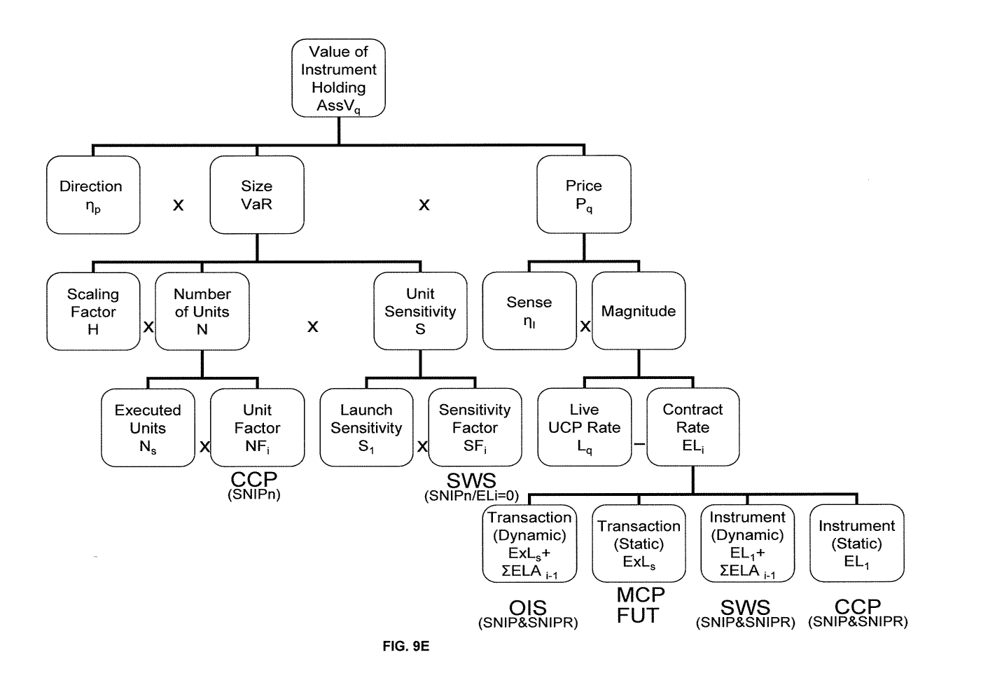

Instruments values can be expressed most simply as the product of three factors. These factors and their potential dynamics are shown schematically in FIG. 9E.

a) “Price”

Each inventive instrument will have a contractual pay-out, and therefore a market value, linked to the prevailing spot market rate L_{q} for one (or more) UCP, and therefore linked to the prevailing spot rate Li_{q} for one (or more) Reference IRS, both defined by RCDC 5028, constant maturity K 5008 and a quotation basis summarised by Quotation Basis 5096. We denote the spot rate for each such UCP, quoted at any time hh:mm:ss on any date fₛᵢ, in terms of a number of market conventions, as L_{q} L(hhmmss,i,RCDC,K). We introduce further defining attributes of rate L_{q} in section Secondary Market, but suppress the notation as L_{q} in the remainder of this section. We note that irrespective of the time of the quotation on day fₛᵢ, each Reference IRS beneath the UCP will have an effective date sᵢ and a termination date s(K)ᵢ. We also note that RCDC may differ from the instrument denomination currency IDC 5089.

We tabulate the pay-off formulation for each Embodiment in FIG. 8F. We provide descriptive support for the table here.

For SWS, OIS and TRI, each Series will possess an Entry Level ELᵢ, similar for example in certain respects to the concept of the “strike” of an option. For CCP, all Series possess Entry Level ELᵢ=EL₁=0. Prices quoted throughout the first trading day fₛ₁ for settlement on the first day of the first ELA period in the Active Period, Issue Date s₁, are made with reference to an initial Entry Level EL₁ 5020, an identifying characteristic of the series chosen at launch by the parties involved within certain guidelines.

The intrinsic value of SWS instruments linked to a single UCP rate L_{q} for value s₁ will be max{0, η_{I}(L_{q}−EL₁)}; for OIS & CCP, it is η_{I}(L_{q}−EL₁); for TRI, (1+G(s)ᵢη_{I}(L_{q}−EL₁)). For prices P_{q} quoted throughout each successive trading day fₛᵢ>fₛ₁, for which settlement occurs on sᵢ, prevailing Entry Level ELᵢ is calculated as ELᵢ₋₁ plus Entry Level Adjustment ELAᵢ₋₁. The intrinsic value of SWS for value sᵢ will be max{0, η(L_{q}−ELᵢ)}; for OIS, η_{I}(L_{q}−ELᵢ); for CCP, η_{I}(L_{q}−ELᵢ); for TRI, TRI(close)ᵢ₋₁ (1+G(n)ᵢ₋₁η_{I}(L_{q}−ELᵢ)).

For instruments linked to movements in the spread between UCP rates L(1)_{q} and L(2)_{q}, we can define the instrument pay-off as max{0, η(L(1)_{q}−L(2)_{q}−ELᵢ)}. We have implicitly defined the spread here as L(1)_{q}-L(2)_{q}. A Payer instrument on this spread pays off an increasing amount as the spread rises, but the contribution to this spread rise could be an increase in L(1)_{q} or a decrease in L(2)_{q}. For clarification, we define the concepts of the Lead Component and the Drop Component. In this example, L(1)_{q} is the Lead Component and L(2)_{q} is the Drop Component. In general, the Lead Component will be the rate with the higher initial value, for example the longer rate in an intra-curve spread product assuming a positive curve. Key attributes of the Lead Component are its currency 5028, its tenor 5008 and its quotation basis 5096; key attributes of the Drop Component are its currency 5036, its tenor 5037 and its quotation basis 5097.

For MCP & FUT, Series Entry Level ELᵢ is replaced with Execution Level ExLₛ. ExLₛ is a feature of each transaction in the Series as opposed to the Series itself, and therefore does not vary over the holding period. This characteristic also applies to CCP. Charges/credits to the position value are made via a distinct cash account (“Margin Account”) which must be held by the user of the contract for the purpose of supporting its trading activities. In FIG. 8H, this is denoted by ε=0.

Instrument values V(I)_{q} and transaction values V(T)_{q} are covered further in Secondary Trading. For FUT, we note only a possible market convention for rates to be inverted for the purpose of trading, which gives rise to the two pay-off functions in FIG. 8F.

In a first optional arrangement, the quoted Futures Contract Series price P_{F,q} would relate to the Live Quote according to the following inverse relationship:

P_{F,q}=(100%−L_{q}) (1Fa)

For example, for a live market swap rate L_{q} of 3.340%, P_{F,q}=96.660%

In a second optional arrangement, the following relationship applies:

P_{F,q}=L_{q} (1Fb)

As well as tracking value changes through variation margining, the Exchange specifies an initial margin to be credited to the Margin Account by parties with a position in the instrument. This mitigates credit risk for the clearing agent. Its scale will be governed by factors including the volatility of the Live Quote L_{q} following the techniques described in evaluating Safeguard Termination Premium.

The inventive instruments possess a characteristic denoted as Sense η_{I}, which can take one of two values. Long positions, for which ηₚ=1, in Payer instruments, for which η_{I}=1, provide an exposure equivalent to that obtained by paying the fixed rate and receiving the floating rate in the Reference IRS. Long positions, for which ηₚ=1, in Receiver instruments, for which η_{I}=−1, give the holder/depositor an exposure equivalent to that obtained by receiving the fixed rate and paying the floating rate in the Reference IRS.

Before detailing the method by which the index level behind each instrument is calculated, it is important to describe a feature which, in common with other types of financial claim, underpins the pricing framework. Consider a floating rate note (“FRN”): the return on the FRN is governed by the periodic fixing of a benchmark rate. This benchmark rate has a special property. Ignoring credit risk, at each fixing date the stream of future returns from the FRN is taken to have a value of 100% of Par. In other words, the fair value of the interim income stream offsets exactly the discount associated with deferring capital repayment into the future. This property has many uses. We use it to derive grid-point swap curve discount factors below, for example, where the benchmark rate is LIBOR in the case of US Dollars and is EURIBOR in the case of euros.

By extension, any interval over which a financial instrument pays benchmark-rate-based flows can be treated as if that interval makes no contribution to the NPV of the instrument. This is a critical point for the valuation of embodiments of the inventive instruments which have a maturity greater than one business day. Holders have the opportunity to buy and sell the instruments on a continuous basis; there are also daily opportunities for benchmarked exit or for early termination. However, should a position be held overnight, users are charged the fair value for that overnight position. Once trading begins the following day, the value of the instrument need account only for VaRᵢ/ELᵢ applicable for that day, with the contribution to the value from the stream of future changes reducing to zero. Changes to VaRᵢ/EL; play the part of the income stream to set against any decision to retain the instrument position and thereby delay capital return. UCPIs are the market benchmark rates governing that process.

In certain embodiments, these adjustments are charged/credited within a separate cash account, for example in the case of FUT the Margin Account. The presence and availability of cash accounts such as the Margin Account, through which to apply value changes, means the instrument itself is freed from these elements.

Where margins are imposed, such as ELAM, this validity of this concept may be threatened on a purely theoretical basis, but provided the magnitude of the margins is kept small relative to bid/offer dealing spreads, the method and systems remains valid from a practical perspective. In this case, the issue can be dealt with by adopting suitable accounting methods for the products, for example on an accruals basis.

b) “Size”

We should take note at this point of a significant departure from conventional IRS dealing. Embodiments of the present invention are most naturally traded in terms of a risk amount VaR. Conventional IRS are traded in terms of Notional Amount. It is simple to convert Notional Amounts to VaRₛ by using a multiplier equal to Reference IRS duration. We make use of this relationship when describing an optional trading and quotation regime in Secondary Market. We also describe modifications to trading choices on an electronic platform which make the inventive instruments tradable with minimum disruption to existing methods and systems.

For all Embodiments, parties will agree a risk amount VaRₛ for each transaction. VaRₛ is the value at risk under the transaction at inception to a 1 basis point movement in the relevant Live Quote L_{q}. It will be a figure expressed in units of IDC.

Inventive instruments driven by UCPIs from the SNIPᵢ and SNIPRᵢ families have risk amounts which are independent of time. These may be denoted as VaR. Let us look first at “size” for these instruments. Since “size” is static, we may in some cases work with unit values for convenience.

We use as the base assumption in the calculations that follow for all embodiments that prices P_{A,q} may be quoted as a number of basis points, as a percentage, or in absolute terms; the absolute value is hereafter used in the relationships between prices, risk amounts and invoice/payment amounts.

For SWS & TRI, each Series will have a Sensitivity 5087, being the change in the value of one security based upon a 1 basis point move in L_{q}. To convert prices P_{A,q} into invoice amounts for a transaction, it will be necessary to multiply by a factor H*VaRₛ. VaRₛ may also be expressed in terms of number of securities, where VaRₛ=Sensitivity*No. of Securities Nₛ.

For OIS, MCP & CCP, transactions will have a VaRₛ. There may be no denominations for these instruments.

For FUT, we further divide sensitivity into two elements. Each Futures Contract Series will have a minimum price movement Tick, defined as the smallest price increment available to the contract; for convenience, we also define Ticks per basis point Ticks/bp as 0.01%/Tick. There will also be a cash value TickVal associated with a price movement equal to one Tick per contract. Consider a contract for which the Tick is 0.001% and TickVal is $10.00; a movement in the contract price from 96.660% to 96.670% is therefore 10 Ticks, and produces a value change per contract of $100.00. By this commonly used method, VaRₛ can be expressed in terms of number of contracts, or number of lots Nₛ, where VaR=Ticks/bp*TickVal*Nₛ. To convert absolute price movements {P_{D,qj}−P_{D,qi}} into Margin Account cash movements for a transaction, it will be necessary to multiply by a factor H*VaR.

Inventive instruments driven by UCPIs from the SNIPnᵢ family have risk amounts which are dependent on time. These may be denoted as VaRᵢ, to highlight the once-daily index-based resizing. Let us consider how to account for “size” with these instruments.

We may choose to account for the dynamics of VaRᵢ through adjustment of one of two subsidiary factors: the number of trading units Nᵢ or the sensitivity of each trading unit Sᵢ. We use no subscript where that factor has no time-dependence. We will typically deploy the dynamics via Nᵢ unless instrument constraints dictate otherwise.

The size evolves from the value set at dealing as VaRₛ (=VaR_{i,s}) on fₛᵢ for value sᵢ, as follows:

$${VaR}_{i + 1} = {VaR}_{i} ( 1 + \frac{( {SNIPn}_{i} + {INM}_{i} ) ( {n}_{i} - {s}_{i} )}{{MMC}_{IDC}} )$$

For instruments such as CCP, for which Sensitivity is a superfluous concept (and so strictly takes a value S=1), we have

$${N}_{i + 1} = {N}_{i} {NF}_{i} = {N}_{i} ( 1 + \frac{( {SNIPn}_{i} + {INM}_{i} ) ( {n}_{i} - {s}_{i} )}{{MMC}_{IDC}} ) ; {N}_{i + 1} = {VaR}_{i + 1}$$

Certain instruments, for example SWS, may have pre-set trading unit UCP sensitivity Sensitivity 5087. For these instruments, the number of units held must remain constant, and the dynamics must therefore feed in via a dynamic Series sensitivity. For special case ELᵢ=EL₁=0, we define a compounding coefficient (“Sensitivity Factor”, SFᵢ), an attribute of the Series, as

$${SF}_{i} = {\prod }_{t = 1}^{i - 1} \{ 1 + \frac{( {SNIPn}_{t} + {INM}_{t} ) ( {n}_{t} - {s}_{t} )}{{MMC}_{IDC}} \} for i > 1 ; {SF}_{1} = 1$$

where t=1 applies to the Issue Date, i is here the number of business days from and including the Issue Date up to and including the value date, SF₁=1 and INMₜ=a margin applied to the benchmark rate and we have

VaRₛ=VaR_{i,s}=SFᵢ×Sensitivity×Number of Units Nₛ.

VaRᵢ₊₁=SFᵢ₊₁×Sensitivity×Number of Units Nₛ.

c) Notation

Terms not otherwise defined in this document take the definitions given in the International Swap Dealers Association (“ISDA®”) 2000 Definitions, as updated and supplemented from time to time.

“i” is a series of whole numbers from one to m, each denoting an Index-Driven Adjustment Period in chronological order from, and including, the first Index-Driven Adjustment Period in the Active Period. References to “period i” or “day i” should be taken to encompass operations performed on day fₛᵢ in respect of settlement date sᵢ and in respect of calculation period commencing sᵢ and terminating ii.

The first good business day in the Active Period is the Issue Date 5084 s₁≡s_{ID}.

The last good business day in the Active Period is the Termination Date 5002, nₘ=n_{TD}.

“j” and “k” are series of whole numbers starting from one, each representing the incidence of a periodic roll date in chronological order from, and including, the first incidence. In case the roll frequency is annual, the incidences will be anniversaries of the original date.

The spot settlement date (“spot”) associated with the first day of any IDA period i, adjusted for any applicable business day conventions and applicable financial centres, is sᵢ≡s(0)ᵢ 2045.

The next following settlement date (“next”) associated with the last day of any IDA period i, adjusted for any applicable business day conventions and applicable financial centres, is nᵢ≡n(0)ᵢ 5022.

The j^{th} incidence in a periodic roll schedule out of any spot settlement date sᵢ, adjusted for any applicable business day conventions and applicable financial centres, is s(j)ᵢ.

The j^{th} incidence in a periodic roll schedule out of any next following settlement date nᵢ, adjusted for any applicable business day conventions and applicable financial centres, is n(j)ᵢ.

The maturity date for a Reference IRS of constant maturity K 5008 with effective date sᵢ 2045 and nᵢ 5022 is s(K)ᵢ 2038 and n(K)ᵢ respectively assuming annual fixed roll frequency. For swaps quoted with a fixed payment frequency of freq 2035 per annum, we introduce a subscript to k to enumerate sequential payment dates in a given year prior to the anniversary date itself.

We use the subscript “q” to denote variables which vary continuously throughout a trading day; we use the subscript “i” to denote variables which take on a single value in a given period i; we use the subscript “c” to denote the closing value of a variable for a given period i, being the final status of variable “q” in that period; we use the subscript “s” to denote the execution value of a variable in respect of a transaction which sets the value of that variable.

The fixing date associated with a rate with effective date sᵢ is fₛᵢ 5013
The fixing date associated with a rate with effective date nᵢ is fₙᵢ.

The value, calculated on the first day of any future period i for value date t, of a zero coupon bond with maturity date T is Z_{i,t,T}≡Z(i, t, T).

The value, calculated on the first day of any period i for value n(0)ᵢ, of a zero coupon bond with maturity date n(j)ᵢ is Zⱼ≡Z(i, n(0)ᵢ, n(j)ᵢ).

The day count basis associated with the fixed leg of a given rate quote is denoted by dcb 2036.

The year fraction associated with a period running from, and including, start date tₛₜₐᵣₜ up to, but excluding, date t_{end} is yrf(tₛₜₐᵣₜ, t_{end}, dcb).

The discount factor 1050 calculated at date few for a cashflow payable on date T is λ(T)≡λ(i,T).

The closing rate on the first day of any IDA period i for a Reference IRS of currency RCDC 5028, constant maturity K 5008 and quotation basis 5096 is Ai_{i,K} 5009

The derived closing rate on the first day of any IDA period i for a Curve Point of currency RCDC 5028, constant maturity K 5008 and quotation basis 5096 is A_{i,K} 5110

The closing rate on the first day of any IDA period i for a Reference IRS of currency RCDC 5036, constant maturity K 5037 and quotation basis 5097 is Ai_{i,K} 5039

The derived closing rate on the first day of any IDA period i for a Curve Point of currency RCDC 5036, constant maturity K 5037 and quotation basis 5097 is A_{i,K} 5110

The issue price expressed as units of denomination currency IDC 5089 per security of an instrument of embodiment E is C≡C₁ 5012; for embodiment F, issue price C≡H/G.

Gearing G is the present value, expressed in basis points, of a one basis point annuity payable over dates and with a daycount as per the fixed leg of the Reference IRS

The rate for any period i for deposits in IDC 5089 made for value sᵢ maturing on nᵢ is Dᵢ 5018.

The margin to be applied to a rate for any period i for deposits with the Issuer 5024 in denomination currency IDC made for value sᵢ maturing on nᵢ is DMᵢ 5019.

The margin to be applied to a rate for any period i for implicit mark-to-market balances within the instruments in IDC calculated for value sᵢ maturing on nᵢ is MMᵢ 5006. This margin will take one positive value for (customer) credit balances MMLM (thereby generating positive value for a market-maker) and a second negative value for (customer) debit balances MMBM as formulated in MAFᵢ below.

The margin to be applied to a SNIPRᵢ rate for any period i for UCP balances is RAMᵢ 5118. This margin will take one negative value for (customer) long balances RALM and a second positive value for (customer) short balances RABM. The margin to be applied to a Di rate for any period i for synthetic cash balances is SCMᵢ 5117. This margin will take one positive value for (customer) synthetic cash debit balances SCBM and a second negative value for (customer) synthetic cash credit balances SCLM. SCBM & RALM will t_{end} to operate in tandem; SCLM & RABM will t_{end} to operate in tandem

The deposit accrual factor DAFᵢ for period i is

$$\frac{( {D}_{i} - {DM}_{i} ) ( {n}_{i} - {s}_{i} )}{{MMC}_{IDC}}$$

The mark-to-market accrual factor MAFᵢ for period i is

$$\frac{( {D}_{i} - {MM}_{i} ) ( {n}_{i} - {s}_{i} )}{{MMC}_{IDC}}$$

Sense η_{I} 5021 is an attribute of an instrument describing the direction of the price response in the instrument for an upward movement in the underlying rate. For instruments whose price rises when rates rise, η_{I}=1; for instruments whose price falls when rates rise, η_{I}=−1. Values of η_{I} for the inventive instruments are tabulated in FIG. 8H.

Direction ηₚ is an attribute of a trade in an instrument. For purchases, which result in long positions in instruments, ηₚ=1. For sales, which result in short positions, ηₚ=−1.

Parameter γ distinguishes between instruments whose value drives of SNIPᵢ indices, for which γ=1, and those whose value drives off SNIPR indices, for which γ=0. Instruments whose value drives off SNIPnᵢ indices are to be treated separately.

Parameter ε distinguishes between instruments whose overnight adjustment feeds into instrument value, for which ε=1, and those whose overnight adjustment feeds into a supporting cash account, for which ε=0.

Parameter θ_{AV} distinguishes between instruments whose contribution to unrealized P&L is made via Asset Value, for which θ_{AV}=1, and those whose contribution to unrealized P&L is made via Unrealised P&L, for which θ_{AV}=0.

Parameter θ_{IA} distinguishes between instruments whose acquisition/disposal involves a cash payment, for which θ_{IA}=1, and those bought & sold on margin, for which θ_{IA}=0.

Parameters θ_{M,E} and θ_{M,I} distinguish between instruments such as FUT which involve an external margin requirement, for which θ_{M,E}=1 and θ_{M,I}=0, and those such as Margined Curve Points & iMID OIS which involve an internal margin requirement, for which θ_{M,E}=0 and θ_{M,I}=1. We then have θ_{M,E}+θM,I=1.

Parameter θ_{M,AB} distinguishes between positions in instruments, such as long SWS, for which there is no margin (PFE) requirement, for which θ_{M,AB}=0, and others, for which θ_{M,AB}=1. It allows discrimination and avoids double-counting in product accounting.

Initial capital margin ICM(bp) is the margin requirement, expressed in basis points, to cover potential future exposure from movements in open position value.

The dual demands of describing the processes involved in making and using the present invention both in clear, concise text and in drawings has led us to employing text and numerical identifiers for many attributes within classes. These identifiers may appear together or separately. For example, the Option Adjustment attribute featuring in embodiment E is referred to with text identifier OAᵢ and with numerical identifier 5026, according to context.

d) Adjustment Factor Calculation 1700

Positions in inventive instruments held overnight experience UCPI-driven value adjustments IDAᵢ. For SWS, OIS & TRI, each Series has an evolving Entry Level ELᵢ; Entry Level Adjustment ELAᵢ is the non-zero component of IDAᵢ and is applied to the Series. The impact on position value is felt via the change in Series value. For MCP, CCP & FUT, Margin Balance Adjustment MBAᵢ is the non-zero component of IDAᵢ and is applied to the Margin Account. The impact on position value is felt via the change in Margin Account balance.

IDAᵢ=ELAᵢ+MBAᵢ (1A)

ELAᵢ=ε[γ(SNIPᵢ−η_{I}MAᵢ)+(1−γ)(SCIᵢ−RAIᵢ)+η_{I}(αOAᵢ+ELAM−βDAᵢ)] (1B)

MBAᵢ=(1−ε)[γ(SNIPᵢ)−(1−γ)RAI_{I}+ηₚη_{I}ELAM] (1C)

Prevailing Entry Level ELᵢ 5007 will be calculated according to a step-wise chronological process, for which the unit of each time-step will be one business day. Specifically,

ELᵢ₊₁=ELᵢ+ELAᵢ (2)

From above, we see that ELAᵢ 5017 has up to 5 components, 4 of which relate to the terms and conditions of the instrument, and 1 of which relates to the UCP. The values of α, β, γ, ε and η_{I} are tabulated in FIG. 8H

FIGS. 8A, 8B & 8C chart the process by which ELAᵢ 5017 is calculated according to the pricing model which is described below and can be implemented by computer program. FIG. 8C tabulates and consolidates combinations of instrument attributes and positions in those instruments as a net result, expressed in terms of η_{I}. We note here that action “Buy” leads a position “Long”; the action “Sell” leads to a position “Short”.

Instruments which deploy SNIPᵢ 5016 also involve a value component of form MAᵢ 5005; SNIPRᵢ-driven instruments involve SCIᵢ and RAIᵢ. Funded embodiments, such as examples E and F, will involve a second cash-related element DAᵢ 5098. Embodiments which incorporate a maximum or minimum pay-out, such as SWS, are likely to involve a calculation of an option-related element of a form following that of OAᵢ 5026.

In step C1, we load market data from Input Data Manager 1600, data from the Yield Curve class 1000 and instrument attributes 5000 from the Instrument database 220. We then calculate index components MAᵢ 5005 and DAᵢ 5098. The figures are reported back to the Instrument database 220,5000.

Proceeds adjustment DAᵢ 5098 appears in relation to the presence of primary cash raised upon launch of an instrument 5000. The borrower 5024 credits the instrument via the Entry Level for the interest earned on this cash on a daily basis, with compounding to reflect that repayment is deferred until maturity 5002. The value is as follows:

$${DA}_{i} = \frac{{C}_{i}}{Senstvty H} {DAF}_{i} ; \\ {C}_{i} = {C}_{1} * {\prod }_{t = 1}^{i - 1} \{ 1 + \frac{( {D}_{t} - {DM}_{t} ) ( {n}_{t} - {s}_{t} )}{{MMC}_{IDC}} \} for i > 1 \qquad ( 3 )$$

Mark-to-market Adjustment MAᵢ 5005 appears in relation to the pay-out deferral which is a repetitive feature over the life of the instruments. Market-makers will experience negative (positive) mark-to-market on their positions. These mark-to-markets will appear as debits (credits) payable (receivable) for value spot. Instruments may systematically postpone the cashflow until the following business day. The value associated with this postponement has to be captured in the instrument, and market-makers may apply margins in calculating this value. FIG. 8E tabulates preferred combinations of these margins, including those in a SNIPR regime for which SCIᵢ/RAIᵢ combine to act as SNIPᵢ/MAᵢ; the net result is a charge to end-users. We account for the value via ELᵢ on a daily basis. There is no direct compounding, since the effect is passed through from period to period via the influence on ELAᵢ

The value is as follows:

$${MA}_{i} = [ {η}_{I} ( {Λ}_{i , K} - ( {EL}_{1} + {\sum }_{t = 1}^{i - 1} {ELA}_{t} ) ) - β \frac{{C}_{i}}{Senstvty H} ] {MAF}_{i} \qquad ( 4 )$$

where Cᵢ 5010 is as defined above.

In step C2, we calculate the Forward Swap Premium SNIFᵢ 5015, an element of the forward-CMS adjustment SNIPᵢ 5016. Component SNIPᵢ is a charge/credit relating the risk associated with an overnight position against the Live Quote. SNIFᵢ is present to account for roll date difference for a spot-starting Reference IRS traded on day fₙᵢ versus those on day fₛᵢ

For step C2, we must calculate at the close on day fₛᵢ the expected rate Φ_{i,K} 5014 for the (forward-starting) Reference IRS with effective date nᵢ, expressing it as a difference relative to the fixing-corrected (spot-starting) rate Λ_{i,K} 5009. The figure is reported back to the instrument database. A full expression for the value Φ_{i,K} is presented in Annex A.i.

SNIFᵢ=Φ_{i,K}−Λ_{i,K} (5)

Via step C3, we calculate:

SNIPᵢ=SNIFᵢ+CCᵢ+QCᵢ (6)

The factor SNIPᵢ is unique to each Curve Point, IDC and Instrument Source Panel combination. The factor ELAᵢ will be unique to each instrument and/or position.

The Convexity Correction CCᵢ 5004 appears to account for a mismatch between the natural payment basis on the Reference IRS relative to the promised spot payments under the instrument.

The Quanto Correction QCᵢ 5003 appears to account for situations in which IDC is not the same as RCDC. In this situation, the index user has protection against adverse FX rate movements, specifically the weakening of RCDC 5028 relative to IDC 5089. The value of this benefit is charged back to the index by way of the third term in the expression for SNIPᵢ.

Full expressions for the values are presented in Annex A.ii. and Annex A.iii.

For spread instruments, we calculate the values for Lead and Drop components independently exactly as before, including any quanto and/or convexity corrections. However, the Lead Component makes a positive contribution to the Entry Level Adjustment, while the Drop Component contributes in the opposite sense. Stated mathematically,

SNIP(Spread)ᵢ=SNIP(Lead)ᵢ−SNIP(Drop)ᵢ

In step C4, we calculate the option-related adjustment OAᵢ 5026. OAᵢ may appear for embodiments which are strict assets of the holders. In these cases, protection is provided to an instrument holder in the form of the minimum price of zero, which imposes a discontinuity in the pay-off of the instruments relative to movements in L_{q}. The value of this benefit is charged back to the holder by way of the component OAᵢ. A full expression for the value is presented in Annex A.iv for single rate instruments, and in Annex A.v for spread instruments.

In cases where DAᵢ is zero, we could replace the proceeds-driven option adjustment OAᵢ with a more flexible stop-loss feature. Users would be free to specify stop-loss barriers for their positions, either in terms of P/L (equating to a changing strike) or fixed strike. The safeguard termination mechanism may be absent from instruments of this configuration.

In a number of optional embodiments, it is possible to incorporate an Entry Level Adjustment Margin ELAM 5001 into ELAᵢ. ELAM can be expressed as a fixed periodic amount, or in alternative embodiments could be expressed as a rate. It would represent a drain on instrument value to holders.

For instruments with non-zero MBAᵢ, a proxy for prevailing holding cost ELᵢ 5007 may be calculated according to a modified step-wise chronological process, for which the unit of each time-step will be one business day. Note however that associating a given transaction with a portion of the Margin Account balance is arguably an artificial exercise. Specifically,

ELᵢ₊₁=ELᵢ+ηₚη_{I}MBAᵢ−(MFAᵢ+CIAᵢ); EL_{I}=ExLₛ (2F)

MBAᵢ 5017 has up to three components, two of which relate to position, and one of which relates to the UCP.

Mark-to-market Adjustment MFAᵢ 5005 appears as a result of marking a position to market. For externally-margined instruments, this is known as variation margining. To calculate the mark-to-market, we need to define a rate Λ_{F,C,i} determined from the closing price P_{F,C,i} for the series on every day i by P_{F,C,i}=η_{I}(Λ_{F,C,i}−EL₁). P_{F,C,i} will be closely related to the last traded price. On day 1, variation margin VM₁=η_{I}ηₚ (Λ_{F,C,1}−ExLₛ). For each subsequent day i, the change in variation margin ΔVMᵢ is given by ηₚ η_{I} (Λ_{F,C,i}−Λ_{F,C,i-1}) and the cumulative variation margin VMᵢ is given by

VMᵢ=ηₚη_{I}(Λ_{F,C,i}−ExLₛ) (3F)

The percentage credit MFAᵢ to the Margin Account is an interest amount on the cumulative variation margin. We can define this credit as

MFAᵢ=VMᵢMAFᵢ (4F)

Where negative, this figure will act as a debit to the Buyer's Margin Account. For internally-margined instruments, we replace VMᵢ in (4F) above with unrealised P&L UPL_{C,i}. The cashflow is notional rather than real in this case.

Compound adjustment CIAᵢ 5098 appears in relation to the cumulative effects in the Margin Account from holding an open position in instrument 5000 since position inception. The account provider 5024 credits/debits the position via the Margin Account for the interest earned/payable on position-induced balance on a daily basis. The value is as follows:

$${CIA}_{i} = [ \begin{matrix}- {η}_{p} {η}_{I} {\sum }_{t = 1}^{i - 1} {SNIP}_{t} - {\sum }_{t = 1}^{i - 1} ELAM + \\ {\sum }_{t = 1}^{i - 1} {MFA}_{t} + {\sum }_{t = 1}^{i - 1} {CIA}_{t}\end{matrix} ] {MAF}_{i} , for i > 1 \qquad ( 5 F )$$

We can then relate the lifetime profit/loss P/L of the position with reference to a rate equivalent ExL_{d} of a contract disposal price P_{F,C,d} executed on day i for value sᵢ. P/L is the sum of credits/debits to the Margin Account and is therefore

P/L=ηₚη_{I}(ExL_{d}−ELᵢ) (6F)

where ηₚ is the direction of the opening transaction

A non-zero ELAM, bundled with SNIPᵢ, gives rise to a margin adjustment which differentiates long positions from short positions. For example, for FUT(η_{I}=−1), long positions: SNIPLᵢ=−SNIPᵢ−ELAM; short positions SNIPSᵢ=SNIPᵢ−ELAM. Further, a market host might simultaneously set ELAM=0, or make a portion of it a rebate, for specific customer groups, such as liquidity providers as an incentive for their market-making service.

In further optional arrangements, applicable for all embodiments and especially CCP, we use indices SNIPRᵢ and indices SNIPnᵢ so as to enable integration with the prior art instruments. By this method, we treat UCP positions as positions in a funded UCP commodity and in cash. SNIPRᵢ represents a spot/next yield for the funded UCP asset expressed as a dividend rate; SNIPn_{i,K} represents a spot/next funding cost for the UCP commodity expressed in units of itself:

$$\begin{matrix}{SNIPR}_{i , K} = {Λ}_{i , K} {D}_{i} - {SNIP}_{i , K} \frac{{MMC}_{IDC}}{{n}_{i} - {s}_{i}} & ( 1 R ) \\ {SNIPn}_{i , K} = \frac{{SNIPR}_{i , K}}{{Λ}_{i , K} + {SNIP}_{i , K}} & ( 1 N )\end{matrix}$$

Systems which deploy SNIP_{i,K} and SNIPR_{i,K} have the advantage that VaR remains the cumulative arithmetic sum of instrument transactions: a VaR-sized purchase is offset by a VaR-sized sale irrespective of the period between the transactions. Instruments fuelled by SNIP_{i,K} and SNIPR_{i,K} UCPIs, with their static VaRₛ lend themselves to examination per unit, and we have taken advantage of this thus far within the Adjustment Factor Calculation section.

In systems which deploy SNIPn_{i,K}, instrument position balances VaR_{i,K} becomes a dynamic function of value date:

$${VaR}_{i + 1 , K} = {VaR}_{i , K} ( 1 + ( {SNIPn}_{i , K} + {INM}_{i} ) \frac{( {n}_{i} - {s}_{i} )}{{MMC}_{IDC}} )$$

This has the advantage of allowing instrument balances to be processed in isolation, without recourse to a parallel IDC cash account. Where SNIPn_{i,K} is negative, this will lead to a reduction in the instrument balance from sᵢ to nᵢ.

SNIPnᵢ is most applicable for the CCP product; a SNIPnᵢ-driven CCP embodiment has dynamics most closely matching conventional FX positions. However, since dynamics for a broader set of instruments can be described by SNIP_{i,K} and SNIPR_{i,K}, we do not explore the full usefulness of SNIPn_{i,K} in this patent application. However, we detail the position dynamics within Balance Adjustment Calculation.

Returning to static VaR instruments, using SNIPRᵢ, processing of positions can therefore be integrated more straightforwardly into existing share/bond platforms. To elaborate, we consider UCP with price L_{q} as akin to a foreign currency, the purchase of which is financed by payment of domestic currency RCDC. Consider buying one UCP unit at price ExLₛ. The short domestic currency position, initially scaled as ExLₛ units, is financed at its established S/N cash rate; the long Curve Point (foreign currency) position earns interest at rate SNIPR_{i,K}, likely to be negative, which is credited (debited where negative) daily against the domestic currency short cash balance. In this sense, it resembles the cash dividend from a share, or the coupon from a bond. This reinforces the ability for open-ended trading of UCPs in line with practices in existing markets.

We can retain expression (6F) for lifetime position P/L, with the terminal contractual percentage pay-off emerging as the result of a compounding step-wise process

P/L=ηₚη_{I}(ExL_{d}−ELᵢ) (6R)

However, we break down component contributions to ELᵢ differently. Under this new decomposition, with ε=1 and γ=0,

$$\begin{matrix} {EL}_{i + 1} = {EL}_{i} + {ELA}_{i} & ( 2 R ) \\ {ELA}_{i} = {SCI}_{i} - {RAI}_{i} + {η}_{I} ( α {OA}_{i} + ELAM ) - {η}_{I} β {DA}_{i} & ( 3 R ) \\ {SCI}_{i} = ( {EL}_{i} + {η}_{I} β \frac{{C}_{i}}{Sensitvty * H} ) \frac{( {D}_{i} + {SCM}_{i} ) ( {n}_{i} - {s}_{i} )}{{MMC}_{IDC}} & ( 4 R ) \\ {RAI}_{i} = \frac{( {SNIPR}_{i} + {RAM}_{i} ) ( {n}_{i} - {s}_{i} )}{{MMC}_{IDC}} & ( 5 R )\end{matrix}$$

where SCMᵢ and RAMᵢ are margins applied to Dᵢ and SNIPRᵢ respectively which will be agreed bilaterally between suppliers and their customers in the course of their commercial dealings. For example, margin SCMᵢ could be that employed between a prime broker and a client in respect of a consolidated cash balance in currency IDC. These margins will generally be configured to generate positive value for market-makers.

On a practical level, we expect suppliers to employ RAMᵢ more actively than SCMᵢ to extract value from positions. With respect to accuracy, we observe that short-term deposit rates such as EONIA are quoted to an accuracy of only 2 decimal places in the percent. We expect to produce SNIPRᵢ figures to greater accuracy; we note that the market here signals a high tolerance for rounding with respect to daily compounded rates. We also note that a SNIPᵢ figure rounded and published to the nearest one hundred thousandth of a percentage point corresponds most closely to a SNIPRᵢ figure expressed to the nearest thousandth of a percentage point.

As a general comment, market participants adopting the indices for inclusion as value drivers within financial contracts may bear risk against the index fixings. Within the definitions provided by the leading derivatives market trade association, ISDA®, percentage figures are, unless otherwise specified, to be rounded to the nearest one hundred thousandth of a percentage point (9.876541% is rounded to 9.87654% and 9.876545% is rounded to 9.87655%). Agreement on index values to an accuracy to one ten millionths of a percentage point can be reached off pre-agreed input data and methods, and agreement at an order of magnitude of hundred thousandths of a percentage point, the maximum accuracy prescribed by ISDA® for governing contractual payments, is likely across the family of (production) systems in commercial operation. Agreement at this order is not necessary for the validity of the present invention. We also observe that current output values (USD & EUR) of CCᵢ are 0.00001%-0.00020% and those of QCᵢ are less than 0.00010%; these values are small relative to bid/offer spreads in the IRS market, and the risks associated with the value of these elements can be managed in the general course of an IRD trading activity. Their small scale, allied with their intra-day stability, means that in practice Dealers will be willing to assume them without explicit daily notification.

(e) Balance Adjustment Calculation

For SNIPnᵢ-driven instruments, it is more convenient to work in terms of instrument positions as opposed to instrument units. For SWS, use of SFᵢ allows analysis at the unit level.

The initial instrument balance IB₁ associated with a transaction is set by the transaction risk amount VaRₛ; it is given by

IB₁=ηₚHVaRₛ

Balances in inventive instruments held overnight experience SNIPnᵢ-driven value adjustments IBAᵢ given by

$${IB}_{i + 1} = {IB}_{i} + {IBA}_{i} = {η}_{p} H {VaR}_{i + 1} , i > 1$$

$$\begin{matrix}{VaR}_{i + 1} = {VaR}_{i} + {IAA}_{i} \\ = {VaR}_{i} + {VaR}_{i} \frac{( {SNIPn}_{i} + {INM}_{i} ) ( {n}_{i} - {s}_{i} )}{{MMC}_{IDC}} )\end{matrix}$$

A negative value of SNIPnᵢ will lead to a reduction in the instrument balance. For instruments with pre-set denominations, the number of units held remains constant, but the sensitivity of the holding is modified through application of the Sensitivity Factor.

Margin INMᵢ may follow RAMᵢ in having one value INLMᵢ for long balances and a second value INBMᵢ for short balances, agreed between end-user and account provider as part of general terms of business. However, for certain embodiments such as SWS, the value must be variable, and is determined as a function of other parameters. For SNIPn-driven SWS (ELᵢ=0):

$${INM}_{i} = [ \frac{- \frac{{C}_{i}}{{S}_{1} H} ( {DM}_{i} - {MM}_{i} ) - {Λ}_{i , K} {MM}_{i} - ( ELAM + {OA}_{i} ) \frac{( {n}_{i} - {s}_{i} )}{{MMC}_{IDC}}}{{SF}_{i} ( {Λ}_{i , K} + {SNIP}_{i , K} )} ]$$

where DMᵢ≧0, MMLM≧0, MMBM≦0 (as defined in Notation), ELAM≧0, OAᵢ≧0, and so INMᵢ is a charge against the instrument value.

Cash balances held overnight experience Dᵢ-driven value adjustments CBAᵢ. The initial cash balance CB₁ induced by a transaction is the invoice amount, given by

CB₁=−ηₚExLₛHVaRₛ

Subsequent cash balances CBᵢ are given by

$${CB}_{i + 1} = {CB}_{i} + {CBA}_{i} = {CB}_{i} + {CB}_{i} \frac{( {D}_{i} + {CM}_{i} ) ( {n}_{i} - {s}_{i} )}{{MMC}_{IDC}} )$$

We can track the profitability of individual positions by aggregating the real-time cash value AssV_{q} of the instrument account balance VaRᵢ with the compounded cash balance CBᵢ. Note that this will be an artificial exercise in situations where multiple positions contribute to instrument and particularly to cash balances.

$${V ( T )}_{q} = {η}_{p} {VaR}_{s} H ( \begin{matrix}- {ExL}_{s} {\prod }_{t = 1}^{i - 1} \{ 1 + \frac{( {D}_{t} + {CM}_{t} ) ( {n}_{t} - {s}_{t} )}{{MMC}_{IDC}} \} + \\ {L}_{q} {\prod }_{t = 1}^{i - 1} \{ 1 + \frac{( {SNIPn}_{t} + {INM}_{t} ) ( {n}_{t} - {s}_{t} )}{{MMC}_{IDC}} \}\end{matrix} )$$

We may also product a proxy for holding cost EhLᵢ as

$${EhL}_{i} = {ExL}_{s} {\prod }_{t = 1}^{i - 1} \{ 1 + \frac{( {D}_{t} + {CM}_{t} ) ( {n}_{t} - {s}_{t} )}{{MMC}_{IDC}} \} / {\prod }_{t = 1}^{i - 1} \{ 1 + \frac{( {SNIPn}_{t} + {INM}_{t} ) ( {n}_{t} - {s}_{t} )}{{MMC}_{IDC}} \}$$

We may also develop an expression for the lifetime profitability P/L of two precisely offsetting transactions as follows:

$$P / L = {η}_{p} {VaR}_{s} H ( \begin{matrix}- {ExL}_{s} {\prod }_{t = 1}^{i - 1} \{ 1 + \frac{( {D}_{t} + {CM}_{t} ) ( {n}_{t} - {s}_{t} )}{{MMC}_{IDC}} \} + \\ {ExL}_{d} {\prod }_{t = 1}^{i - 1} \{ 1 + \frac{( {SNIPn}_{t} + {INM}_{t} ) ( {n}_{t} - {s}_{t} )}{{MMC}_{IDC}} \}\end{matrix} )$$

where ηₚ is the direction of the first of the two offsetting transactions

(f) Total Return Indices

There is great flexibility with respect to construction of embodiment F-type instruments. Rules regarding the nature and frequency of any Reference IRS risk linkage and rebalancing, and as to the relative risk weightings of distinct Reference IRS, may vary. For example, the scale of the Live Quote-based risk position at inception could be derived from the PV01 Γ_{i,K} of a market-priced spot-starting Reference IRS, or from the PV01 G_{K} of a spot-starting Reference IRS with pre-specified fixed rate. The scale of the risk could be static (fixed at inception) or dynamic. Where dynamic, the resealing of risk could be carried out a fixed time intervals, for example each day in response to market-driven changes to G_{i,K}, or at fixed risk deviations, for example when a market movement first causes the mismatch between the risk as last scaled into the index and that in a market-adjusted equivalent to rise above a pre-specified threshold irrespective of time taken. These total return measures may also incorporate a resealing of risk according to prevailing present value, or may be permanently referenced against the inception cash value. They may also incorporate minimum and maximum constraints, through inclusion of an option adjustment component, either as a percentage of prevailing value or of inception value. In all cases, the T-R Indices will capture realised market movements relative to daily expectations. Critically, the composition of these T-R Indices can be governed by published rules, and they can be designed such that their performance can be captured by way of real investment actions which adhere to these rules.

In one example, a T-R Index can be created which involves daily rebalancing to a prevailing market constant maturity risk equivalent and which involves scaling relative to cumulative performance since inception. This is best considered as a string of daily risk positions, closed out and reset at the closing rates for a given day. In this example, from an inception value C₁=10,000, set so to give base value TRI₁=100.00%,

TRI(live)_{q,i+1}=TRI(close)ᵢ{1+(Λ_{i,k}+ELAᵢ−L_{q,i+1,K})G(n)_{i,K}};

TRI(close)ᵢ₊₁=TRI(close)ᵢ└1+(Λ_{i,K}+ELAᵢ−Λ_{i+1,K})G(n)_{i,K}┘

where G(n)_{i,K} denotes the gearing of the K year Reference IRS, with effective date nᵢ, based off closing rates on day fₛᵢ, where ELAᵢ=SNIPᵢ+DA*ᵢ and where

$${DA}_{i}^{*} = \frac{{C}_{1}}{{G ( n )}_{iK} H} G \cdot {DAF}_{i}$$

In this special case, MAᵢ 5005 is absent as a result of benchmarking against daily closing values. For an investable version, in which respective bids and offers would need to be considered for rebalancing, component MAᵢ 5005 would return.

In an extension to this and other optional T-R Index embodiments, it would be possible to combine risks across a set of maturities according to rules regarding weightings, for example splitting inception value into fixed constituent weightings C(K)₁ across maturities K such that

$${\sum }_{K = 1}^{30} {C ( K )}_{1} = 10 , 000$$

Annex A.i-Forward IRS Premium SNIFᵢ 5015 Calculation (All Embodiments)

We illustrate the key stages involved in the method of evaluating the Forward Swap Premium in FIG. 9A.

The standard method by which market practitioners generate forward IRS rates proceeds via the production of zero coupon discount factors. The process is implemented by many commercially available analytics software packages, such that we need only summarise the important steps and choices here. The present invention relies upon the presence and use of these existing data structures, methods and systems. Among the conventions and methods used are date adjustment schemes (e.g. Business Day Convention, Business Centres), weighting methods (e.g. Daycount Fraction Scheme), interpolation methods (e.g. Linear, Splines for example as described in Bartels et al. (1998)) and extrapolation methods (e.g. Linear, Flat).

We load Input Rates for a given RCDC term structure into Yield Curve Manager 3800. Yield Curve Manager 3800 sets and loads currency and yield curve conventions 1000 and builds a yield curve for distribution.

Where we require intermediate rates not present in the Input Rate set for fully defining the curve, Yield Curve Manager employs splicing and interpolation methods to generate them from Input Rates. It is equipped to use short-term interest rate futures prices as part of this curve-building process where necessary.

We convert Input and intermediate Rates into grid-point date discount factor by a series of methods including a bootstrapping method. These can in turn be converted into grid-point date zero coupon rates by a series of methods.

We need to generate discount factors applicable to non-grid-point dates. To do so, we first produce non-grid-point date zero coupon rates by a series of methods, and convert them back into discount factors by a series of methods.

The non-grid-point discount factors can be reconstituted via a series of methods into a forward swap rate Φ_{i,K} as per FIG. 9A and also to create PV01 G_{i,K}.

Consider the payments associated with the “next” Reference IRS: the n(0)ᵢ value of receiving one unit of Reference IRS denomination currency as an annuity over the fixed leg payment dates is

$$PV 01 {G ( n )}_{i , K} = {\sum }_{j = 1}^{K} {Z}_{j} {ω}_{n , i , j} \qquad A . i .1$$

Consider also the payments associated with the “spot” Reference IRS: the s(0)ᵢ value of receiving one unit of Reference IRS denomination currency as an annuity over the fixed leg payment dates is

$$PV 01 {G ( s )}_{i , K} = \frac{{\sum }_{j = 1}^{K} {χ}_{j} {ω}_{s , i , j}}{{χ}_{s }} \qquad A . i .1 . a$$

Sampling of FLT_{Lq}¹

The deposit rate for index tenor 2028 from source 2056 is not directly available on a live basis, since the averaging process is only conducted once per day at the time of the fixing. We can, nonetheless, develop a method for determining FLT_{Lq}¹. We can also sample a closing market rate FLT_{Ci}¹ as a special case of FLT_{Lq}¹ at the close. FLT_{Lq}¹ acts on an intra-day basis to reference the value contribution of the floating fixing prior to the close. FLT_{Ci}¹ marks the fixing FLT_{Fi}¹ to market and also acts as the base from which to project the first fixing on tomorrow's spot-starting IRS. We may sample live deposit quotes directly, ensuring a consistent & reliable contributor set. Where this is not deemed sufficient, we may seek recourse to additional instrument prices. In one embodiment of the process, we snapshot the OIS with maturity 2028 at the time of the floating fixing. We then apply a constant basis assumption, adding the change in the OIS rate to FLT_{Fi}¹ to arrive at FLT_{Lq}¹ and FLT_{Ci}¹. We could also moderate this with a parallel exercise covering the (two) front STIR futures contracts, adjusting proportionately for the period of overlap between these contracts and the rate fixing. The change in price acts as a reference for the OIS-derived deposit-rate move.

### Optional Post-Fixing Curve Definition

In one optional curve-building embodiment, we use the constant basis assumption which gives a value FLT_{Lq}¹. We define the discount factor λ_{FLT1} applicable to payments scheduled for the termination date of the deposit contract of tenor 2028 as

$$\frac{{χ}_{s}}{( 1 + ( {FLT}_{Lq}^{1} {ω}_{FLT 1} ) )} .$$

Now, consider a 1 yr IRS, quoted vs a floating index which sets FLTk times a year, at rate L(p)_{q,1}. The known payments under this swap are: (i) L(p)_{q,1} ω_{FXD1} on the fixed leg, and (ii) FLT_{Fi}¹ ω_{FLT1} on the floating leg. We use this information to determine the discount factor at the 1 yr point for the LIBOR curve.

The PV of payments on the floating leg is given by FLT_{Fi}¹ω_{FLT1} λ_{FLT1}+λ_{FLT1}−λ_{FLTk}. The value of the fixed leg payment is L(p)_{q,1} ω_{FXD1} λ_{FXD1}. We note that λ_{FXD1}=λFLTk

Equating the value of these two sets of flows and substituting,

$${χ}_{FXD 1} = \frac{{χ}_{FLT 1} ( 1 + {FLT}_{Fi}^{1} {ω}_{FLT 1} )}{1 + {L ( p )}_{q , 1} {ω}_{FXD 1}}$$

We derive closing discount factors when FLT_{Lq}¹=FLT_{Ci}¹ and L(p)_{q,K}=Λ_{i,K} for all K.

Let us now consider longer-dated IRS. We can deal here with a switch of short-rate floating indices (for example in EUR from 3 m to 6 m EURIBOR as the floating leg index for IRS with a maturity of 2 yrs or more) as necessary.

The present value of the floating leg (FLT_{Fi}¹ is here the rate for the K>1 designated maturity) is FLT_{Fi}¹ω_{FLT1} λ_{FLT1}+λ_{FLT1}−λ_{FXDK}. The present value of the fixed leg is

$${L ( p )}_{q , K} {\sum }_{j = 1}^{K} {χ}_{FXDj} {ω}_{FXDj}$$

By equating these values and manipulating

$${χ}_{FXDK} = \frac{{χ}_{FLT 1} ( 1 + {FLT}_{Fi}^{1} {ω}_{FLT 1} ) - {L ( p )}_{q , K} {\sum }_{j = 1}^{K - 1} {χ}_{FXDj} {ω}_{FXDj}}{1 + {L ( p )}_{q , K} {ω}_{FXDK}}$$

When this optional curve-building embodiment is employed to the closing curve, we apply adjustments δ_{q,K} to closing rates Λ_{i,k} to produce SNIF₁ and OAᵢ, as per FIG. 9D.

Annex A.ii—CCᵢ 5004 Calculation (All Embodiments)

The second term in the formulation of SNIPᵢ, the convexity correction CCᵢ 5004, uses attributes of variable F_{i,K} including its calculated closing rate Φ_{i,K} as an input. The term relates to differences in payment basis between the security, which condenses the rate movements to “spot” value adjustments, and the natural rate. Key stages in its calculation are illustrated in FIG. 9B.

For instruments with a value linked to SNIPᵢ, by design a one basis point (1 bp) change in the Curve Point rate results in a fixed change in instrument value across all yield levels; there is no convexity

$$( \frac{d P}{d {L}_{i}} = 1 , \frac{{d}^{2} P}{d {L}_{i}^{2}} = 0 ) .$$

By contrast, the change in Reference IRS value for a 1 bp rate change is contingent on yield levels i.e. convexity is present

$$( \frac{d P}{d {L}_{i}} \neq constant , \frac{{d}^{2} P}{d {L}_{i}^{2}} \neq 0 ) .$$

There are two steps to evaluating the convexity correction. The first step is to model the yield curve movements, and the second is to evaluate the expected value of the change in payment basis under this model. Following Brotherton-Ratcliffe and Iben (1993) as amended by Haug (1998), we have

$${CC}_{i} = - \frac{1}{2} \frac{\frac{{d}^{2} P}{d {F}_{i , K}^{2}}}{\frac{d P}{d {F}_{i , K}}} {Φ}_{i , K}^{2} ( exp ( {σ}^{2} {T}_{fni} ) - 1 ) \qquad A . ii .1$$

where P is the value of the fixed leg of a forward swap with fixed coupon and roll dates matching F_{i,K}, σ is the implied volatility of forward rate, and T_{fni} is the period in years between fixing day fₛᵢ and fixing day fₙᵢ calculated according to an Actual/365 calendar. Values for the partial derivatives can be generated numerically or by using 3^{rd} party financial analytics libraries.

In one optional embodiment, we take

$$\frac{d P}{d {F}_{i , K}} = PV 01 and \frac{{d}^{2} P}{d {F}_{i , K}^{2}} = \frac{d PV 01}{d {F}_{i , K}}$$

There is some evidence that volatility on trading days exceeds that on non-trading days. In one optional embodiment, we implement the variable T_{fni} in the above formulation as the number of trading days between fixing day fₛᵢ and fixing day fₙᵢ divided by the number of trading days per calendar year. This has the effect of increasing the convexity value between weekdays while decreasing the convexity connection applicable over weekends. This alternative method may also apply to the daily option values OAᵢ.

Annex A.iii—QCᵢ 5003 Calculation (All Embodiments)

Quanto instruments settle in one currency IDC while having a value determined relative to a Reference IRS in a second currency RCDC. We can model the change in value via the forward swap rate Φ_{i,K} and incorporate the value via our expression for SNIPᵢ. Key stages in its calculation are illustrated in FIG. 9C.

We find in practice that the quanto correction and convexity correction for the present invention can be calculated independently, and are additive.

Valuation of quanto options was pioneered by Derman, Karasinski & Wecker (1990) and is summarised in Haug (1998). As applied to our interest rate environment, we find

QCᵢ=Φ_{i,K}{exp(−ρ_{fx}σ_{fx}σ_{rc}T_{fni})−1} A.iii.1
where ρ_{fx} is the correlation between forward rate F_{i,K} and the exchange rate, σ_{rc} is the implied volatility of the forward rate (previously σ), σ_{fx} is the implied volatility of the exchange rate from the Market Data Manager, and T_{fni} is the period in years between fixing day fₛᵢ and fixing day fₙᵢ calculated according to an Actual/365 calendar.

For quanto correlation ρ_{q}, we consider IDC as domestic currency. RCDC is considered as the foreign currency, and we take the exchange rate to be quoted as domestic currency per foreign currency i.e. IDC/RCDC. ρ_{q} is then the correlation between that exchange rate and the rate for the Reference IRS. If strength in the domestic currency (IDC/RCDC ↓) is accompanied by falls in the Reference IRS rate (F_{i,K} ↓), meaning p(IDC/RCDC, F_{i,K})>0, the quanto correction is negative, and vice versa.

Let us denote this new quanto-corrected forward CMS rate as Φ_{i,K,fx}. Bearing in mind the sequential nature of the calculation of ELAᵢ, for the avoidance of doubt, we can state that the convexity correction is calculated as before from the original Φ_{i,K}, but that the option adjustment is calculated using Φ_{i,K,fx} in place of Φ_{i,K}.

Annex A.iv—OAᵢ 5026 Calculation—Single Reference IRS (Embodiment A)

This calculation is iterative, and the strike of the option in each successive iteration is a function of the output value from the previous iteration. For the first iteration, we set strike as ELᵢ₊₁ calculated prior to inclusion of this value component, which we denote for this purpose with an additional subscript EL_{i+1,1}. We solve until the results for successive iterations do not differ at the degree of rounding 5099 employed. Given the very low strike sensitivity dP/dX, this occurs in practice after very few iterations.

We need to invoke a model to place a value on this. A suitable model is the Black-76 model, which assumes the forward rate is lognormally distributed, consistent with our model for the convexity correction.

For any period i, our input parameters to the model are:

Strike, iteration 1=X₁≡EL_{i+1,1}

Strike, iteration c (c>1)=X_{c}≡EL_{i+1,1}+ηOV_{c-1}

Forward CMS rate=Λ_{i,K}+SNIPᵢ

Time to expiry=T_{fni}

Implied volatility=σ

Risk-free interest rate=0

Note that Φ_{i,K}, T_{fni} and σ take identical values to those used in calculating CCᵢ 5004, unless there is a significant volatility smile associated with an option struck at X_{c}, in which case a distinct volatility can be employed, either directly supplied or interpolated from a supplied surface. The directly supplied figure may be calculated by adding a fixed upward adjustment to C to account for fat tails in the underlying distribution. The option value needs no discounting, since it is charged on its expiry date.

A Payer-instrument incorporates an implicit long put option on the rate, and

$${OV}_{c} = {X}_{c} N ( - {d}_{2} ) - ( {Λ}_{i , K} + {SNIP}_{i} ) N ( - {d}_{1} ) \\ {d}_{1} = \frac{ln ( ( {Λ}_{i , K} + {SNIP}_{i} ) / {X}_{c} ) + {σ}^{2} {T}_{fni} / 2}{σ \sqrt{{T}_{ni}}} , \\ {d}_{2} = \frac{ln ( ( {Λ}_{i , K} + {SNIP}_{i} ) / {X}_{c} ) - {σ}^{2} {T}_{fni} / 2}{σ \sqrt{{T}_{ni}}} , \qquad A . iv .1$$

N(z) denotes the cumulative normal distribution function

Then OAᵢ=OV_{c}, where c is the smallest integer for which OV_{c-1}=OV_{c}

A Receiver-security incorporates an implicit long call option on the CMS rate, and

OV_{c}=(Λ_{i,K}+SNIPᵢ)N(d₁)−X_{c}N(d₂) A.iv.2
where d₁ and d₂ are as defined above and where N(z) denotes cumulative normal distribution function

Then OAᵢ=OV_{c}, where c is the smallest integer for which OV_{c-1}=OV_{c}

Annex A.v—OAᵢ 5026 Calculation—Spread

As in the single rate case, the calculation is iterative. For the first iteration, we set strike as ELᵢ₊₁ calculated prior to inclusion of this value component, which we denote for this purpose with an additional subscript EL_{i+1,1}. We solve until the results for successive iterations do not differ at the degree of rounding 5099 employed. Given the very low strike sensitivity dP/dX, this occurs in practice after very few iterations.

We need to invoke a model to place a value on this. Kirk (1995) created a suitable model via transformation of the Black-76 model, which achieves consistency with previous model assumptions.

For any day i, our input parameters to the model are:

Strike, iteration 1=X₁≡EL_{i+1,1}

Strike, iteration c (c>1)=X_{c}=≡EL_{i+1,1}+ηOV_{c-1}

Forward rate, Lead=F₁≡Λ(1)_{i,K1}+SNIP(1)ᵢ

Forward rate, Drop=F₂≡Λ(2)_{i,K2}+SNIP(2)ᵢ

Time to expiry=T_{fni}

Implied volatility, Lead=σ₁

Implied volatility, Drop=σ₂

Rate correlation=ρᵣ

Risk-free interest rate=0

Note that Φ(1)_{i,K1}, Φ(2)_{i,K2}, T_{fni}, σ₁ and σ₂ take identical values to those used in calculating the convexity correction. The option value needs no discounting, since it is charged on its expiry date.

A Payer instrument incorporates an implicit long put option on the Spread, and

$${OV}_{c} = ( {F}_{2} + {X}_{c} ) [ N ( - {d}_{2} ) - FN ( - {d}_{1} ) ] \\ where {d}_{1} = \frac{ln ( F ) + {σ}_{F}^{2} {T}_{fni} / 2}{{σ}_{F} \sqrt{{T}_{fni}}} , \\ {d}_{2} = \frac{ln ( F ) - {σ}_{F}^{2} {T}_{fni} / 2}{{σ}_{F} \sqrt{{T}_{fni}}} , \\ F = \frac{{F}_{1}}{{F}_{2} + X} , \\ {σ}_{F} = \sqrt{{σ}_{1}^{2} + {[ {σ}_{2} \frac{{F}_{2}}{{F}_{2} + X} ]}^{2} - 2 {ρσ}_{1} {σ}_{2} \frac{{F}_{2}}{{F}_{2} + X}} \qquad A . v .1$$

and where N(z) denotes the cumulative normal distribution function as before.

Then OAᵢ=OV_{c}, where c is the smallest integer for which OV_{c-1}=OV_{c}

A Receiver instrument incorporates an implicit long call option on the Spread, and

OV_{c}=(F₂+X_{c})[FN(d₁)−N(d₂)] A.v.2
where d₁ and d₂ are as defined above and where N(z) denotes the cumulative normal distribution function

Then OAᵢ=OV_{c}, where c is the smallest integer for which OV_{c-1}=OV_{c}

### Annex A.vi

For a generic spot-starting IRS, the first short-rate fixing FLT_{Fi}¹ on the floating leg typically occurs on the trade date fₛᵢ. This fixing relates to a defined source 2056 and to a defined floating index tenor 2028, with start date sᵢ and maturity date s(1₁)ᵢ. Once fixed, the first payment on the floating leg of the swap becomes known.

The presence and timing of the fixing gives rise to an effect which is relevant to the relationship between UCP quotes L_{q} and IRS quotes Li_{q} within a given day. Let us first determine the value of the short-rate fixing.

Post-fixing on trading day fₛᵢ, a proxy for prevailing market rate FLT_{Lq}¹ for deposits from source 2056 with tenor 2028 can be generated.

The intra-day mark-to-market V_{FLT} of the floating leg is then given by

$${V}_{FLT} = ( {FLT}_{Lq}^{1} - {FLT}_{Fi}^{1} ) {ω}_{FLT 1} \frac{{χ}_{FLT 1}}{{χ}_{s}}$$

where ω_{FLT1} is yrf(s(0)₁, s(1₁)ᵢ, dcb(FLT_{Fi})) and λ_{FLT1} is the discount factor applicable to payments on s(1₁)ᵢ.

Now, this floating leg value is common to all spot-starting IRS in currency RCDC, irrespective of tenor K. However, its impact on the rate for each K-year IRS is variable. We must convert from units of price into units of rate. The conversion factor into the K-year index is the PV01 G(s)_{q,K}, where we apply the suffix q to represent the fact that this PV01 is a dynamic function of prevailing market conditions.

Thus, the adjustment δ_{q,K} is given as

$${δ}_{q , K} = \frac{{V}_{FLT}}{{G ( s )}_{q , K}}$$

A sample calculation is featured in FIG. 9D.

Now, one relationship between UCP quotes L_{q} and IRS quotes Li_{q} prevails prior to the short-rate fixing, and is supplanted by a second relationship after the short-rate fixing. We refine our notation by denoting the live IRS quotes made during these periods as Li(a)_{q} and Li(p)_{q} respectively. In one optional embodiment, we define the following relationships with the live quotes L_{q} for inventive instrument business (explicitly showing the K-dependence of the quote which is generally suppressed):

L_{q,K}=Li(a)_{q,K}

L_{q,K}=Li(p)_{q,K}+δ_{q,K}

Rates Li(p)_{q,K} are forward-starting Par-coupon instruments; rates L_{q,K} are their spot-starting equivalents.

Values δ_{q,K} are typically only a few hundredths of a basis point. As a result, for many ongoing processing functions, excluding the generation of SNIFᵢ and live instrument pricing, UCP quotes and IRS quotes are interchangeable on a practical level, for example in calculating CCᵢ, QCᵢ, MAᵢ, and OAᵢ. This has the operational benefit that adjustments δ_{q,K} may be omitted from trade maintenance regimes where agreed between the parties, and may rely on Reference IRS rates.

### Annex A.vii Trigger Chance

Provision of Trigger Chance is an example of one novel real-time data stream to support use of instruments of the present invention.

For those instrument types which incorporate a mandatory early termination mechanism, such as Embodiment E, end-users and dealers will be exposed to the risk of a mandatory close-out of their position. This will occur when instrument prices decline. It is an event which holders may wish to avoid. One method by which a user might manage their risk would be by switching out of an instrument which becomes likely to experience mandatory termination into a second instrument referenced against the same Curve Point for which the likelihood of early termination is smaller. One measure of likelihood is Trigger Chance TC_{q}, the probability that L_{q} breaches the Safeguard Termination Level STLᵢ for the instrument over a pre-specified horizon. In one optional embodiment, users will be able in a suitably interactive environment such as the index calculator's internet site to specify a Trigger Chance Horizon TCH and receive an individually calculated TC_{q}(TCH) relating to that horizon. In another optional embodiment, in a display of pre-configured instrument characteristics, the horizon will have been chosen for the viewer in line with conventions established for the instrument and the associated probability will be displayed.

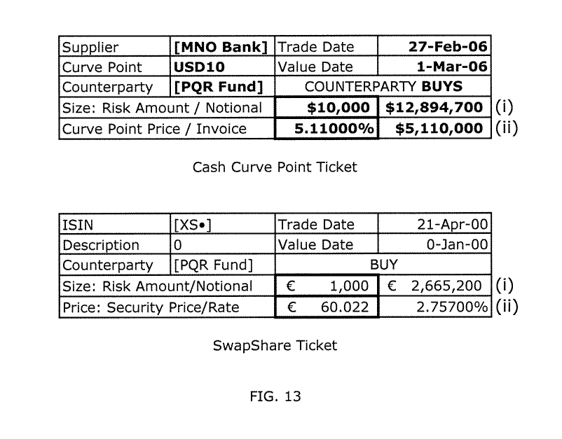

FIG. 16 shows the process of calculating TC_{q} using the example instrument and market of FIG. 13. First, select TCH, for example 1 month. Driven by this selection 1202, and the day i on which selection is made, we define a TCH End Date TCHEDᵢ. We call on algorithms as defined above in the Index Calculation Process for SNIFᵢ 5015, CCᵢ 5004, & QCᵢ 5003, substituting the S/N input rate for a S/TCH input rate and a 1 business day implied volatility input for a TCH expiry implied volatility input and substituting a S/N forward horizon for a TCH forward horizon. From this, we derive a convexity-adjusted forward rate F(L_{q}).

The likelihood of a mandatory termination event can be approximated by treating STL as the barrier in a binary barrier cash-at-hit option. However, we must account for the presence of a daily-stepped barrier level. In a preferred optional methodology, we observe that the projected growth g(STLᵢ) of STLᵢ relative to F(L_{q}) reduces to

$${\sum }_{t = i}^{TCHED i - 1} ( η ( {DA}_{t} + {MA}_{t} - {OA}_{t} - {ELAM}_{t} ) ) .$$

In this treatment, the likelihood of a mandatory termination event can be approximated by taking STLᵢ as the static barrier in a binary barrier cash-at-hit option. We derive a financing rate D_{Lq} for this treatment as follows:

$${D}_{Lq} = ln \{ 1 + ( ( {L}_{q} + g ( {STL}_{i} ) ) / {L}_{q} - 1 ) ( \frac{365}{{TCHED}_{i} - {s}_{i}} ) \}$$

We may then proceed to evaluate the probability. Following Reiner and Rubenstein (1991) as quoted in Haug (1998), solving for knock-out probability TC, we have

$$\begin{matrix}TC = {( {STL}_{i} / {L}_{q} )}^{( μ + λ )} N ( {η}_{I} z ) + {( {STL}_{i} / {L}_{q} )}^{( μ - λ )} N ( {η}_{I} z - 2 {η}_{I} λσ √ T ) \\ where μ = \frac{{D}_{Lq} - {σ}_{F}^{2} / 2}{{σ}_{F}^{2}} , \\ λ = \sqrt{{μ}^{2} + 2 r / {σ}_{F}^{2}} , \\ z = \frac{ln ( \frac{{STL}_{i}}{{L}_{q}} )}{{σ}_{F} \sqrt{T}} + λ {σ}_{F} \sqrt{T} ,\end{matrix}$$

η_{I}=logical operator as in Notation

Time to expiry T=(f_{TCHEDi}−fₛᵢ)/365

Implied volatility, F(Lq)=σ_{F}

Interest rate r=0.

For spread instruments, we observe that the projected growth g(STLᵢ) of STLᵢ relative to [F(L(1)_{q})-F(L(2)_{q})] reduces to

$${\sum }_{t = i}^{TCHEDi - 1} ( η ( {OA}_{t} + {ELAM}_{t} - {DA}_{t} - {MA}_{t} ) ) ,$$

and we employ the following formulations:

$$\begin{matrix}{D}_{SPRq} = {D}_{L ( 1 ) q , L ( 2 ) q} \\ = ln \{ 1 + ( ( {L ( 1 )}_{q} + g ( {STL}_{i} ) ) / {L ( 1 )}_{q} - 1 ) ( \frac{365}{( {TCHED}_{i} - {s}_{i} )} ) \} \\ TC = {( STL ( m ) / {L ( 1 )}_{q} )}^{( μ + λ )} N ( {η}_{I} z ) + \\ {( STL ( m ) / {L ( 1 )}_{q} )}^{( μ - λ )} N ( {η}_{I} z - 2 {η}_{I} λσ √ T ) \\ where μ = \frac{{D}_{SPRq} - {σ}_{F}^{2} / 2}{{σ}_{F}^{2}} , \\ λ = \sqrt{{μ}^{2} + 2 r / {σ}_{F}^{2}} , \\ z = \frac{ln ( \frac{STL ( m )}{{L ( 1 )}_{q}} )}{{σ}_{F} \sqrt{T}} + λ {σ}_{F} \sqrt{T} ,\end{matrix}$$

η_{I}=logical operator as in Notation

Time to expiry T=(f_{TCHEDi}−fₛᵢ)/365

$$Implied volatility = {σ}_{F} = \sqrt{\begin{matrix}{σ}_{1}^{2} + {[ {σ}_{2} \frac{{F}_{2}}{{F}_{2} + STL ( m )} ]}^{2} - \\ 2 {ρσ}_{1} {σ}_{2} \frac{{F}_{2}}{{F}_{2} + STL ( m )}\end{matrix}}$$

Interest rate r=0.

STL(m)=L(2)_{q}+STLᵢ

e) Index Publication/Distribution 900

UCPIs, as well as packaged calculations such as ELAᵢ, must be distributed to users. A choice of distribution channels is available, according to the degree to which users will expect to interact with the published data.

The SNIPᵢ and SNIPRᵢ indices in USD and EUR are being produced and published by the index calculator 5033 under as yet unregistered trade mark “SNIP”, an acronym denoting Spot Next IRS Points. The figures have been distributed over the Reuters data platform, on Reuters pages SNIPFIXUSD and SNIPFIXEUR, commencing 7 Oct. 2005 in the case of SNIPs. They have also been published on internet site www.midanalytics.com.

Further series of pages onto which daily index information will be made available are expected to be established. Each location to which an executed financial claim of one of more parties refers for its contractually-binding index fixings will be an ELA Source 5044. For example, ELA source “EUR-SNIP-IMID” might mean that the fixing applicable for a given ELA period will be the rate appearing on Reuters page SNIPFIXEUR under heading “SNIP Fixing” in relation to EUR IRS of Reference Tenor K at or around 18H30 on the days that is two TARGET Settlement Days prior to the first day of that period. Implicit to the figures quoted on each ELA Source will be a panel 5045 of data providers contributing input data for use in that fixing calculation process.

In a preferred embodiment, users will take advantage of existing electronic data exchange infrastructures and protocols between themselves and large market data vendors such as Reuters Group plc and Bloomberg LP. In this embodiment, the factors will be given identification codes under these protocols, for example a RIC or a field within an existing form class for securities in the case where the commercial data vendor is Reuters Group plc, so as to enable efficient data retrieval, manipulation and application by Dealers and by customers. This follows practices in place for daily-published indices such as EONIA and LIBOR.

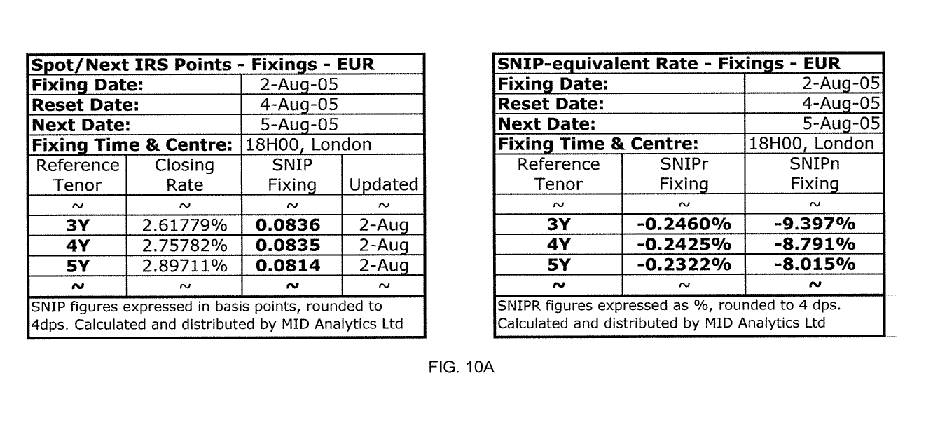

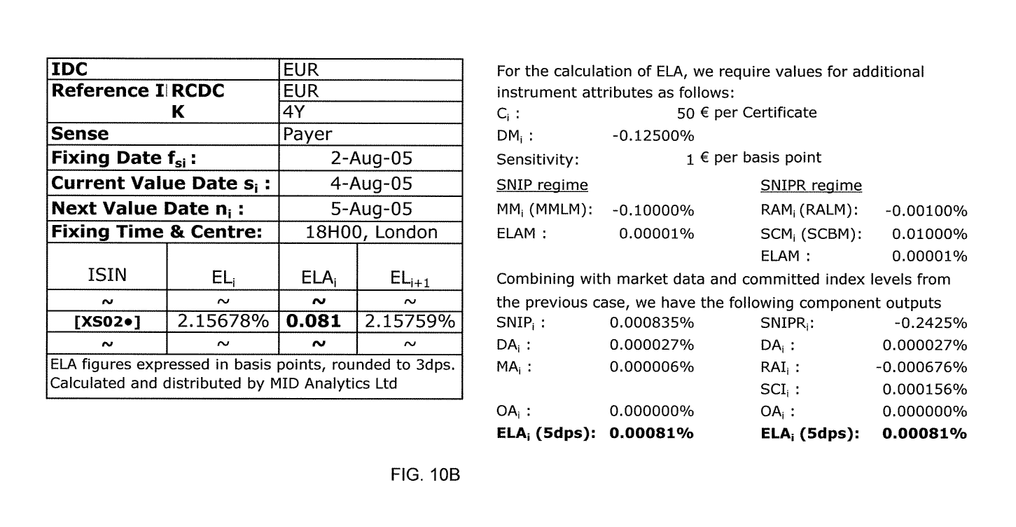

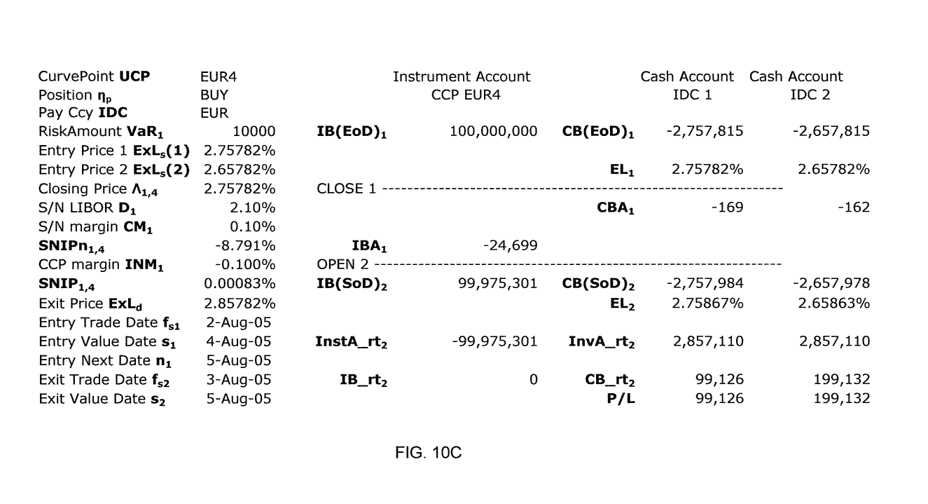

Examples of a potential read-only screen lay-out for daily publication of SNIPᵢ and ELAᵢ indices is provided in FIGS. 10A and 10B respectively.

Index fixings may also potentially be communicated directly to involved parties so that they prepare efficiently for the next day of trading. Datafiles in a variety of formats, including XML, can be exchanged for this purpose.

In a further optional embodiment, expected index values may be distributed to participating Dealers a number of hours ahead of the closing Adjustment Factor Calculation process in order to synchronise calculation library inputs and thereby eliminate avoidable data input discrepancies prior to publication of committed figures.

For Embodiment D, where the inventive contract may be a futures contract listed on an Exchange, each Exchange will be supplied directly with the factor SNIPᵢ via process 6010 in FIG. 6. In one optional arrangement, this will be a factor SNIPᵢ calculated specifically for an Exchange, based on incoming Exchange data, which cause it to differ from other factors SNIPᵢ published for the same date and Curve Point.

Clients of the Exchange with positions in contracts to which such charges apply will be notified by the exchange itself, and may be offered access to independent resources to check figures in line with commercial arrangements between the parties.

### Secondary Markets

The quotation regime tabulated per instrument in FIG. 8F defines the relationship between the UCP buy & sell quotes L_{B,q} & L_{S,q} respectively and the instrument buy & sell quotes P_{B,q} & P_{S,q}. We note that IRS Pay quote Li_{P,q} corresponds with UCP buy quote L_{B,q} and that Li_{R,q} corresponds with L_{S,q}.

The quotation regime bears a simple relationship to Sense η_{I}. For η_{I}=1, bid rate L_{B,q} corresponds with bid price P_{B,q} and L_{S,q} corresponds with P_{S,q}; for η_{I}=−1, bid rate L_{B,q} corresponds with offer price P_{S,q} and L_{S,q} corresponds with P_{B,q}.

The valuation function is defined as the formulation via which value AssV_{q} can be derived from live quote L_{q}. We can usefully at this point highlight cash instruments, which have a non-zero value AssV_{q} in their own right (TRI, SWS, CCP, OIS). CFD instruments have AssV_{q}=0, and have a value V(T)_{q} only as a function of a position in that instrument (OIP, FUT, MCP).

Instruments possess a global Entry Level ELᵢ, produced from parameters set in the primary phase, in which all transactions in that Series share and from which the value AssV_{q} of that Series, tabulated in FIG. 8F, is derived.

Let us now consider transactions in the instruments. They possess a transaction Execution Level ExLₛ. Transaction value V(T)_{q} is calculated by substituting L_{q} with ExLₛ in invoice amount, and considering the impact on cash and instrument accounts:

Execution date: V(T)_{q}=NIAₛ+NAssV_{q}

All instruments can be traded off live quote L_{q}. Certain instruments may also trade off pre-configured panels displaying prices P_{q}. For SwapShares and Cash Curve Points, these price panels could display values P_{q}=V(I)_{q}. For iMID Futures, the price panels could display quotes P(Futures)_{q}=η_{I}(L_{q}−EL₁), where EL₁=100% for η_{I}=−1 and EL₁=0% for η_{I}=1.

The specifications of each Series are loaded into trading platforms as part of the primary phase. This may include establishing agreed support services, such as analytical functions or ticket processing linkages. It is then made available for trading among market participants who simply require access to settlement facilities for the clearing system in question.

Each Series may have a set of designated market-makers. Instruments may be traded with customers by private negotiation, over Exchange trading systems and over other selected e-commerce platforms. By this method and system, users will therefore be capable of trading a commoditised IRS risk (i.e. Series) freely from a number of potential suppliers over an electronic platform.

An electronic fixed-income trading platform is a wide area network of computers connected in such a way as to allow the participants to execute transactions between each other. These could be auction systems, cross-matching systems, inter-dealer systems, multi-dealer systems or single-dealer systems. The wide area network of computers could optionally be the Internet. Further optional embodiments exist in which the risk exchange is in bi-lateral form, for example a contract-for-difference and the trading platform is a wide area network of computers, for example the Internet or Bloomberg.

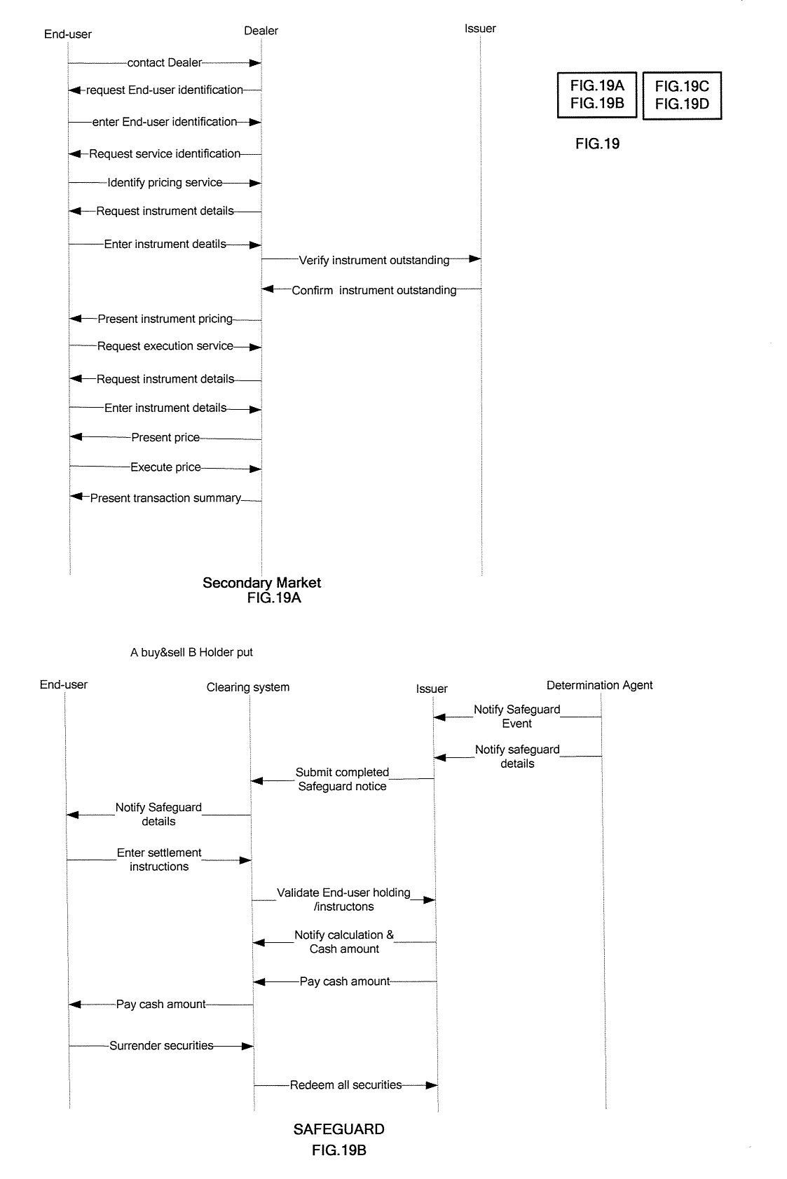

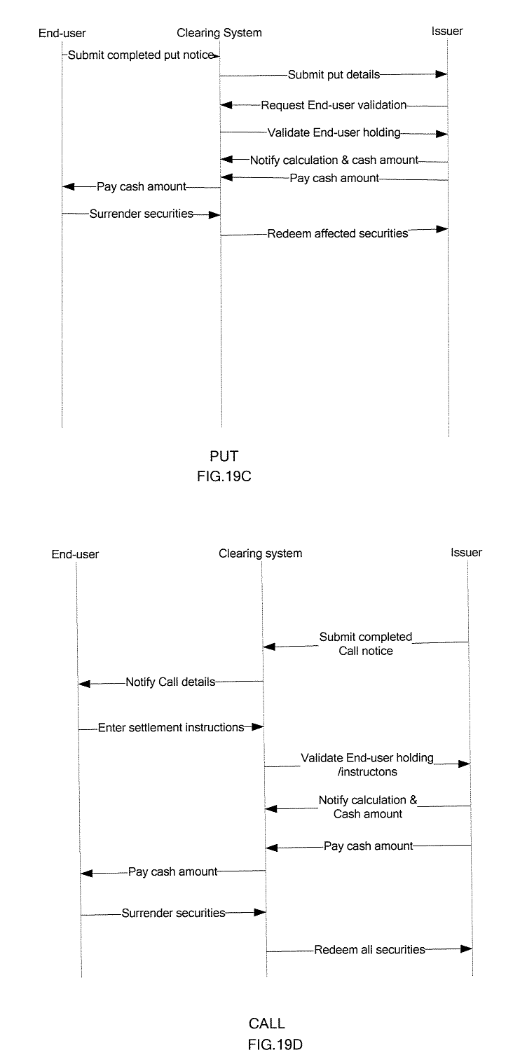

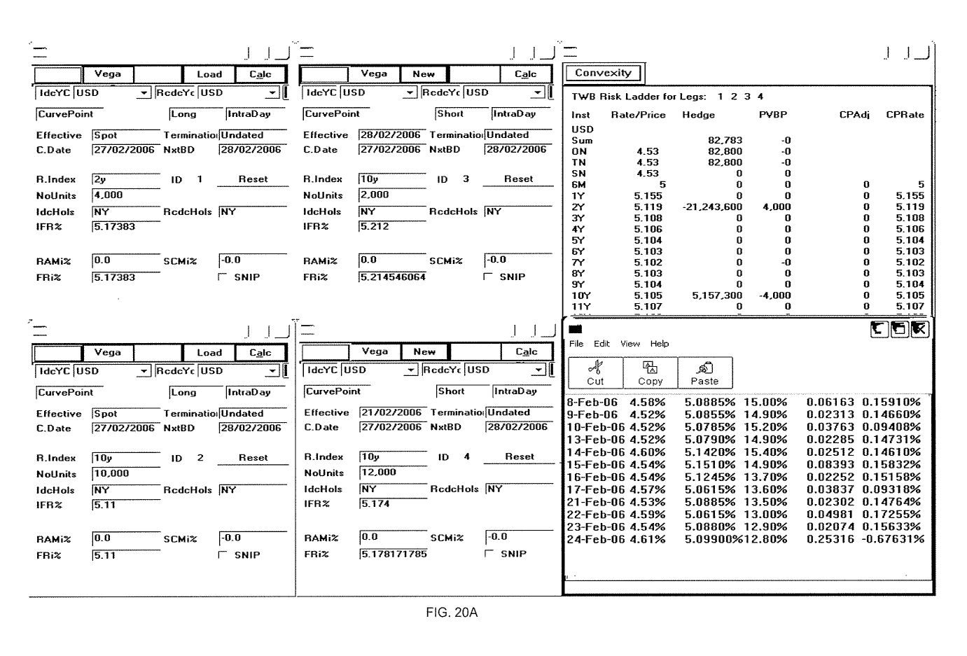

{Broaden beyond Embodiment E?} Secondary markets in the instruments will be the main entry and exit routes for users. FIG. 19A is an event trace diagram for this process. From before, we have price P_{A,q} quoted as tabulated in FIG. 8F.

Ticketing

The nature of these instruments will be initially unfamiliar to potential users. New market conventions must be established to ensure homogeneity in the manner in which instrument prices are displayed, and in the manner in which trading and ticketing is conducted.

Tickets in iMID instruments vary according to product. However, all tickets must convey information in 6 key areas: an instrument identifier, the trading partners, their respective positions, the size, the execution price, and the trade date & settlement date.

We tabulate in FIG. 8G the expected default ticket data. Let us consider the ways in which this information may be organised, and the ways it may need translating for the purpose of efficient trade capture.

Series identifier: The identifier for the Series may be a code from an external classification such as ISIN (SWS, FUT, TRI), an internal reference of a counterparty (OIS, TRI), or a direct UCP reference UCPₛ. (MCP, CCP, OIP, TRI). Use of UCP, may incorporate data gathered on the path to execution.

Trading Partners & Buy/Sell: Every transaction involves a Buyer and a Seller; tickets must identify them. In the case of OIP, for which the ticketing burden is greatest, the price-taker is deemed the Buyer (ηₚ=1), with Sense set according to whether the price-taker pays (η_{I}=1) or receives (η_{I}=1); by this regime, price-makers are Sellers (ηₚ=−1) of OIP. Upon instantiation, OIP undergoes an instantaneous transition into OIS, and the Buyer may increase (ηₚ=1) or decrease (ηₚ=−1) the instrument size through secondary trading. Save for OIP, Buyer and Seller may be identified by each party confirming its own position ηₚ and its counterparty C/Pₛ to a (third party) clearing agent. Existing ticket protocols ensure that parties are able to communicate their position unambiguously, and iMID instruments will share these protocols according to product format.

Transaction Timing Trade date has a default value fₛᵢ and settlement date has a default value sᵢ. There is scope for trading partners to agree alternative dates.

Size: All tickets in inventive instruments have a risk amount VaRₛ. VaRₛ is the value at risk under the transaction to a 1 basis point movement in the live UCP quote L_{q}. It will be a figure expressed in units of IDC.

VaRₛ may, for the purpose of quotation and pre-execution analysis, have been converted into (i) a number of instrument units Nₛ; or (ii) a notional equivalent N_{IRS}. The relationship between these variables is as follows:

$$\begin{matrix}{VaR}_{s} = \frac{{G ( s )}_{i , K} {N}_{IRS}}{H} \\ {N}_{s} = \frac{{VaR}_{s}}{Sensitivity} ,\end{matrix} ;$$

where Sensitivity is, where variable, that retrieved from the instrument database as applicable for the settlement date in question.

VaRₛ, Nₛ or N_{IRS} may be agreed at dealing. For the purpose of ticketing, we may use VaRₛ or Nₛ. Nₛ may be referred to as number of units, number of lots or number of securities. Execution based on N_{IRS} must be supported by mutually-accepted protocols governing the source and timing associated with setting G(s)_{i,K}, and for those instruments with a pre-configured Sensitivity, there must be additional protocols to govern the rounding to produce Nₛ.

Price: Each piece of activity is associated with a UCP rate ExLₛ at dealing. ExLₛ is the instantaneous extract from the continuous live quote series at the point of execution. ExLₛ substitutes L_{q} in formulations of NAssV_{q} to give price & value at execution Pₛ & NIAₛ, with ELᵢ=ELₛ, as shown within FIG. 8F. As noted previously, ExLₛ may be expressed or presented in basis points (“450.1”) or as percent (“4.501”) as well as taking its strict value in absolute terms (“4.501%”, 0.04501”). System implementations will adjust for this through the use of scaling factors H (=10,000) and 100 respectively.

Conversion of rate ExLₛ into ticket price Pₛ requires there to be mutually-accepted protocols to govern rounding. We may also work backwards from price Pₛ to determine ExLₛ.

Price Pₛ will serve one of two functions: it will be the basis from which invoice amounts are calculated for Cash instruments, or it may be the initial reference point for margining for CFD instruments.

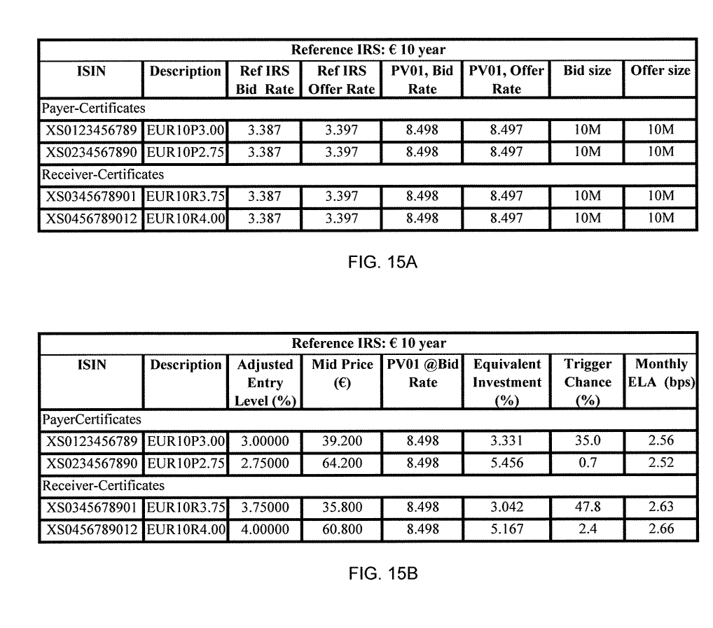

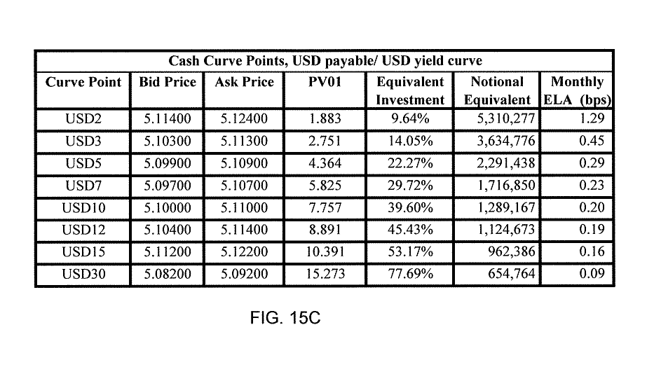

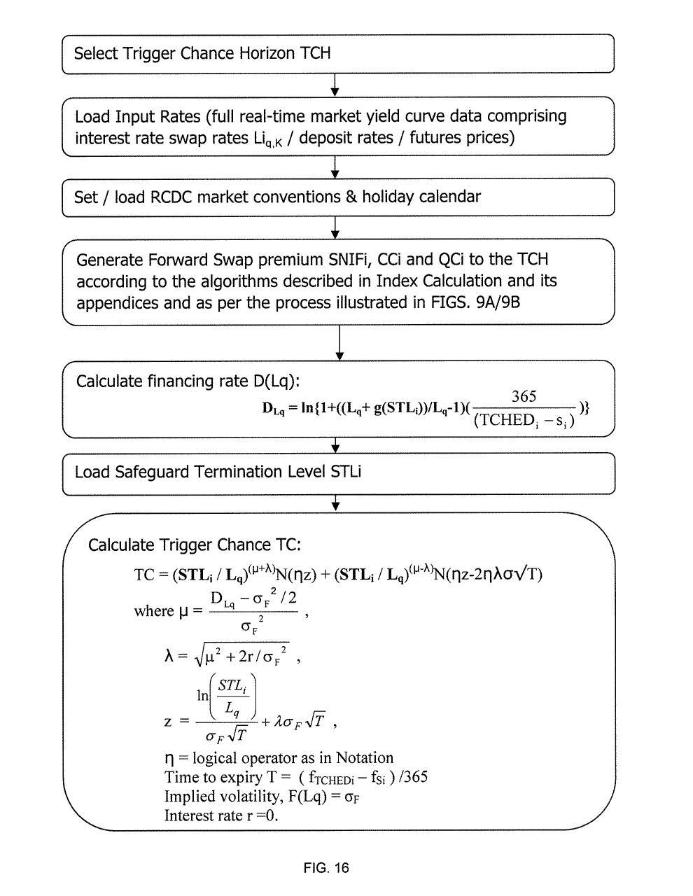

An example of price display panel for Embodiment E is given as FIG. 15A.

The Description field may adopt the following conventions for a single currency instrument: [RCDC][K][P/R][ELᵢ], where RCDC is the SWIFT code of the currency, by definition both UCP and payment currency for the Series; K is the UCP tenor in years; P/R denotes Sense, with P=Payer and R=Receiver; EL₁ is the initial entry level.

In a further optional arrangement, a number of other key instrument characteristics could be supplied via real-time processes 1900 for display for each security on an auxiliary set of screens, including Vendor screens and Internet pages. These items may include Trigger Chance (see Annex A.vii), Bond-equivalent Nominal per H securities (Sensitivity*H/G_{q,K}), Investment in securities as a percentage of Bond-Equivalent Nominal (=P_{A,q} (offer)*G_{q,K}), and estimated monthly

$$ELA ( ( {\sum }_{t = i - 5}^{i - 1} {ELA}_{t} ) * 30 / ( {n}_{i - 1} - {s}_{i - 5} ) ) .$$

An example of such a display screen for Embodiment E is given in FIG. 15B and for Embodiment A is given as FIG. 15C.

Embodiment C has certain unique ticketing requirements. Secondary activity may increase, decrease or cancel existing Series. Where η(open)_{I}=η(new)ₚ, we have η(comb)_{I}=η(open)_{I}, VaR(comb)ᵢ=VaR(open)+VaRₛ and EL(comb)ᵢ=[VaR(open)EL(open)ᵢ+VaRₛExLₛ]/VaR(comb). Where η(open)_{I}=−η(new)ₚ, we additionally require VaR(open)≧VaRₛ. If VaR(open)=VaRₛ, we cancel the open transaction with the new transaction, and generate realised P&L RPL(comb)ᵢ=VaRₛ η(open)_{I} (ExLₛ−EL(open)ᵢ). If VaR(open)>VaRₛ, we have a further choice of whether to realise P&L via the new transaction or to roll it into the open contract. If we choose to realise P&L, we generate realised P&L RPL(comb)ᵢ=VaRₛ η(open)_{I} (ExLₛ−EL(open)ᵢ, retain EL(comb)ᵢ=EL(open)ᵢ and η(comb)_{I}=η(open)_{I}, and reset VaR(comb)=VaR(open)ₛ−VaR_{S}. If we choose not to realise P&L, we have RPL(comb)ᵢ=0, VaR(comb)=VaR(open)ₛ−VaRₛ, EL(comb)ᵢ=[VaR(open)EL(open)ᵢ−VaRₛ ExLₛ]/VaR(comb) and η(comb)_{I}=η(open)ᵢ.

### Trade Execution—E-Commerce Platforms 1950

The ability to integrate the trade execution into existing electronic trading platforms (“eIRS-Platfonms”) for IRS, as well as those for foreign exchange, for securities and for futures, is important because it ensures the usefulness of the inventive contract is fully realised.

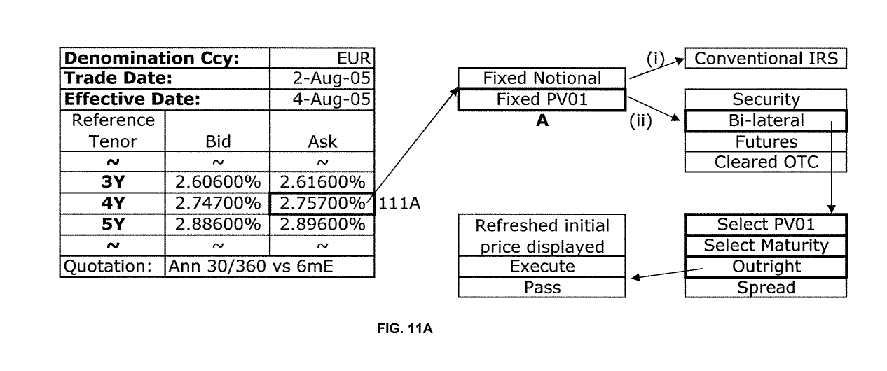

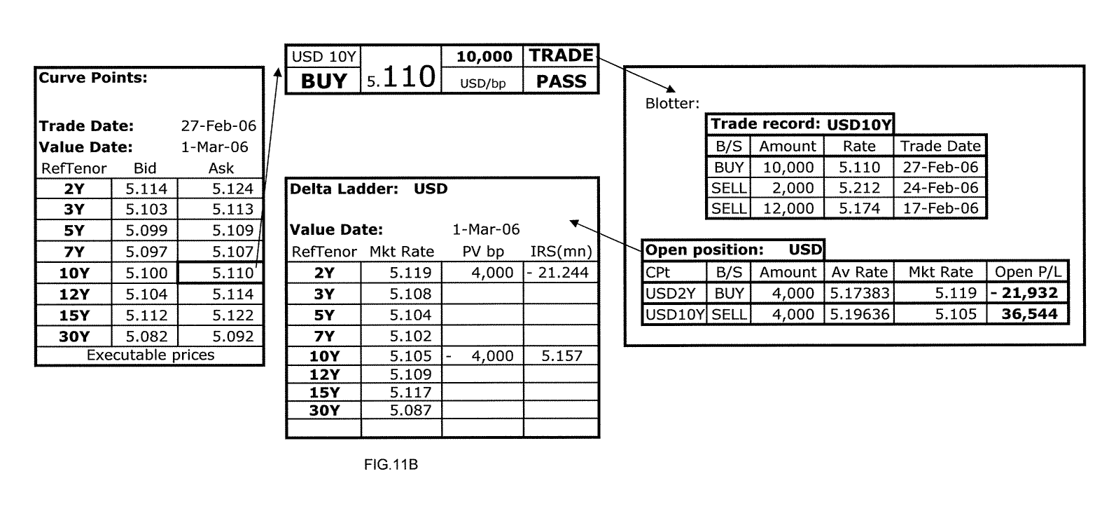

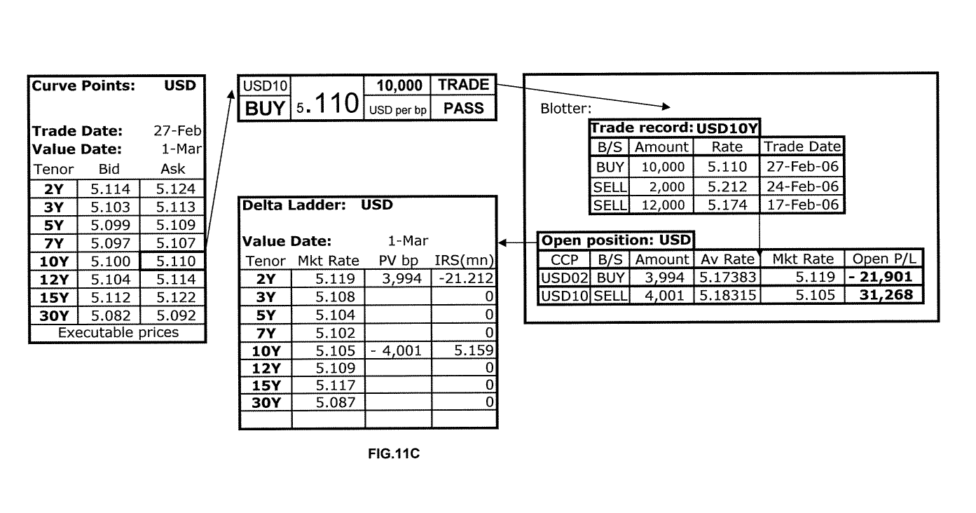

We illustrate the modifications for bi-lateral (B, C) and security (D, E) embodiments in FIGS. 11A,11B & 12 respectively. In the absence of standardised APIs across the eIRS-Platforms in commercial operation, the illustrations are schematic.

Clients approaching execution of a conventional IRS within existing eIRS-Platforms select the rate they wish to trade 111A. Normally, this would lead to the display of a new GUI as per Contract 1&2 in FIG. 1, into which the customer inserts, amongst other things, details of the counterparty in whose name they are trading and the Notional Amount of the transaction that they wish to execute.

As shown in FIG. 11A, we can insert an additional choice A in response to the initial rate selection 111A. Choice A will require clients to select from a new GUI whether they wish to execute a transaction in (i) a fixed Notional Amount or (ii) a fixed PV01. Choice (i) will take the client back into the conventional IRS description screen of a form as per FIG. 1. Choice (ii) will lead to a new GUI for execution of a transaction in an instrument of the present invention, at which stage the adjustment δ_{q,K} may be applied. Clients will be asked for details of the counterparty in whose name they are trading and the Risk Amount, or PV01, of the transaction that they wish to execute. In one optional embodiment, clients will be able to view the conventional fixed IRS notional amount equivalent to their PV01 choice. They may also be asked additionally to insert a maturity for the contract. This new choice occurs because the rate against which they are trading has been decoupled from its conventional maturity, and an independent maturity for the contract to be executed must be selected. This maturity may either be open-ended, as per conventions in FX trading, or may be short-dated (a matter of days, weeks or months) in the case of the OIS embodiments.

Having selected counterparty, size and contract maturity, in one optional embodiment the client will be required to select whether their transaction is Outright or as part of a Spread. Selection Outright will lead to a new GUI in which a refreshed price for the transaction is displayed to the customer. They will choose whether to proceed with execution or whether to pass. Selection Spread will lead to the client being required to provide details of a second UCP against which the original UCP is to be traded as a spread. In one optional embodiment, this could be achieved by returning the client to the original Reference Tenor/Rate matrix window, in which the original chosen rate is highlighted for ease of reference, and in which only the appropriate maturities (all except 10 yrs in our example) and prices (bids in our example) are available for selection. Choice of one such price will lead to a new GUI in which a refreshed price for the spread is displayed, with details of the counterparty, size and contract maturity redisplayed for convenience. The client will choose whether to proceed with execution of whether to pass.

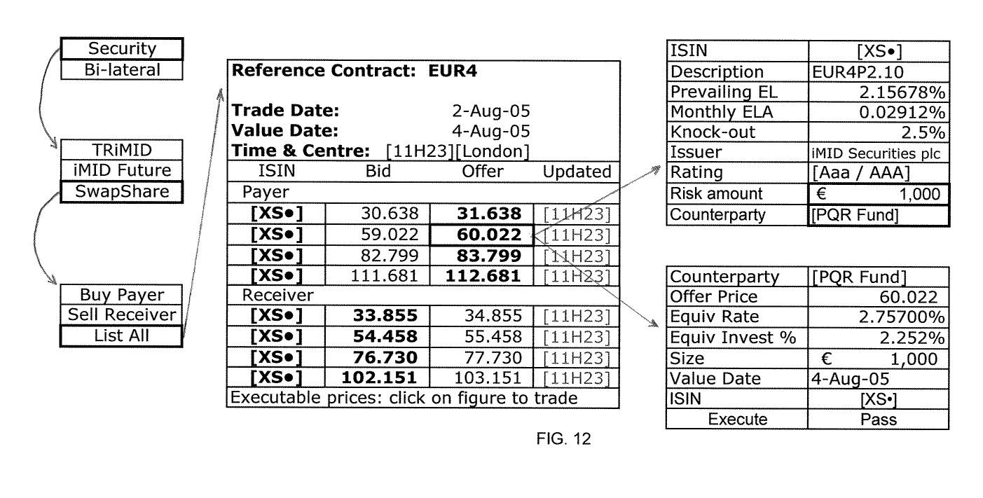

Transactions in instruments of embodiment E can also be offered by extension of the decision process facing a customer under the prior art. Specifically, after making choice (A)(ii) described above in FIG. 11A, the customer must select an instrument type. The subsequent choices upon selection Security for Embodiment E are detailed in FIG. 12. In one optional embodiment, the ability to execute securities to create a spread position can also be offered, by inclusion of the choice “Outright/Spread” within the GUI immediately prior to the display of the refreshed instrument price.

We should highlight at this point a key advantage of the present invention, relating to market access, illustrated for Embodiment E. Customers who are not currently enabled for IRS activity, and cannot therefore act upon IRS rates presented to them over an e-commerce platform, can be given a new IRS risk execution possibility, as follows: customers of this type can be recognised by the trading system, for example by suitable classification of their customer identity, so that an attempt to act upon an IRS rate presented to them will immediately be translated into a request to execute a securitised IRS risk product such as embodiment E. In other words, as represented in FIG. 11A, we bypass choice A and choice (ii) and will be immediately presented with choice of type “Buy Payer/Sell Receiver/List All” shown in FIG. 12. Alongside this customer advantage, we also have a platform advantage. Specifically, platforms which cannot currently offer conventional IRS execution, and which therefore currently present passive IRS rate market data if any to users, can now offer an execution possibility in IRS risk. Here too a customer wishing to act upon an IRS rate presented to them is immediately shown a choice of type “Buy Payer/Sell Receiver/List All” shown in FIG. 12. By this system and method, the risk classes available to users of “securities only” e-platforms is significantly enhanced.

In this case, the client will be required to select whether their transaction is Outright or as part of a Spread. Selection Outright will lead to GUIs as shown in FIG. 12. Selection Spread will lead to the client being required to provide details of a second Curve Point against which the original rate is to be spread. In one optional embodiment, this could be achieved by returning the client to the original Reference Tenor/Rate matrix screen, in which the original chosen rate is highlighted for ease of reference, and in which only the appropriate maturities (all except 10 yrs in our example) and prices (bids in our example) are available for selection. Choice of one such price will return the client to a menu structure illustrated in FIG. 11A.

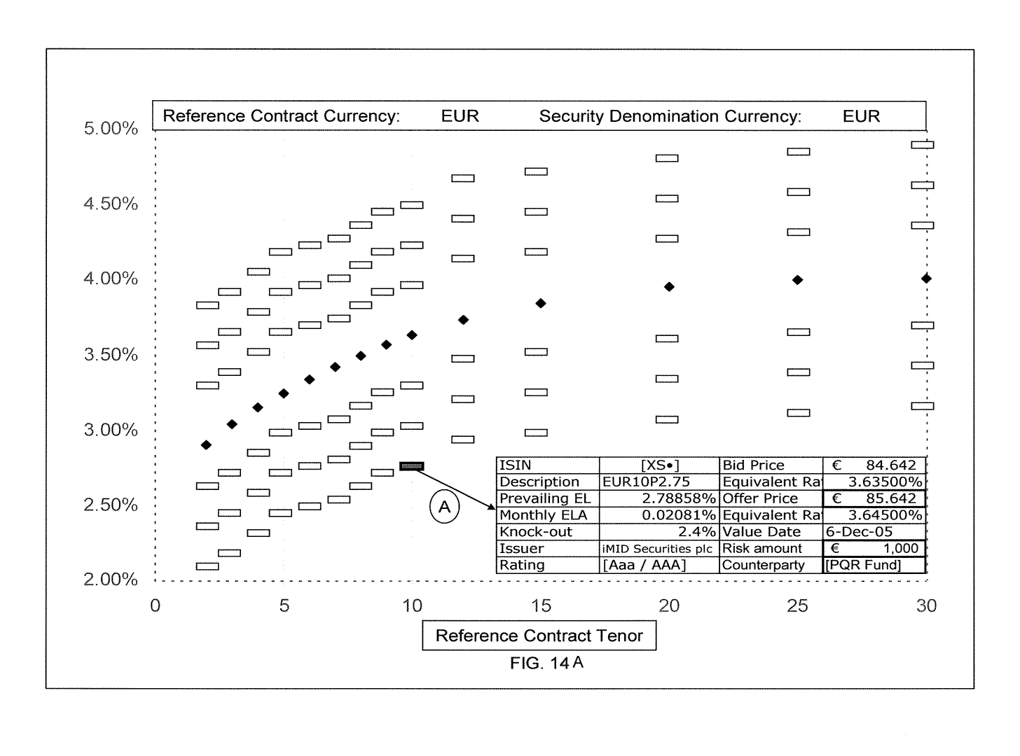

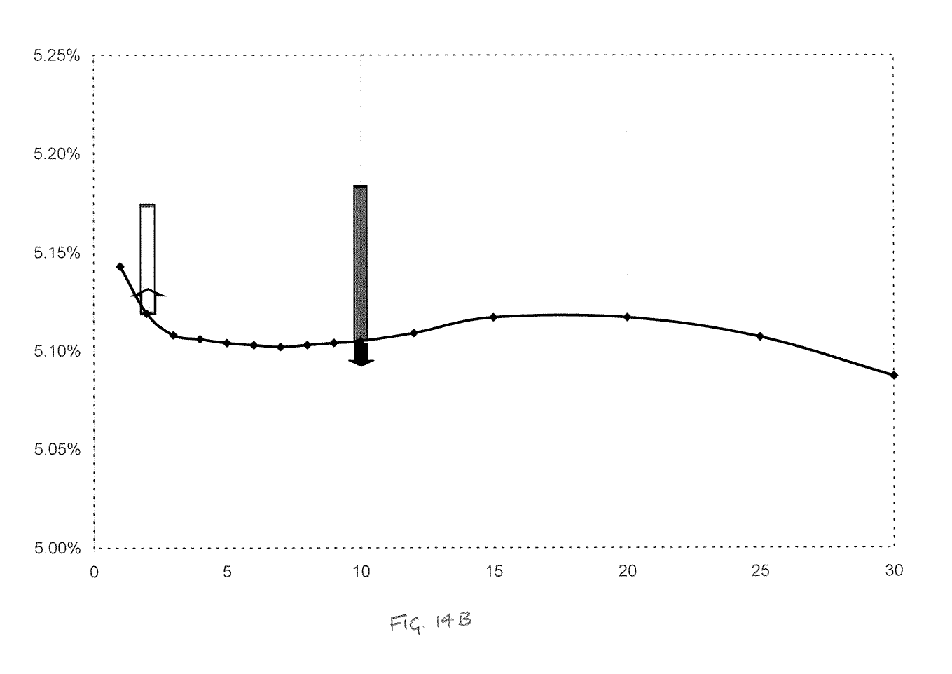

FIGS. 11B & 11C illustrates the integration of IRS risk trading into spot foreign exchange trading platforms via Embodiment B & A respectively. In line with the development of the rate L_{q} as an asset in its own right according to the present invention, we display quoted UCP rates labelled as “Curve Point”. A client selecting a specific UCP for trading, for example the Ask rate opposite the caption 10Y, is presented with an opportunity to buy that UCP, via an MCP or CCP Series, by specifying the number of units, for example 10,000, for the transaction. Should the client elect to transact, the client could be presented with a summary of recent transactions in that Series. By the method outlined in (8F) for each position, multiple positions in this Series can be aggregated to a single quantity and average price, as for trading in an FX rate. Such aggregation is not possible for conventional IRS. A client might subsequently query the trading system for their open positions across Curve Points, and such positions can be represented in novel ways relative to prior art IRS. Positions might be displayed as per FIG. 11B in the manner of a delta ladder, a common display format relating back to a conventional IRS position nominal equivalent. Positions might also be displayed in the manner of FIG. 14A or FIG. 14B, retaining tenor K of the UCP along the horizontal axis while displaying average position price on the vertical axis as opposed to the prevailing Entry Level. Active Curve Points (those in which a client has an exposure) could be displayed in different colours (for example, blue for long and red for short) relative to a neutral colour (for example light brown) for inactive grid-points. In an alternative embodiment, active UCPs could be identified with an arrow (pointing upwards for long positions or downwards for short positions). In a further embodiment, both identification systems could be employed. In a further optional embodiment, clients might interact with a display of this type by selecting a particular UCP so as to initiate a transaction as an alternative starting point for FIG. 11B.

Clients may also approach execution of securities instruments of type E within an electronic securities trading platform. In this situation, clients will be able to look up a specific Series, for example via its ISIN 5025, and be presented with a securities execution screen which is conventional in many respects to those presented for regular bond business. There are two novel elements relative to a standard bond execution screen to which we draw attention. They are shown via FIG. 13. The two novel elements of the execution data structure, method and system are (i) the security price/equivalent Curve Point rate toggle and (ii) the security risk amount PV01/equivalent Reference IRS Notional amount toggle. The relationships underpinning these toggles are described elsewhere in this document, and they implemented within real-time processes 1900.

We also present a novel graphic display within the electronic platform's graphic user interface (“GUI”) menu, illustrated in FIGS. 14A & 14B, which may enhance the execution process. Clients may be presented with a GUI showing all Series available to the client on that platform referenced to a selected RCDC/IDC pair. The GUI may display tenor K along one axis, and UCP rate along the other axis. The GUI may display the prevailing set of UCP rates as a central element. Selection of any one of these central UCP rates may then act as a basis for integration with the novel scheme illustrated in FIGS. 11A & 11B, for the trading of Embodiments A, B, C or D. The display may also accommodate display of securities, such as those of Embodiment E, as follows. If we consider an individual tenor K, Series will be displayed as cells according to their Prevailing Entry Level. In one optional embodiment, the cells will be labelled according to a security identifier, such as ISIN. As a result, outstanding Payer instruments will appear below the central UCP rate, and Receiver instruments above. In one optional embodiment, customers will be able to select individual Series. As illustrated in step A, using the example of the least leveraged Payer instrument referenced to the 10 yr EUR UCP rate, this will lead to the presentation to the customer of a new descriptive instrument GUI, containing information relating to that security, including but not limited to ISIN, Prevailing Entry Level, projected monthly ELA and Trigger Chance, as well as price information. In one optional embodiment, a chart of recent price history will be available. In one optional embodiment, customers will be able to progress to subsequent GUIs via a series of choices, resulting ultimately in execution of a transaction.

This schematic approach has the benefit of presenting the set of available instruments to customers in a readily digestible form. It will become apparent to users as they gain experience that instruments ranked closest to the prevailing yield curve level will be characterised by, for example, highest leverage and highest knock-out likelihood. Those furthest away from the prevailing yield curve level will be characterised by, for example, highest investment equivalent.

### Product Accounting

The fungibility of inventive instrument positions within a Series has a positive impact when accounting for multiple positions over a period of days. We outline a basic process here, for instruments with static VaRₛ including potential margin management, to illustrate its simplicity.

AB(SoD)ᵢ is defined as a cash account balance at the start of day i. We define AB(SoD)₁=0.
ACI_{q} is defined as external cash paid into the account during day i.
ACW_{q} is defined as cash withdrawn to external location from the account during day i.
RPL_rt_{q} is defined as the running total P&L realised from activity in iMID instruments for whom θ_{AV}=0 during day i.
IA_rt_{q} is defined as the running total invoice amount from activity in iMID instruments during day i.
VM_rt_{q} is defined as the running total change in variation margin relative to the previous close from activity in externally-margined iMID instruments during day i. This will typically be the change in unrealised P&L from FUT activity.
IM_rt_{q} is defined as the running total change in initial margin from activity in externally-margined iMID instruments. This will typically result from FUT activity.
AB(EoD)ᵢ is defined as the cash account balance at the end of day i.
UPL_rt_{q} is defined as the running total unrealised P&L associated with internally-margined iMID instruments for whom θ_{AV}=0 during day i.
AssV_rt_{q} is defined as the running total asset value in iMID instrument positions for whom θ_{AV}=1.
AB_{q} is defined as the live account balance on day i.
AccV_{q} is defined as the live account value on day i.
MPFE_rt_{q} is defined as the running total margin requirement from open positions in internally-margined iMID instruments.
ABxPFE_{q} is defined as the running total cash account balance net of MPFE_{q} during day i.
AccVxPFE_{q} is defined as the live account value net of MPFE_{q} during day i.
MBAᵢ is the overnight index-driven adjustment to the account balance for iMID instruments, which is applicable for instruments for which ε=0.
MBIᵢ is defined as the overnight interest on the sum of the account balance AB(EoD)ᵢ and unrealised P&L UPL_{c,i}, calculated in the conventional fashion. It accounts for interest on aggregate UPL_{c,i}, and replaces at account level the component MFAᵢ which applies to individual position mark-to-market.

AB_{—}rt_{q}=AB(SoD)ᵢ+ACI_{q}−ACW_{q}+RPL_{—}rt_{q}+IA_{—}rt_{q}+VM_{—}rt_{q}+(IM_{—}rt_{q}−IM_{—}rt_{c,i-1})

AccV_{q}=AB_{—}rt_{q}+UPL_{—}rt_{q}+AssV_{—}rt_{q}

ABxPFE_{—}rt_{q}=AB_{—}rt_{q}+MPFE(AB)_{—}rt_{q}

AccVxPFE_{—}rt_{q}=AccV_{—}rt_{q}+MPFE_{—}rt_{q}

In these definitions, for the closing running total on day i, notation _rt_{q} is replaced by subscript _rt_{c,i}. For example, the closing running total unrealised P&L UPL_rt_{q} is denoted as UPL_rt_{c,i}. Values _rt_{c,i} may be inputs to the overnight roll calculation process, the outputs from which are in turn used to seed opening values on day (i+1) as follows:

AB(SoD)ᵢ₊₁=AB(EoD)ᵢ+MBIᵢηₚ_{_{—}}rt_{c,i}η_{I}HVaR_{—}rt_{c,i}MBAIᵢ; RPL_rt_{open,i+1}=0;

IA_rt_{open,i+1}=0; VM_rt_{open,i+1}=0; IM_rt_{open,i+1}=IM_rt_{c,i}; UPL_rt_{open,i+1}=UPL_rt_{c,i};

MPFE_{open,i+1}=MPFE_rt_{c,i}; ηₚ_{_{—}}rt_{open,i+1}=ηₚ_{_{—}}rt_{c,i}; VaR_rt_{open,i+1}=VaR_rt_{c,i}(SNIP&SNIPR);

Running totals of margin requirements, realised P&L and unrealised P&L may not be purely additive, and will account for the interplay between individual (offsetting) transactions. For contributions to closing values from individual transactions executed in period i:

IAₛ=θ_{IA}NIAₛ

VM_{C,i}=θ_{M,E}HVaRηₚη_{I}(Λ_{F,C,i}−ExLₛ)=θ_{M,E}HVaRηₚ(P_{F,C,i}−Pₛ); for open positions brought into day i, ExLₛ=Λ_{F,C,i-1}

IMₛ=−θ_{M,E}HVaRICM(bp)

UPL_{C,i}=(1−θ_{AV})θ_{M,I}HVaRηₚη_{I}(Λ_{C,i}−EL₁)

AssV_{C,i}=θ_{AV}NAssV_{C,i}

MPFEₛ=−θ_{M,I}HVaRICM(bp)

MPFE(AB)ₛ=θ_{M,AB}MPFEₛ

Replacing closing rate(s) A_{C,i} with live rate(s) L_{q} in the above formulations for VM_{C,i}, UPL_{C,i} & AssV_{C,i} gives real-time values of these variables.

### Instrument Lending

There will be repo markets in the securities embodiments (borrowing/lending securities versus cash), to facilitate short-selling securities.

When SNIPᵢ-based, we have described the presence of a cash-related elements DAᵢ and MAᵢ within the daily Entry Level Adjustment ELAᵢ. These elements represent a compounding credit to the buyer for the use of its cash.

The break-even repo rate or effective deposit rate EDR can be expressed in terms of the instrument's prevailing secondary market price P_{q} as

$$EDR = \frac{{C}_{i}}{{HP}_{q}} ( {D}_{i} - {DM}_{i} ) + \frac{( {HP}_{q} - {C}_{i} )}{{HP}_{q}} ( {D}_{i} - {MM}_{i} ) - \frac{ELAM}{{P}_{q}} \frac{{MMC}_{IDC}}{{n}_{i} - {s}_{i}} ,$$

where ELAM 5001 is a fixed periodic amount.

This rate may act as a basis for repo market rates, although rates may deviate significantly in the event of significant position taking in the instruments. Buyers should, on this basis, have no incentive to move between instruments referenced against a given Curve Point. The instruments can be treated as general collateral.

### Termination Features

Contractual embodiments of the present invention will possess a maturity date, which may be open-ended. Scheduled terminal contractual payments will occur on this date in the absence of a prior termination event.

All embodiments may possess early termination features, both optional and mandatory. These may be at the position level or at the Series level. They provide simple, transparent routes from instrument balance to cash, and are therefore highly useful.

### Holder Termination Provision (“HTP”) Manager 1500

The inventive instruments have been designed with live secondary trading as the dominant transfer method. An additional transfer mechanism, optionally established in the primary phase and denoted a Holder Termination Provision 5060, may also be set up. The mechanism takes advantage of the relationship between each UCP and its real Reference IRS, and the prior art presence of benchmark snapshots (each an “IRS Fixing”) for these Reference IRS, such as the once-daily ISDAFIX® fixings.

In its simplest form, the mechanism would involve parties agreeing ad hoc to a secondary ticket in all respects (instrument, buy/sell ηₚ, size VaRₛ trade date fₛᵢ, settlement date sᵢ) save price; instead of agreeing price at execution, parties agree an IRS Fixing reference CIRS_{K,i} for the price, and a spread EF_{C} to that reference. The execution price ExLₛ for the transaction is then set, without further intervention from either party, upon publication of the IRS Fixing.

The mechanism may also be enshrined in the primary phase, as an exit route (ηₚ=−1). Each holder may require the Issuer 5024 to repay the obligation on certain dates 5061. Subject to a pre-specified notice period defined by attributes 5062,5063 given by the holder, units equivalent to the specified VaR must be repaid by the Issuer for immediate value with reference to CIRS_{K,i} defined by attributes 5064, 5066, 5067.

The contractual repayment HTPA 5068 is given by:

HTPA=θ_{IA}(−ηₚη_{I}(CIRS_{K,i}−ELᵢ)−EF_{C})HVaR

HTPA=θ_{IA}(−ηₚ)max{0,η_{I}(CIRS_{K,i}−ELᵢ)−EF_{C}}HVaR
where the fee EF_{C} 5065 payable by the holder upon exercise which may be expressed as a rate, as here, or as an amount.

For embodiments E & F, this feature must be present for the instrument to be classified as debt. FIG. 19C is an event trace diagram for the process. For embodiments A,B&C, the amount may be negative i.e. a payment from the holder to the Issuer. This feature may be present in embodiment D, hedged by an auction format or by liquidity providers.

By this feature, holders may, where a conventional IRS dealing framework can be identified between parties with offsetting requirements, convert inventive contracts into their IRS equivalent. Payment HTPA is made as detailed above. Simultaneously, the parties enter into an IRS contract denominated in RCDC with effective date sᵢ, tenor K, quotation basis QB, with fixed rate CIRS_{K,i} and notional amount

$$\frac{Var H}{{G ( s )}_{q , K}} ,$$

where G(s)_{q,K} is determined with reference to the wider set of rates CIRSᵢ. Positions would retain their Sense for each party on conversion. In this process, we would often set EF_{C}=0.

### Safeguard Termination Provision (“STP”) Manager 1300

Leveraged security embodiments such as Embodiment E, being strict assets of their holders, are likely to possess a mandatory early termination provision STP 5040. STP will act over a Series. FIG. 19B is an event trace diagram for this process. For embodiments in which Live Quotes L_{q} feed continuously into contract pay-out without constraints and for which parties are liable for the full extent of any move, no such feature is necessary.

The presence of non-zero Issue Price 5012 means the holder pays cash to acquire the instrument. This cash is akin to a margin against adverse price movements. This margin is an attribute of the instrument in Embodiments A,E&F, which distinguishes it from Embodiment B,C&D in which margin is an attribute of the position. In embodiment E, the Holder cannot lose more than this initial cash investment. In exchange for protecting the Holder in this way, the Issuer (and therefore by extension the Hedge Counterparty) earns the premium OAᵢ.

The STP is equivalent to a margin monitor. Should the margin become inadequate on some measure, the security is subject to mandatory early redemption at that then prevailing price.

In one optional embodiment, margin adequacy is measured by a Safeguard Termination Level STLᵢ 5043. STLᵢ is offset relative to ELᵢ 5007 according to the characteristics of the Reference IRS, for example as a multiple of the standard deviation of the daily swap rate move based on an input volatility level, or for example to within a certain confidence interval relative to a historical data set. We call this offset Safeguard Termination Premium 5042. Safeguard Termination Premium may be fixed or reset periodically, according to individual contractual terms. A Live Quote L_{q} move beyond STLᵢ triggers mandatory early redemption.

In a second optional embodiment, the value of option component OAᵢ is the measure of margin adequacy. A Live Quote L_{q} move which drives the option value OAᵢ above a pre-defined maximum threshold (“OTL”) causes mandatory early redemption. The level OTL could be zero at the degree of rounding 5099 employed. The option value could be monitored on a continuous basis (in which case it would strictly for these purposes take the subscript “q”) or could be monitored at its daily closing value as per its contribution to ELAᵢ or at some other periodicity as defined within the contractual terms.

On a breach of margin adequacy, the Issuer's repayment STPA 5058 is:

STPA=θ_{IA}HVaRmax{0,η_{I}(STSRRS_{K,i}−ELᵢ)}

Safeguard Termination Settlement Rate STSRRS_{K,i} 5053 will be the settlement rate for determining payments on instruments following a Safeguard Termination Event, defined by attributes 5056,5057. Its relationship to executable market rates immediately following the occurrence of the termination event is governed by a set of rules and methods 5054,5055,5092. These rules include time limits for activity and assignment rights over Hedging Derivative Contracts. This is distinct from the Safeguard Termination Event Relevant Source (“STERS”) rate, which will be the rate observed for the purpose of determining the occurrence of the termination event and is governed by its own set of rules and methods 5046-5052,5092,5093. The STERS rate may be from a single source or be a panel average, it may be a bid-, offer or mid-market rate, it may be executable or non-executable, and it may be instantaneous or time-averaged.

### Issuer Call Provision (“ITP”) Manager 1500

Suppliers may benefit from an ability, established in the primary phase, to terminate positions. ITP 5069 may act over a Series or an individual position. For example, for Embodiments B&C, this will represent a device via which credit exposure to the end-user may be managed.

For Embodiment E&F, the Hedge Counterparty will in practice drive the actions of the Issuer, who may benefit from the ability to redeem the outstanding instruments of a particular Series at a prevailing market price. For example, partial holder terminations may have taken the outstanding series amount below some threshold, or market movements might have made the series unsuitable for trading.

For securitised embodiments, repayment amount ITPA 5075 is of the form:

ITPA=θ_{IA}HVaRmax{0,η_{I}(CIRS_{K,i}−ELᵢ)+EF_{I}}
where CIRS_{K,i} is the Issuer Call Settlement Rate, governed by attributes and methods 5070,5073,5074,5076 and EF_{I} 5072 is a fee payable by the Issuer upon exercise, which may be expressed as a rate, as here, or as an amount.

The Issuer would in these circumstances be required to redeem a series in full. FIG. 19D is an event trace diagram for this process.

For bi-lateral embodiments, repayment amount ITPA would be of the form:

ITPA=θ_{IA}HVaR[η_{I}(CIRS_{K,i}−ELᵢ)+EF_{I}]

The Issuer may in these circumstances redeem a Series in part. For these Embodiments, the amount can be negative i.e. a payment to the Issuer.

### Risks to Dealers

In trading products with a pay-off linked to these indices, traders will take on risk. These risks fall within the existing family of risks taking by an interest rate trading operation. Indeed, it is an advantage of the present invention that the parameters necessary for producing these indices, and the analytics necessary for evaluation of the risks associated with the indices, are implicit within the interest derivatives pricing engines of the majority of large international banks.

The market risk from dealing in the contractual embodiments of the present invention can be managed by traders within the framework of an existing interest rate risk management business. The first-order (delta) risk can be offset by trading in conventional IRS. This will leave two second-order risks within the hedged portfolio.

Fixing risk is defined as the difference between the value for the instrument adjustment anticipated by the dealer's system relative to the value published by the index calculator 5033. It will be this latter value which is contractually binding. This risk will be examined within the commercial validation through which dealers are likely to channel product development & product approval from their risk control functions. The willingness of Dealers to automatically assume this risk, thereby creating timing flexibility for end-users, is a key element of the inventive system.

Realised Convexity risk can be defined as the difference between the value of the convexity component embedded within last night's published index (an expectation) and the value experienced as time passes through today's realised market movements (a realisation). It occurs by virtue of slicing the passage of time, and therefore the convexity value, into units of one business day. Broadly, the implied volatility input in the index calculation process will imply an expected market move over the period in question. If the realised market movement exceeds this expectation, the index will in hindsight prove to have been an under-estimate of the value, and a portfolio will experience profits and losses according the direction of the portfolio exposure. Option strategies could be employed by dealers to manage this risk.

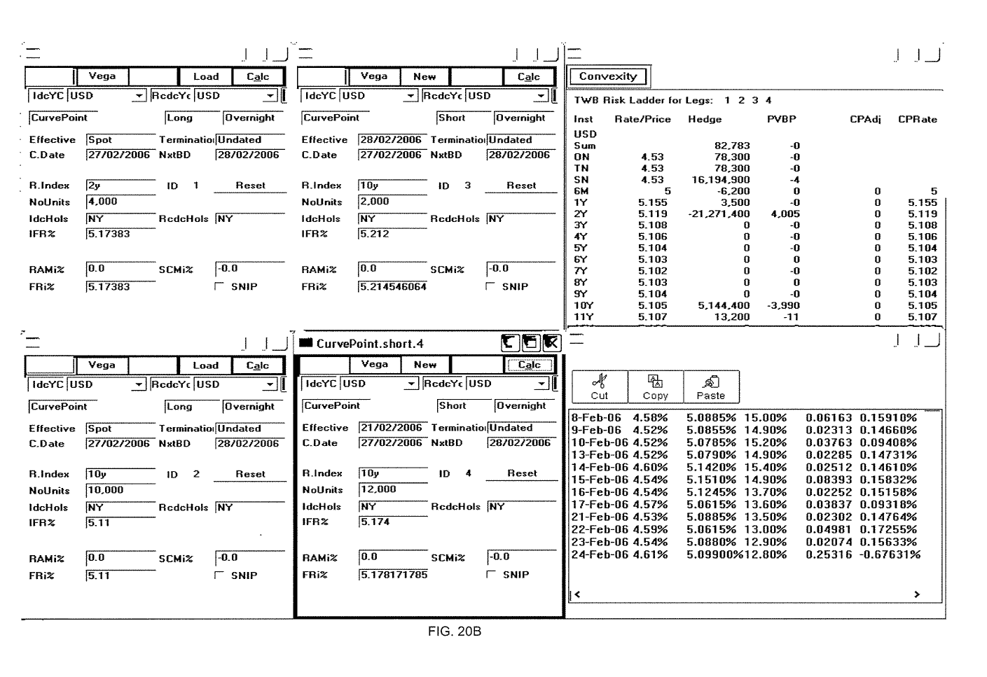

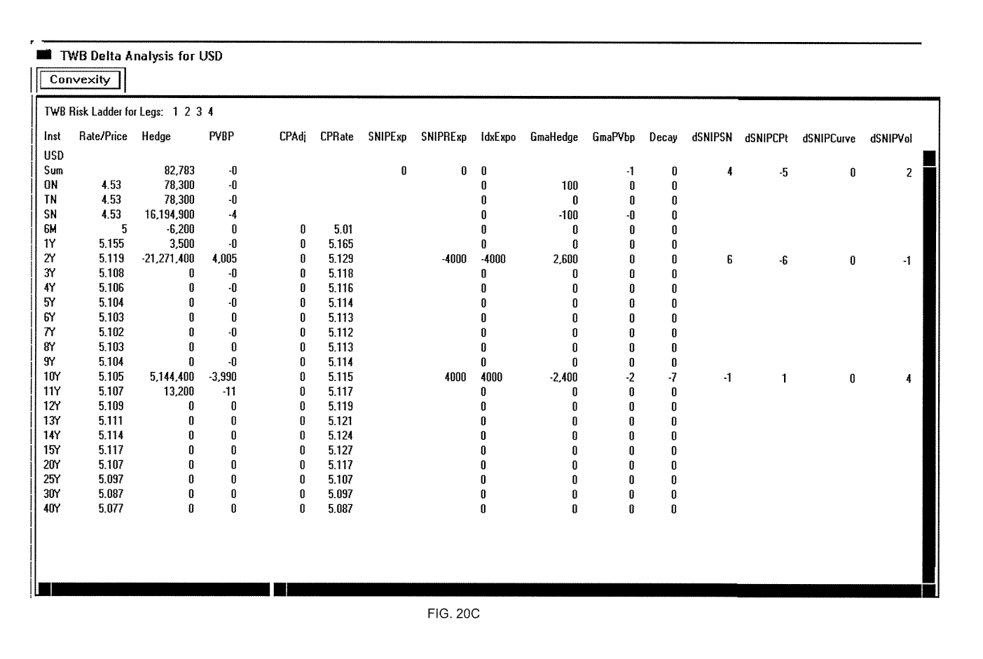

FIGS. 20A, 20B & 20C illustrate example embodiments of the graphical user interface via which these risks can be reported to users for ongoing management. Risks are split per Curve Point/Reference IRS pair.

Risk managers may elect to view risks from one of at least two perspectives: Intra-day and Overnight. The requirement to apply these distinct perspectives comes from the timing flexibility associated with positions in inventive instruments. Since they are typically open-ended, we cannot revalue against a definitive maturity. This characteristic is shared with FX positions, but not with the prior art in IRS.

For the Intra-day perspective, risks are reported as if inventive instrument positions will be closed out at or prior to market closing. The dominant risk in this case is the Realised Convexity mismatch, which is reported via GmaHedge, GmaCash and Decay. SNIPExp, SNIPRExp & IdxExpo are also reported. Inventive instruments are valued as if both legs in the contract are set and paid early.

For the Overnight perspective, risks are reported as if inventive instrument positions will be held open overnight. Inventive instruments are valued as if both legs are set and paid one-business-day in arrears. In the absence of margins within ELAᵢ, there is no change to position NPV. This is because, excluding fees, the adjustment ELAᵢ to the fixed leg of the contract compensates exactly for the risks borne in having an arrears-set floating leg. Measures of Fixing risk (dSNIPSN, dSNIPIdx, dSNIPIdx2, dSNIPCurve & dSNIPVol) become relevant and are reported.

SNIPExp is defined as the aggregate PVBP equivalent across SNIP-indexed instruments referenced against the Curve Point in question.

SNIPRExp is defined as the aggregate PVBP equivalent across SNIPR-indexed instruments referenced against the Curve Point in question.

IdxExpo is the sum of SNIPExp and SNIPRExp values. A negative value in each case means that a positive SNIP value will be a charge to the position.

GmaHedge is the change in Hedge for a 1 bp upward movement in Li_{q} instruments, with a positive figure indicating a long gamma position.

For inventive instruments in isolation, as in FIG. 20C, GmaCash can be the PVBP equivalent of GmaHedge, being GmaHedge*G(s)_{q,K}. More generally, and for mixed prior art and inventive instrument positions, GmaCash is the change in PVBP of the combined position for a 1 bp increase in rates.

Decay is the prevailing cash value to the instrument position of instrument gamma ahead of its next reset. A negative figure indicates the cost expectation of a long gamma position. At the point it is reset, it will equal the cash charge to the position embedded within the SNIP fixing.

The subsequent figures are sensitivities of the position, via the IdxExpo and expressed as cash value, which result from potential discrepancies between a user's input values and those market averages which are implicit within the published SNIP figure.

dSNIPSN is the sensitivity of the index position to a 1 bp increase in the S/N rate in isolation. A positive figure indicates that a higher S/N will benefit the position, by contributing to a reduction in the SNIP figure.

dSNIPIdx is the sensitivity of the index position to a 1 bp increase in that Curve Point rate in isolation. A positive figure indicates that a higher rate will benefit the position, by contributing to a reduction in the SNIP figure through a pronounced impact on the interpolation.

dSNIPIdx2 is the sensitivity of the index position to a 1 bp increase in that Curve Point rate and the immediately longer Curve Point rate. A positive figure indicates that this change will benefit the position, by contributing to an increase in the SNIP figure.

dSNIPCurve is the sensitivity of the index position to a 1 bp parallel increase in the yield curve. A positive figure indicates that a higher curve level will benefit the position.

dSNIPVol is the sensitivity of the index position to a 1% increase in implied volatility. A positive figure indicates that a higher implied volatility will benefit the position, by contributing to an increase in the SNIP figure.

Hedging tools will emerge with increased adoption of these indices. For example, in the prior art, an overnight index swap (“OIS”) is an instrument in which a daily compounded overnight interest rate such as EONIA is exchanged for a fixed payment. A novel OIS in which the SNIPR index replaces the EONIA index is a hedging tool for dealers who find that, as a result of imbalances in their client flows in inventive indexed products, they experience potentially long-term (1 week or more) SNIPR-index exposure.

As for other index-linked transactions, the notional amounts for these swaps will be the product of risk amount VaR multiplied by H. For a single Calculation Period SNIPr-OIS running from effective date sᵢ to termination date n_{T}, we define the single floating rate payment according to the following formulation:

$$Floating Payment = {\sum }_{t = 1}^{T} [ \frac{( {SNIPR}_{t} + {RAM}_{t} ) ( {n}_{t} - {s}_{t} )}{{MMC}_{IDC}} {\prod }_{u = t + 1}^{T} \{ 1 + \frac{( {D}_{u} ) ( {n}_{u} - {s}_{u} )}{{MMC}_{IDC}} \} ] ,$$

where T is the number of business days in the Calculation Period from and including the Effective Date up to but excluding the Termination Date, t is a series of whole numbers running from one to T, SNIPR, for any day t is a reference rate equal to the overnight rate as published by the Index Calculation Agent in respect of that day, and RAMₜ is a margin applicable to the reference rate set equal to zero for generic market quotation.

The fixed rate FXD can be quoted and be payable according to standard methods and schemes within the Interest Rate derivatives markets. For a fixed rate quoted on a money market basis, the net payment for value n_{T} would be:

$$( FXD \frac{( {n}_{T} - {s}_{1} )}{{MMC}_{IDC}} - Floating Payment ) VaR H$$

A second novel OIS in which the SNIPn index replaces the EONIA index is a hedging tool for dealers who find that, as a result of imbalances in their client flows in inventive indexed products, they experience potentially long-term (1 week or more) SNIPn-index exposure.

The notional amounts for these swaps will be the product of risk amount VaRₛ multiplied by H. For a single Calculation Period SNIPn-OIS running from effective date sᵢ to termination date n_{T}, we define the single floating rate payment, to be applied to the instrument balance for value n_{T}, according to the following formulation:

$$Floating Rate = [ {\prod }_{t = 1}^{T} \{ 1 + \frac{( \begin{matrix}{SNIPn}_{t} + \\ {INM}_{t}\end{matrix} ) ( {n}_{t} - {s}_{t} )}{{MMC}_{IDC}} \} - 1 ] \frac{{MMC}_{IDC}}{( {n}_{T} - {s}_{1} )} ,$$

where T is the number of business days in the Calculation Period from and including the Effective Date up to but excluding the Termination Date, t is a series of whole numbers running from one to T, SNIPnₜ for any day t is a reference rate equal to the spot/next rate as published by the Index Calculation Agent in respect of that day, and INMₜ is a margin applicable to the reference rate set equal to zero for generic market quotation.

The fixed rate FXD can be quoted and be payable according to standard methods and schemes within the Interest Rate derivatives markets. For a fixed rate quoted on a money market basis, the net payment, to be applied to the instrument balance for value n_{T}, would be:

$$( FXD - Floating Rate ) \frac{( {n}_{T} - {s}_{1} )}{{MMC}_{IDC}} {VaR}_{s} H$$

For both SNIPR- and SNIPn-OIS, the fixed rate for differing maturities for each Curve Point would be set by the market. These fixed rates are examples of a basis for UCP financing rates for maturities other than Spot/Next. When longer-term financing is applied to individual positions in inventive instruments, the transparency of the linkage between position value and live quote L_{q} is lost. However, as familiarity with the inventive instruments grows, we expect markets in term financing of positions to grow.

### Example 1

The manager of a fixed income credit portfolio who is unable to execute conventional IRS is offered a 10 yr fixed rate new issue at a pre-specified spread to the mid-swap rate L(10)_{q}. They like the credit, and want to buy the bonds, but they have a restriction on the scale of the absolute risk position they are allowed to take in the maturity in question.

The manager would immediately have to reduce their holding of some other credit bond(s) in order to accommodate the new issue, or would have to short-sell a suitable Government bond to offset the new issue risk. This exposes the manager to basis risk between the chosen Government bond and the swap rate against which the new issue was launched and priced, and exposes the manager to repo rate risk in that Government bond.

New alternative using Embodiment A—the manager can buy the new issue and can simultaneously buy the Cash Curve Point referenced to L(10)_{q}. This combination locks in the spread to mid-swaps at which the new issue is executed. We coin the term “to exchange MIDs” to describe this combination, and it is analogous in risk concept to the market practice of “exchanging Treasuries/Govts” in current use. The interest rate profile of the long Cash Curve Point position offsets the profile of the long new issue position, with an added advantage of a long convexity profile (paid for via the Balance Adjustments). The cash required to buy the Cash Curve Point position may borrowed from the account provider against its value. With the credit spread securely tied up in this way, the manager is then free to dispose of other holdings at a time of its choosing. For example, if the manager is generally positive about credit spreads, they can wait for this move to happen before selling positions which tighten beyond fair value.

New alternative using Embodiment D—the manager can buy the new issue and simultaneously execute a sell transaction in a Futures Contract Series with price relationship (1Fa) referenced to the Reference Contract of appropriate maturity. This combination locks in the spread to mid-swaps at which the new issue is executed. The interest rate profile of the short futures position offsets the profile of the long new issue position, with an added advantage of a long convexity profile (paid for via charges to the Margin Account). There is no additional cash requirement to put on this position apart from margin requirements at the Exchange. With the credit spread securely tied up in this way, the manager is then free to dispose of other holdings as with Embodiment A.

### Example 2

The manager of a fixed income portfolio wishes to lengthen the duration of their interest rate exposure from 5 yrs to 30 yrs without disrupting portfolio credit composition or increasing the absolute sensitivity of the portfolio to a parallel yield curve move. They are able to execute conventional IRS.

The manager would enter into two IRS transactions, paying fixed in the 5 yr maturity and receiving fixed in the 30 yr maturity. The relative Notional Amounts of each swap would be selected so as to offset each other in absolute terms at the time of execution, as a ratio of inception PV01s. Movements in absolute rates, coupled with the passage of time, will alter the delta sensitivities of the two swaps such that they no longer offset each other. The manager is required to actively monitor the two positions, and make adjustments to the relative sizes in order to maintain the original neutrality. Upon exit, the manager will receive an amount equal to the net of the two swap unwind values, which will not compare readily to the individual exit rate quotes or to the lifetime spread change.

New alternative using Embodiment C—the manager can enter into a SNIP-driven OIS, in which the pay-out to the manager is driven by a spread {L(30)_{q}−L(5)_{q}}. The fixed rate on the OIS adjusts daily according to a net SNIP index contribution (SNIP(30)ᵢ−SNIP(5)ᵢ) and position-wide MAᵢ. Market neutrality is maintained without the need for active management. The exit pay-out will be transparently linked to individual exit rate quotes, and directly identifiable against a lifetime spread change.

### Example 3

A credit bond trader has a net position in the interest rate market as a result of their positions, both long and short, across a variety of individual bonds. They wish to protect themselves from interest movements overnight by macro-hedging the portfolio. They can evaluate the net risk, and select the most suitable maturity bucket in which to execute a hedge.

The trader could enter into a long-term IRS to a maturity date in the selected bucket. At some point during the next trading session, when the net positions have changed, the trader may have no further need of the executed IRS. In this situation, the trader is likely to enter into further IRSs to manage new risks, thereby building up a portfolio of swap positions which are expensive to maintain but often offsetting in risk. Alternatively, the trader could execute a transaction in the most suitable available government bond, and dispose easily of the position once it has run its course. This exposes the trader to basis risk between the chosen Government bond and the swap rates against which bond positions are priced, and potentially to repo rate risk in that Government bond (if short).

New alternative using Embodiment B—the trader executes an MCP trade linked to quote L_{qK} of a tenor and currency equal to that of the conventional swap into which they would otherwise have chosen to enter. The trader agrees ExLₛ and VaRₛ with the price-maker upon execution. The following day, the trader reverses the position, partially or wholly. Specifically, the exit payment is determined by first agreeing ExL_{d}. This can be a prevailing live quote L_{qK} agreed at execution between the parties, or it can be a rate fixing from an information source specified at the inception of the transaction, for example from the ISDAFIX® page series. The amount payable, for value spot, is calculated with reference to formulation 6(F) and is a direct function of its inputs.

Other embodiments, extensions, and modifications of the ideas presented above are comprehended and within the reach of one versed in the art upon reviewing the present disclosure. Accordingly, the scope of the present invention in its various aspects should not be limited by the examples and embodiments presented above. The individual aspects of the present invention, and the entirety of the invention should be regarded so as to allow for such design modifications and future developments within the scope of the present disclosure. The present invention is limited only by the claims that follow.

The following references are hereby incorporated herein in their entirety
(1) Bartels, R. H.; Beatty J. C.; & Barsky, B. A. (1998) “Hermite and Cubic Spline Interpolation”, Ch. 3 ‘An introduction to Splines for use in Computer Graphics and Geometric Modelling’ pp. 9-17, Morgan Kaufmann.
(2) Black, F. (1976) ‘The Pricing of Commodity Contracts’, Journal of Financial Economics, 3, p. 167-179.
(3) Brotherton-Ratcliffe, R.; & Iben, B. (1993) “Yield Curve Applications of Swap Products”, in ‘Advanced Strategies in Financial Risk Management’, Robert J. Schwartz and Clifford W. Smith, New York Institute of Finance.
(4) Derman, E.; Karasinski, P.; & Wecker, J. S. (1990) ‘Understanding Guaranteed Exchange-Rate Contracts in Foreign Stock Investments’, International Equity Strategies, Goldman Sachs, June
(5) Haug, E. G. (1998) ‘The Complete Guide to Option Pricing Formulas’, p. 146-147 (Convexity Correction), p. 104-106 (Quanto Correction) McGraw-Hill
(6) Kirk, E. (1995) ‘Correlation in the Energy Markets’, in Managing Energy Price Risk. London: Risk Publications
(7) Reiner, E. & Rubinstein, M. (1991) “Unscrambling the Binary Code”, Risk Magazine 4(9).

What is claimed is:

1. A computer implemented method of trading interest rate risks comprising at least one of the sequential, sequence independent and non-sequential steps of:
a first party trading a first interest rate risk, to a second party for a second interest rate risk, wherein the second interest rate risk is a fixed cash amount for spot settlement;
applying a daily adjustment to the first interest rate risk; and
determining a trade value of the trade of interest rate risks, the trade value being responsive to a live spot quote and the daily adjustment.

2. A computer implemented method of trading interest rate risks, according to claim 1, wherein the fixed cash amount is calculated as the product of a fixed instrument rate and a fixed instrument amount.

3. A computer implemented method of trading interest rate risks, according to claim 1, wherein the first interest rate risk is floating.

4. A computer implemented method of trading interest rate risks, according to claim 3, wherein the floating first interest rate risk is convertible into a floating cash amount for spot settlement.

5. A computer implemented method of trading interest rate risks, according to claim 4, wherein the floating cash amount is calculated as the product of a floating instrument rate and an instrument amount, wherein the instrument amount is a measure of the scale of the position of the first party.

6. A computer implemented method of trading interest rate risks, according to claim 1, wherein the trade value is determined by summing the fixed cash amount, interest on this fixed cash amount, and the floating cash amount.

7. A computer implemented method of trading interest rate risks, according to claim 5, wherein the instrument amount is floating.

8. A computer implemented method of trading interest rate risks, according to claim 7, wherein an initial value of the floating instrument amount is equal to the fixed instrument amount.

9. A computer implemented method of trading interest rate risks, according to claim 7, wherein the floating instrument amount is adjusted once daily.

10. A computer implemented method of trading interest rate risks, according to claim 5, wherein the floating instrument rate is identical to a live market rate for an interest rate swap.

11. A computer implemented method of trading interest rate risks, according to claim 5, wherein the floating instrument rate is equal to sum of a live market rate for an interest rate swap and an intra-day adjustment applied to the live market rate.

12. A computer implemented method of trading interest rate risks, according to claim 9, wherein a daily adjustment IBAᵢ to the instrument amount is based on a published index rate and the prevailing instrument amount and is computed daily according to:
$${IBA}_{i} = {η}_{p} H {VaR}_{i} \frac{( {SNIPn}_{i} + {INM}_{i} ) ( {n}_{i} - {s}_{i} )}{{MMC}_{IDC}} )$$
where SNIPn=an index rate published once daily; ηₚ=a switch having the value of 1 for a long position and a −1 for a short position; H=a scaling coefficient equal to 10,000; VaR=a prevailing instrument balance; INM=a margin optionally applied to the index rate; (n−s)/MMC_{IDC}=a day count fraction; and a computed value IBA is an adjustment to the instrument balance.

13. A computer implemented method of trading interest rate risks, according to claim 4, wherein the floating cash amount is capable of spot settlement and is determined in an active secondary market.

14. A computer implemented method of trading interest rate risks, according to claim 4, wherein the floating cash amount is capable of spot settlement at one or more discrete times throughout a day, using a primary value calculated with reference to a benchmark fixing rate for an interest rate swap through a process established at instrument launch.

15. A computer implemented method of trading interest rate risks, according to claim 7, wherein the instrument amount balance is registered with a third party clearing agent.

16. A computer implemented method of trading interest rate risks, according to claim 7, wherein the instrument amount balance is directly proportional to the value sensitivity per basis point of the instrument.

17. A computer implemented method of trading interest rate risks, according to claim 1, further comprising settling the trade of interest rate risks, wherein settling comprises:
recording an instrument associated with the first interest rate risk;
recording the denomination currency being exchanged, each of the two parties to the transaction, the respective positions of each of the parties, the settlement instructions of each of the parties, an instrument amount, a spot settlement price, a trade date, and a settlement date.

18. A computer implemented method of trading interest rate risks, according to claim 1, wherein the processing of a trade is performed by foreign exchange processing systems, wherein the foreign exchange processing system is adapted to register balances in an inventive instrument account.

19. A computer implemented method of trading interest rate risks according to claim 1, wherein a value sensitivity risk associated with the trade of interest rate risks is reported, to at least one of the first party and the second party to the transaction, as units of one or more interest rate swap contracts.

20. A computer implemented method of trading interest rates risks according to claim 1, wherein a value sensitivity risk associated with a trade of interest rate risks is reported, to at least one of the first party and the second party to the transaction, as absolute cash sensitivities to movements in the prices of one or more interest rate swap contracts.

21. A graphical user interface method of presenting instrument information for use in electronic trading systems comprising at least one of the sequential, sequence independent and non-sequential steps of:
displaying an interest rate curve as a grid of discrete grid-point tenors K along a first axis;
displaying live market rates corresponding to the grid of discrete grid-point tenors K on a second axis;
displaying at least one instrument on this grid in accordance with its reference tenor and prevailing Entry Level; and
for each instrument, displaying a projected periodic Entry Level adjustment, a probability of mandatory early termination, and information relating to the party's interest rate risk trading activity in that instrument.

22. A graphical user interface method of presenting user's position information for use in electronic trading systems comprising at least one of the sequential, sequence independent and non-sequential steps of:
displaying an interest rate curve as a grid of discrete grid-point tenors K along a first axis;
displaying live market rates corresponding to the grid of discrete grid-point tenors K on a second axis;
displaying at least one trading position of a user on the grid in accordance with the reference tenor and holding cost of an instrument;
for each instrument, displaying a projected periodic holding cost adjustment and information relating to the party's interest rate trading activity in that instrument.

23. A computer implemented method of trading interest rate risks comprising at least one of the sequential, sequence independent and non-sequential steps of:
receiving at a financial product trading system a trade position in a first interest rate risk from a first party, the trade position comprising a request for a quotation from a second party of the fixed cash amount at which the second party is willing to assume the first interest rate risk;
receiving at the financial product trading system a trade position in the first interest rate risk from a second party, the trade position comprising a response to the first party's request for a quotation;
performing a trade for spot settlement through the financial product trading system, between the first position transmitted by the first party and the second position transmitted by the second party, wherein performing the trade comprises:
recording an instrument associated with the first interest rate risk;
recording the denomination currency being exchanged, each of the two parties to the transaction, the respective positions of each of the parties, the settlement instructions of each of the parties, an instrument amount, a spot settlement price, a trade date, and a settlement date.
